(19) United States
(12) Patent Application Publication
(10) Pub. No.: US 2024/0144901 A1
(43) Pub. Date: May 2, 2024

(54) Systems and Methods for Sending, Receiving and Manipulating Digital Elements

(71) Applicant: Conduction Limited, Inc., Pittsburgh, PA (US)

(72) Inventor: Joseph C. Maggiore, Pittsburgh, PA (US)

(21) Appl. No.: 18/385,266

(22) Filed: Oct. 30, 2023

Related U.S. Application Data
(60) Provisional application No. 63/420,396, filed on Oct. 28, 2022.

(51) Int. Cl. G10H 1/00

(52) U.S. Cl. CPC G10H 1/0025; G10H 2210/281; G10H 2220/121

(57) ABSTRACT

The present disclosure provides a system for dynamic, real-time composition of sheet music including: a data library including a plurality of static music notation files, each static music notation file represented as divided into a plurality of blocks; a primary device in communication with the data library, the primary device including a user interface, memory storing program instructions, and a communications module; a receiver device in communication with the primary device; wherein, in response to executing the instructions, the primary device: communicates a dynamic notation file to the receiver device based on a configuration of the plurality of blocks arranged by the primary device; and presents a GUI including controls for moving selections of one or more of the plurality of blocks in real-time while the communication to the receiver device is in progress.

### CROSS-REFERENCE TO PRIOR APPLICATION

The present application is a continuation of which is a continuation of U.S. Application No. 63/420,396 filed on Oct. 28, 2022, the entirety of which is incorporated herein by reference.

### BACKGROUND OF THE INVENTION

The present subject matter relates generally to systems and methods for sending, receiving, and manipulating digital elements. More specifically, the present invention relates to a platform through which a user, such as a DJ, may create and distribute digital sheet music to musicians.

Within the setting of performances by disc jockeys (DJs), a typical setup allows for the controlled manipulation of audio files in real time (i.e. .MP3s) that then output through a series of technologies designed for the modulation of such audio files to finally output to speakers that convert the modulated audio files to audible audio. This is the current method whereby most DJs perform. Some DJs; however, add live musicians to this base described setup. However, there are many barriers to the execution of this kind of performance. First, the communication between the DJ and the live musicians exists only through hand and voice signals, greatly limiting the complexity of ideas that can be transmitted person to person in the immediacy of the performance. Second, the DJ is unable to deviate from predetermined regions of music already rehearsed with the instrumentalists since musicians rely so heavily on sheet music to prescribe the music that is performed. Third, for a DJ to directly interface with an instrumentalist, the DJ often requires in depth musical training, that is often not acquired. Lastly, large groups of instrumentalists require prescribed sheet music to perform, a synchronized method for keeping time, and with the spontaneity and the manipulation of audio tracks that a DJ desires, the modality of sheet music renders this collaboration impossible. Taken together, this makes a DJ performing with one to two musicians difficult, and a DJ performing with greater than two musicians next to impossible. There is currently no technology that addresses these concerns and allows for the direct control or facilitated communication between DJs and musicians in real time.

Outside of DJs, within the setting of live musical performances such as in orchestral ensembles, there is a variety of control methods for the output of live music groups. The groups output sound is ultimately pre-determined by a transcription of sheet music, that each instrumentalist reads from. The only modulations that can be made are expression levels such as tone, volume, tempo—all of which are set through hand gestures performed by a human conductor. A human conductor is unable to mutate sheet music at a granular level for example by key signature, modulating the order of musical bars, looping bars of sheet music for one given instrument, or adding/subtracting instrumentalists in real time. There exists no digital software application for the modulation of sheet music by an untrained user or someone who wishes to edit the sheet music at a macro level outside the scope of the minutiae of specific sheet music notation, particularly within the setting of a live performance. For this reason, even in considering technologies that exist within the space of live musical performances, a DJ would be unable to utilize any of these technologies to allow the accompaniment of a live musician to the DJs performance.

Thereby, there presents an important need for a system, hereby referred to as a “primary device”, that enables a DJ or any other user to manipulate instrumentalist receiver interfaces for the real time distribution of digital sheet music or any written or displayed message or signal, performed by instrumentalists or any other end user viewing the receiver interface, as described herein.

### BRIEF SUMMARY OF THE INVENTION

To meet the needs described above and others, the present disclosure provides systems and methods for sending, receiving, and manipulating digital elements. Although the disclosure provided herein primarily focuses on the use case example of manipulating and sending digital sheet music, it is understood that the unique features and functions descried herein may be applied in the context of manipulation and distribution of other complex images and signals.

In one example, a system for dynamic, real-time composition of sheet music includes: a data library including a plurality of static music notation files, each static music notation file represented as divided into a plurality of blocks; a primary device in communication with the data library, the primary device including a user interface, memory storing program instructions, and a communications module; a receiver device in communication with the primary device; wherein, in response to executing the instructions, the primary device: communicates a dynamic notation file to the receiver device based on a configuration of the plurality of blocks arranged by the primary device; and presents a GUI including controls for moving selections of one or more of the plurality of blocks in real-time while the communication to the receiver device is in progress. In this setting, the receiver device may then display the plurality as blocks or as native representation formats of the music notation file.

In some embodiments, the dynamic notation file is a representation of the configuration of the plurality of blocks arranged by the primary device presented to the receiver device in a first format schema and the configuration of the plurality of blocks arranged by the primary device are presented through the primary device in a second format schema.

The plurality of blocks may be divided by instrument, by instrument grouping, by time, by user defined regions, by song segment, by instrumentalist, or by instrumentalist grouping.

The primary device may present a GUI including controls for moving selections of one or more of the plurality of blocks in real-time while the communication to the receiver device is in progress, the primary device may present a GUI including a prep region, a mid-live region, and a live region, wherein the live region is defined as spanning from a start time, or a present time when the present time is after the start time, through a burn threshold and the mid-live region is defined as spanning from the burn threshold to a later time; presents, through the GUI, controls for moving selections of one or more of the plurality of blocks from the prep region into the mid-live region and live region; and communicates the dynamic notation file based on the blocks in the mid-live region and live region to the receiver device.

In some embodiments, further in response to executing the instructions, the primary device presents, through the GUI, controls for moving selections of blocks into the prep region.

In some embodiments, further in response to executing the instructions, the primary device presents, through the GUI, a block modification control.

In some embodiments, the block modification control is an equalization control.

In some embodiments, the block modification control is a reverb control.

In some embodiments, in response to an application of the reverb control to a selection of blocks, the selected blocks in the dynamic notion file are communicated to the receiver device at a first time and are communicated to a second receiver device as a second time offset from the first time.

In some embodiments, each static music notation file represented as divided into the plurality of blocks is automatically created by the system in response to accessing a related sheet music file or in response to receiving and processing a live music performance.

In another example, system for dynamic, real-time composition of sheet music includes: a data library including a plurality of static music notation files, each static music notation file represented as divided into a plurality of blocks; a primary device in communication with the data library, the primary device including a user interface, memory storing program instructions, and a communications module; a receiver device in communication with the primary device; wherein, in response to executing the instructions, the primary device: presents a GUI including a prep region, a mid-live region, and a live region, wherein the live region is defined as spanning from a start time, or a present time when the present time is after the start time, through a burn threshold and the mid-live region is defined as spanning from the burn threshold to a later time; presents, through the GUI, controls for moving selections of one or more of the plurality of blocks from the prep region into the mid-live region and live region; and communicates a dynamic notation file based on the blocks in the mid-live region and live region to the receiver device.

In some embodiments, the plurality of blocks are divided by instrument, instrument grouping, time, by song segment, instrumentalist, or instrumentalist grouping.

In some embodiments, further in response to executing the instructions, the primary device presents, through the GUI, controls for moving selections of blocks into the prep region.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic representation of the relationship of elements of the systems and methods.

FIG. 2 is schematic representation of a Digital Element represented by a series of blocks, which enables the overall workflow of the systems and methods.

FIG. 3 illustrates an example GUI in which associated linked elements are depicted.

FIG. 4 illustrates a visual representation of blocks that correspond directly to individual locations within a Digital Element, such as digital sheet music

FIG. 5 illustrates a visual representation of a filtering system that is possible through the sorting of Linked Elements.

FIG. 6 illustrates a visual representation of how blocks, or groups of blocks, or any grouping of a latent representation of a digital sheet music file, can be assembled in a prep region and aligned within a grid to be further manipulated.

FIG. 7 illustrates a visual representation of a GUI depicting a block representation of digital sheet music, and how subblocks can be generated in groupings of rows or columns.

FIG. 8 illustrates a visual representation of a block modification GUI and a method for exporting the modified block representation as a block format or as a different modified Digital Element.

FIG. 9 is a schematic representation of the delineation of the types of files that serve as inputs to the example of the systems and methods shown in the figures.

FIG. 10 illustrates an example of various methods of how the number of rows on the GUI can be calculated from a Digital Element.

FIG. 11 is a schematic representation of an interaction between four elements of the systems and methods, including a uploading device, a server, a primary device, and a receiver device.

FIG. 12 is a schematic representation of a Primary Device.

FIG. 13 is a schematic representation of a Receiver Device.

FIGS. 14-24 are graphical representations of various GUIs presented by the Primary Device shown in FIG. 12.

FIG. 25 is a graphical representation of a GUI presented by the Receiver Device shown in FIG. 13.

FIG. 26 is a schematic flow chart representation of an example workflow for the handling of the files required for the Primary Device and Receiver Device.

FIG. 27 is a schematic flow chart example of a file import process.

FIG. 28 is a schematic flow chart example demonstrating how Linked Element files can be recalled and viewed by a device.

FIG. 29 is a schematic flow chart example of a file upload process.

FIG. 30 is a graphical representation of a GUI for selecting user preferences for the block representation to be generated.

FIG. 31 is a graphical representation of a GUI for modifying Metadata.

FIG. 32 is a graphical representation of a GUI in which Digital Elements are represented by block representations.

FIG. 33 is a graphical representation of a GUI for importing Digital Elements into the system and setting of user preferences for Digital Element block representation viewing.

FIG. 34 is a graphical representation of a GUI through which a user may view individual file Block Representation, then modulate the Block Representation through a series of checkboxes to change the user preferences of the Block Representation formation.

FIG. 35 is a flow chart illustrating how a Linked Element is displayed as a grid of blocks.

FIG. 36 is a flow chart depicting the variables and calculation process necessary in order to generate a grid from a Digital Element.

FIG. 37 is a flow chart example of a method for generating columns of the grid including calculating/displaying ‘by bar.’

FIG. 38 is a flow chart example of a method for generating columns of the grid including calculating/displaying ‘by bar group.’

FIG. 39 is a flow chart example of a method for generating columns of the grid including calculating/displaying ‘by rehearsal marking.’

FIG. 40 is a flow chart example of a method for creating bar groupings if there is a beginning series of Digital Element files in which there are an excess or deficit of measures that renders the bar grouping value indivisible by the total number of bars.

FIG. 41 is a graphical representation of a GUI through which a user may modify rehearsal markings or other custom markings on a Digital Element that are extracted immediately from a Digital Element and modified on a user preference panel to be used in calculating variables necessary for a grid.

FIG. 42 is a flow chart example of a method for labelling gridded columns with time labels.

FIG. 43 is a graphical representation of a GUI for Metadata input.

FIG. 44 illustrates an example workflow for extracting Metadata directly from a given Digital Element file.

FIG. 45 illustrates an example of how a user may display a digital sheet music file or any other Digital Element through a latent block representation in which each block corresponds to a single music measure within a digital sheet music file.

FIG. 46 illustrates an example of how a user may display a digital sheet music file or any other Digital Element is through a latent block representation in which each block within the block representation may represent greater than one individual measure of the digital sheet music.

FIG. 47 is a schematic representation of how a Digital Element, such as a .XML file, when parsed by rehearsal markings, is then displayed in block representation on the Primary Device.

FIG. 48 is a flow chart example of a method for calculating row variables.

FIG. 49 is a schematic representation of an example of converting Digital Element rows to a block representation grid, whereby each row of the block representation corresponds to one instrumentalist of the .XML file or other Digital Element.

FIG. 50 is a schematic representation of how a Digital Element is converted through this system and through a user defined preference or standard instrumental grouping to a grouped setting of rows where the individual rows of the block representation represent groups of rows in the .XML file.

FIG. 51 is a flow chart example of a method for assigning rows of block representation to rows of a Digital Element.

FIG. 52 is a flow chart example of a method for assigning row variables when the ‘by instrument grouping’ of FIG. 50 is executed.

FIG. 53 illustrates a ‘grouping map’ whereby a corresponding key of individual Digital Element rows get assigned to groups to inform the row assignments in the block representation.

FIG. 54 is a schematic representation of how multiple servers and computers work in tandem to enable a library of .XML files or any other digital sheet music files or Digital Elements can be searched by their individual rows and columns.

FIG. 55 is a schematic representation of an example storage system whereby digital sheet music files are parsed by row and column tags along with metadata to allow for digital sheet music files to be recalled as a full entity or individual elements of rows, columns, measure units or specific blocks.

FIG. 56 is a flow chart example of a method for generating a list of row names and column names that will be included within the ‘row’ and ‘column’ metadata linked to each .XML file.

FIG. 57 is a flow chart example of a method for how searchable tags can be generated from digital sheet music files.

FIG. 58 is a flow chart example of a method for extracting and storing tags for Metadata.

FIG. 59 is a graphical representation of a GUI for structuring the library of digital sheet music to be searched by its individual components found within the Linked elements

FIG. 60 is a flow chart example of a workflow for filtering. XML files.

FIG. 61 is a graphical representation of a GUI for filtering by song, with further sub filtering.

FIG. 62 is a flow chart example of a method for song filtering.

FIG. 63 is a flow chart example of a method for further song filtering.

FIG. 64 is a flow chart example of a method for artist filtering.

FIG. 65 is a flow chart example of a method for instrument filtering.

FIG. 66 is a graphical representation of a GUI that displays how results from instrumentalist searches are viewed as a series of blocks within a grid.

FIG. 67 is a flow chart example of a method for displaying instruments parts by Blocks.

FIG. 68 is a graphical representation of a GUI through which a user selects a role within the system and the system whereby a primary and receiver device share a session ID to participate in a shared connection.

FIG. 69 is a graphical representation of a GUI presented by the Primary Device shown in FIG. 12.

FIGS. 70A and 70B illustrates an example workflow for the uploading of files and storing of files in a cloud-based system to enable recalling by Primary and Receiver Devices.

FIG. 71 illustrates various examples of graphical user interfaces for the displaying of Linked Elements.

FIG. 72 is a schematic representation of the effect of engaging a Jigsaw Fit on a series of blocks.

FIG. 73 is a graphical representation of a GUI through which multiple blocks within the Timeline can be selected, then saved with custom metadata such as a name, then be later recalled in the library of Linked Elements in a grouping of ‘custom’ songs.

### DETAILED DESCRIPTION OF THE INVENTION

The following detailed description provides examples of implementations of the present subject matter. This disclosure provides a system and method for the processing, editing, sending, and saving of digital sheet music through the use of a latent space Block representation. This is encapsulated and enabled by a series of connected Primary Device(s) and/or Receiver Device(s) that allows for real time modification of sheet music and synchronized displaying between the devices.

The following explanations of terms used in the document are intended to provide context for the detailed descriptions provided further herein. These explanations are used to provide contextual examples and are not intended to be substitutes for the plain and ordinary meaning of the terms used throughout the disclosure.

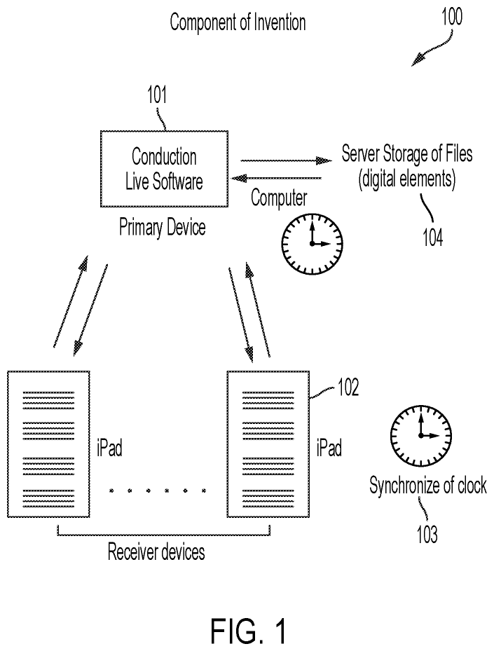

A first set of explanations relate to the devices and users, for example, those shown in the accompanying FIG. 1.

Primary Device (FIG. 1, Item 101): a software or hardware console (computer, tablet, cellular device, etc.) that is designed to manipulate, display, edit, and send Digital Elements through the use of representative Blocks; the modifications made on the Primary Device can be made viewable to the Receiver Devices.

Primary User: a user who operates the Primary Device.

Receiver Device (FIG. 1, Item 102): a software or hardware console that is designed to display representative Blocks from the primary device, as the original Digital Element format or in Block representation, if the user of the Receiver Device so desires.

Receiver User: a user who operates the Receiver Device.

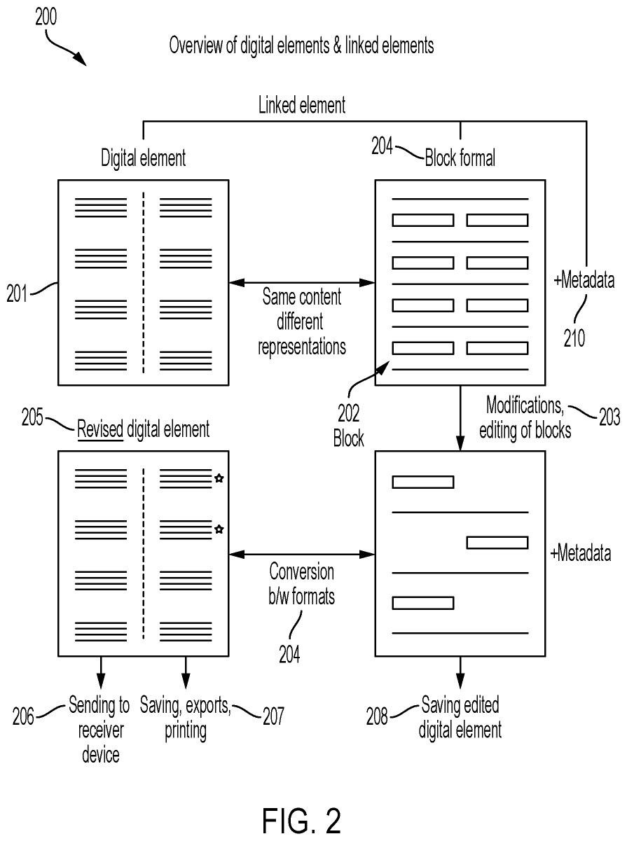

A second set of explanations relate to the library elements, for example, those shown in the accompanying FIG. 2.

Digital Elements (FIG. 2, Item 201): in the setting of digital sheet music, a Digital Element represents a digital sheet music notation file often in the format of a .XML file as described throughout this application; however, Digital Element can encompass any other file format. This can include file formats of text, images, audio, graphics, or any other common file format. This Digital Element can be represented through a latent form as a series of Blocks, as described further herein. The system described here for the editing of these Digital Elements through representative blocks and sending/synchronization/displaying between Primary and Receiver devices can be used for any file format as a Digital Element, here the description primarily focuses on the realm of digital sheet music. These digital sheet music files can be represented by images (.PNG, .PDF, any other file format), sheet music as represented by file formats native to music editing softwares (.XML, .MXL, .MIDI, .MUSX, any other file formats), or any other file format for sheet music that is used within the music industry. Within this document, anywhere written as ‘digital sheet music’ can also mean any other Digital Element. For example, this same system could be used with a theatrical script, whereby the theatrical script as a Digital Element natively exists as a text file, but when converted and used in this software is represented as a Block format, then reconverted back to its original file format as text and displayed on a Receiver Device.

Blocks (FIG. 2, Item 202): simple digital representations of Digital Elements. These blocks can be representations of a full Digital Element in its entirety or a segment of a Digital Element. In the setting of sheet music, the entire sheet music score is generally considered to be a series of music bars. Thus, when the Digital Element in this system is represented as blocks, through a series of definitions described later, each music bar can be represented as an independent easy to manipulate Block. Blocks may be divided differently than by measure, as will be understood by those skilled in the art based on the teachings provided herein.

Revised Digital Elements (FIG. 2, Item 205): once Digital Elements are represented as Blocks and manipulated and edited, they can be transformed back to the original Digital Element format, now as a revised version based on the manipulations made in the Block latent space. In an example, digital sheet music can be represented as a block, then the volume can be changed on the block, then when it is converted back to its original digital element format as digital sheet music, it is now a revised digital element with the volume change reflected in its native format, changed per se from ‘piano’ to ‘forte’.

Metadata: information associated with each Digital Element. Metadata includes but is not limited to user-generated information about the Digital Element. In the music context, this can include tempo, key signature, playlist, instrumentation available, .MP3 files or any other associated files to the Digital Element, and any text or information that is linked to a given Digital Element. This Metadata is used in the system to enable searching of files. Importantly, Metadata can be ascribed to entire Digital Elements, or individual representative Blocks of segments of a Digital Element. In this way, uniquely, segments of an overall Digital Element file can be searched. In an example, this would mean that one bar of a single bass line can be searched and recalled from a library as opposed to just being able to search for the whole song that contains a bass line.

Linked Elements (FIG. 2, Item 209): a single file or groups of files that are callable from a Library of Linked Elements. Linked Elements are single entities within a database that contain multiple fields of data and files. This includes, but is not limited to, the Digital Element native file, the latent Block representative format, any Revised formats of these representations, and Metadata.

Library: a listing of Linked Elements which contain a series of Digital Elements with linked Metadata and latent Block representations.

Bundle: a Linked Element which is a representation of multiple Blocks from the same or a different Linked Element. Bundles are the sum of the individual Blocks in which it contains, allowing for the mass-modification of the Blocks in which it contains.

Track: a given row in the Latent Block representation; in sheet music this is commonly represented as a single instrumentalist's music notation; this system enables a given track to represent multiple instrumentalists notation, whereby a modification made to a tracks Block may effect a change across multiple instrumentalists music notation. The makeup of what instrumentalists are contained within a Track, may be defined by the Primary User or assigned automatically by the system, as described further herein.

Region: a column in the Latent Block Representation. This can be defined by the Primary User and can be in functional units as set by preference (i.e. individual measures, verses/choruses, chunks of 16 measures, units of time, etc.)

Another set of explanations relate to the modifying and sending of Elements.

Prep Area: a gridded area of Tracks and Regions, where Blocks and Bundles can be modified, modulated, assembled or any other form of modification. This region does not move with respect to time, when the Primary User begins a performance. It is an intended space for the Primary User to store and save active working material. Material in the prep area may or may not be visible, as defined by user preferences to the Receiver Devices.

Burn Threshold: a selected threshold of time that delineates when changes to Blocks are no longer possible and/or will not change on the Receiver Device's display area. The Burn Threshold may be user defined and changed through the Primary Device or Receiver Device. The Burn Threshold may be visually depicted on the Primary and Receiver Devices as described further herein.

Mid-Live Area: gridded area with Block and Bundles to allow for the assembly and organized placement of Blocks and Bundles in preparation to be made live. The length of time ranges from the Burn Threshold to an infinite amount of time.

Live Area: gridded area with Block and Bundles. The length of time ranges from ‘current’/‘0:00’ time to the Burn Threshold.

Timeline: the area corresponding to the Prep, Mid-Live, and Live Areas. It is possible for the timeline to only contain one or multiple of these sections.

Turning now to an overview of the systems and methods provided herein. Beginning on FIG. 1, the system of Primary and Receiver Devices is depicted in summary. This system allows for the direct manipulation, editing, sending and saving of Digital Elements, and in this specific case use—sheet music—through the use of representative Blocks to be sent from a Primary Device (FIG. 1, Item 101) to Receiver Devices (FIG. 1, Item 102), whereby these Receiver Devices can display the digital sheet music as it is modified by the Primary Device. When executed, Primary Devices and Receiver Devices can be synchronized for the direct sending and receiving of digital sheet music and representative Blocks across a common clock (FIG. 1, Item 103). This common clock can be conveyed to the Primary and Receiver Users through an auditory click that is transmitted and amplified through the devices, a visual signal as represented by a flash, or another common conveyance of tempo within the music industry.

These digital sheet music files and the associated linked elements that are accessed by the Primary Device and the Receiver Devices are accessed via a cloud-based server, or hard drive, or any other storage container for digital files (FIG. 1, Item 104). These files are fetched, then modulated and resaved. New files can be generated on the Primary Device, then either stored on the Primary Device, or resaved back to a separate storage device.

Turning to FIG. 2, this system includes a distinct representation whereby a Digital Element, in one case being the digital sheet music, is represented by a series of blocks which enables the overall workflow of the system. The ability to convert between the digital sheet music and the block representation in both directions enables this system to easily modify digital sheet music through a series of blocks, yet display the digital sheet music back to Receiver devices as the native digital sheet music format.

This solution, unique and separate from any other current technology, allows a Primary User in operating a Primary Device to do each of the following:
1. Select a given Linked Element through the use of a Library. In an example, this could be a specific song name, a specific instrumentalist part from a specific song, or in a more granular format, select a specific group of measures from a specific song and from a specific instrumentalist part (i.e. bars 10-20 from the bass line of song X).
2. View this digital sheet music as series of representative Blocks (FIG. 2, Items 201, 202); the Primary User can then use the Primary Device to listen to various audio representations of the digital sheet music.
3. Optionally, edit and manipulate the digital sheet music through the use of representative Blocks (FIG. 2, Item 203); saving of Revised Blocks for further modulation and recalling in the library (FIG. 2, Item 208).
4. Convert the manipulated Blocks back to digital sheet music format (FIG. 2, Item 202) thereby creating a Revised Linked Element that can be recalled within the library (FIG. 2, Item 205), or exported.
5. Send, in a synchronized fashion, the digital sheet music from Primary Devices to Receiver Devices. As described further herein, this occurs through a unique defined graphical user interface to show Receiver Users when modifications are made to the digital sheet music and how the digital sheet music is performed in time (FIG. 2, Item 206).
6. Save and export revised digital sheet music (FIG. 2, Item 207); in an example the newly revised composition created in block format can be converted to a digital sheet music notation format such as a .XML file or .PDF file of a music notation score.
7. Receive signals sent from a Receiver Device to a Primary Device or other Receiver Device.

The system and method then allows for a Receiver Device (used by a Receiver User) to:
1. Display signals such as the digital sheet music or direct messages, sent from the Primary Device.
2. Receive and send signals between the Receiver Device and a Primary Device or another Receiver Device. In an example, this could be a request to perform a solo, or a signal that there is a problem on the Receiver Device.
3. Display warning signals that inform the Receiver User of changes to the display.
4. Display and signal to a Receiver User information common to the synchronization and connection between devices (tempo, key signature, current bar position, and other common signals).

This system connecting a Primary Device to Receiver Devices may be enabled through the use of WiFi, cable connections, or any other communication method.

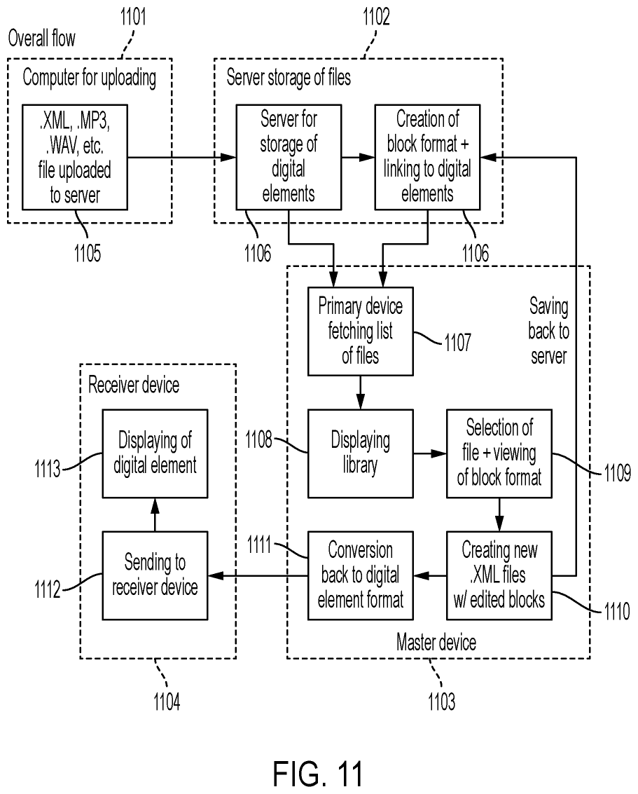

Turning now to FIG. 11, there are four main components to the functioning system. The first two elements in the system enable the direct uploading and file preference defining of the digital sheet music. The first element is a computing device (e.g., laptop computer, tablet, smartphone, etc.) (FIG. 11, Item 1101) with a graphical user interface which allows for a user to take files such as .XML, .WAV, .MP3 and upload them to the second element of the system—a storage unit for these files (FIG. 11, Item 1102).

As described above, there is then a third element of the system, the Primary Device (FIG. 11, Item 1103), that is used to fetch files from the storage unit, modify the files, create new files, save and export the files, and primarily, send the files to the fourth element of the system, the Receiver Devices (FIG. 11, Item 1104). These Receiver Devices then display the files from the Primary Device either directly sent from the Primary Device, or by accessing a specific file as dictated by the Primary Device, directly from the storage server of files.

As visually depicted in FIG. 11, these components work in tandem with one another through the following workflow. First, through a graphical user interface, a user takes .XML, .MP3, .WAV or other audio files and uploads them to the storage server (FIG. 11, Item 1105). During this process, there is other information that is input into the system that is then linked to each of the files—thereby creating a tagging system within the server, for easy access by the other devices. During this process, the system also generates all of the necessary inputs from the .XML files to create the block representation of the digital element (FIG. 11, Item 1106). Next, the Primary Device through the user of a Primary User can access and fetch files from the server (FIG. 11, Item 1107). From here, these files can then be displayed as a list in the form of a library on the graphical user interface of the Primary Device (FIG. 11, Item 1108). When a file is selected, it can then be viewed as a block representation format on the Primary Device; then elements of the block representation can be selected, modified, combined with other block representation forms of digital sheet music (FIG. 11, Item 1109). The combination of representative blocks are thus used to create a new .XML file containing the revised, combined or edited blocks (FIG. 11, Item 1110). In this way, the series of blocks from the block representation are converted back to the original digital element format (.XML) (FIG. 11, Item 1111). This format can be passed back to the storage server, or then directly sent to receiver devices (FIG. 11, Item 1112). The digital element format created from the Primary Device is then displayed on the receiver devices graphical user interface, through either direct receipt from the Primary Device or through receipt of instruction to access the server storage of files, or local files available within the Receiver Device (FIG. 11, Item 1113).

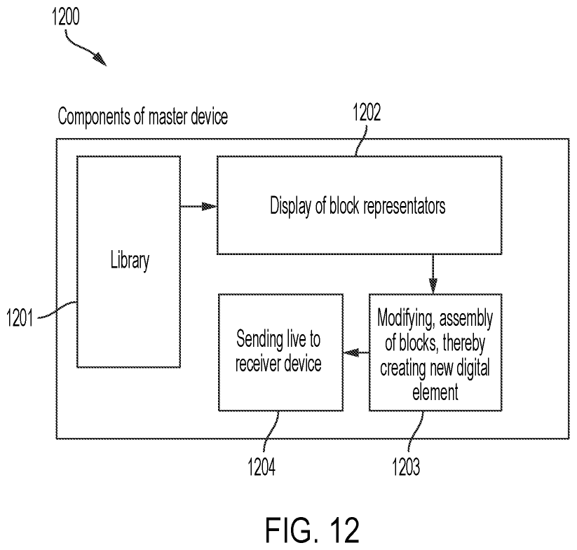

Turning to FIG. 12, the Primary Device has a graphical user interface that is directly linked to its functional workflow. The Primary Device contains a series of graphical user interface components to execute the manipulation of digital sheet music through representative Blocks for eventual sending to Receiver Devices, or otherwise saving or exporting. The Primary Device ultimately enables these functionalities through the following components: a Library of Linked Elements (FIG. 12, Item 1200), a mechanism and method for Block viewing of the digital sheet music or the digital sheet music itself (FIG. 12, Item 1202), a mechanism and method for Block editing and assembling (FIG. 12, Item 1203), and a mechanism and method for Block sending, saving, exporting, communicating with Receiver Device (FIG. 12, Item 1204).

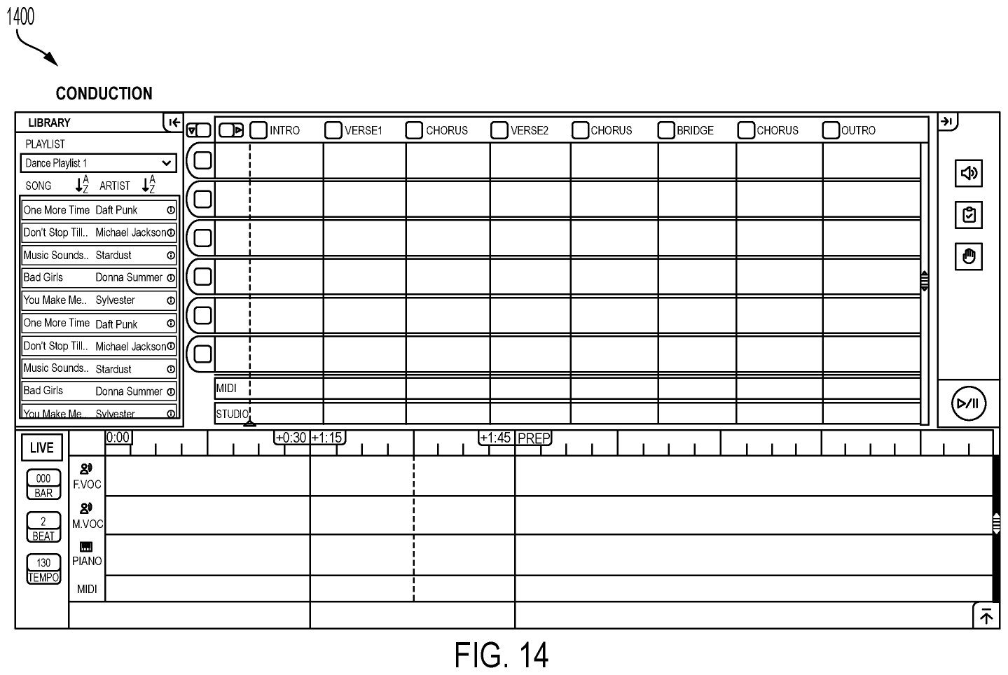

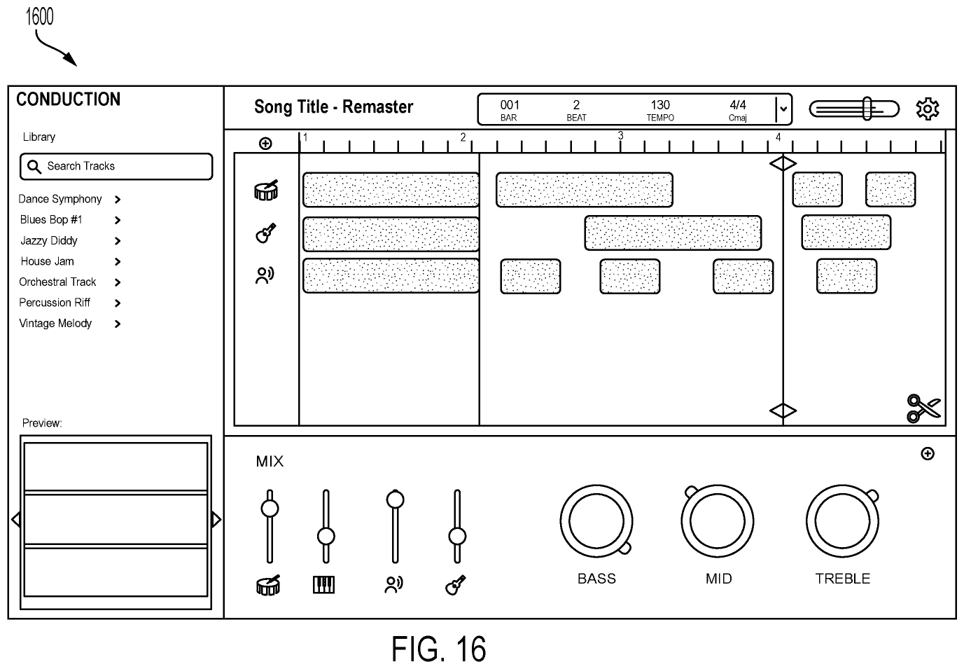

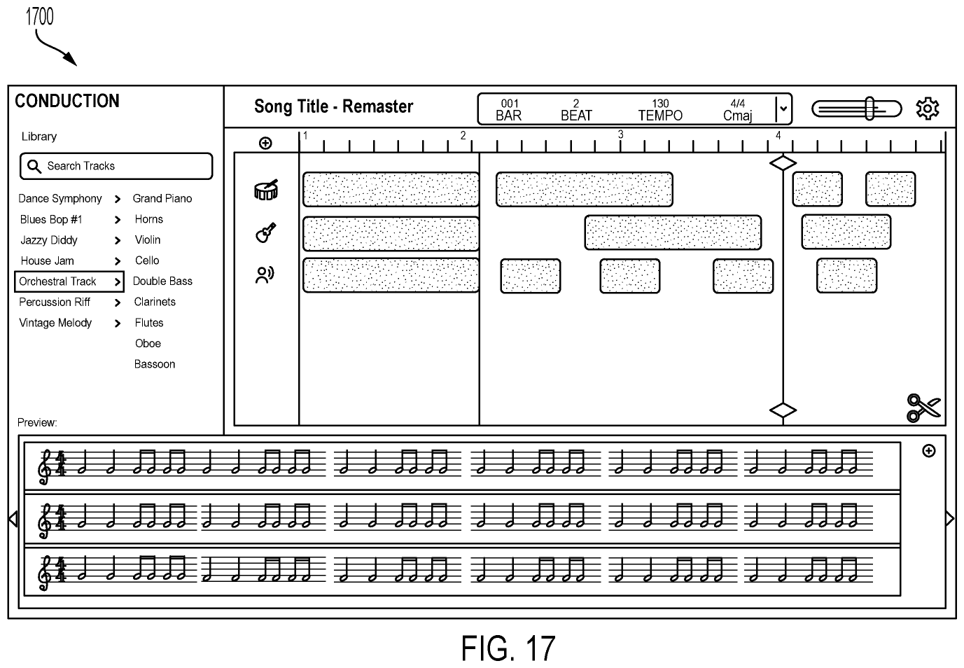

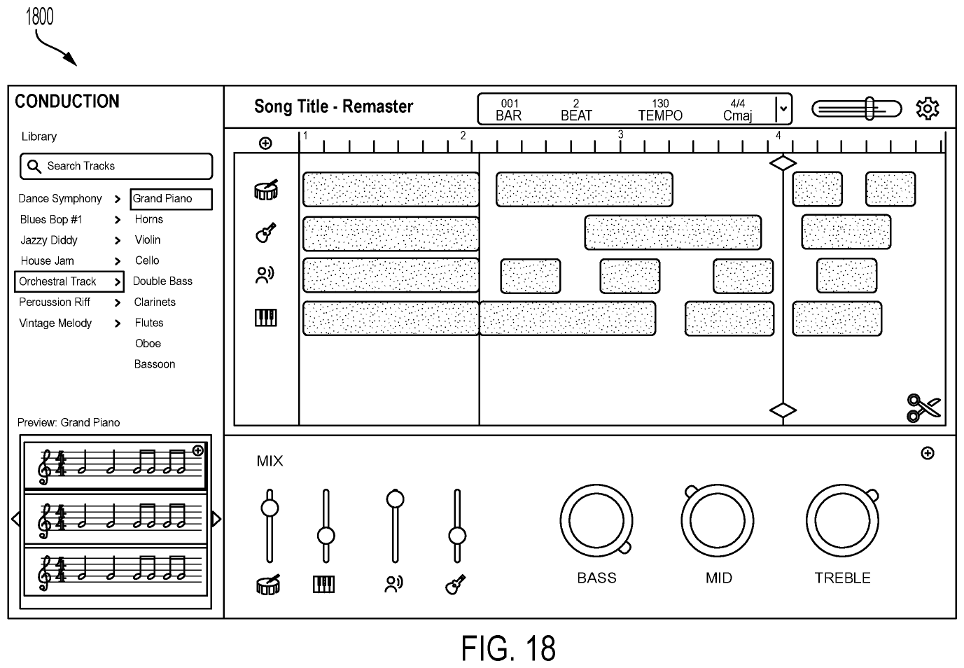

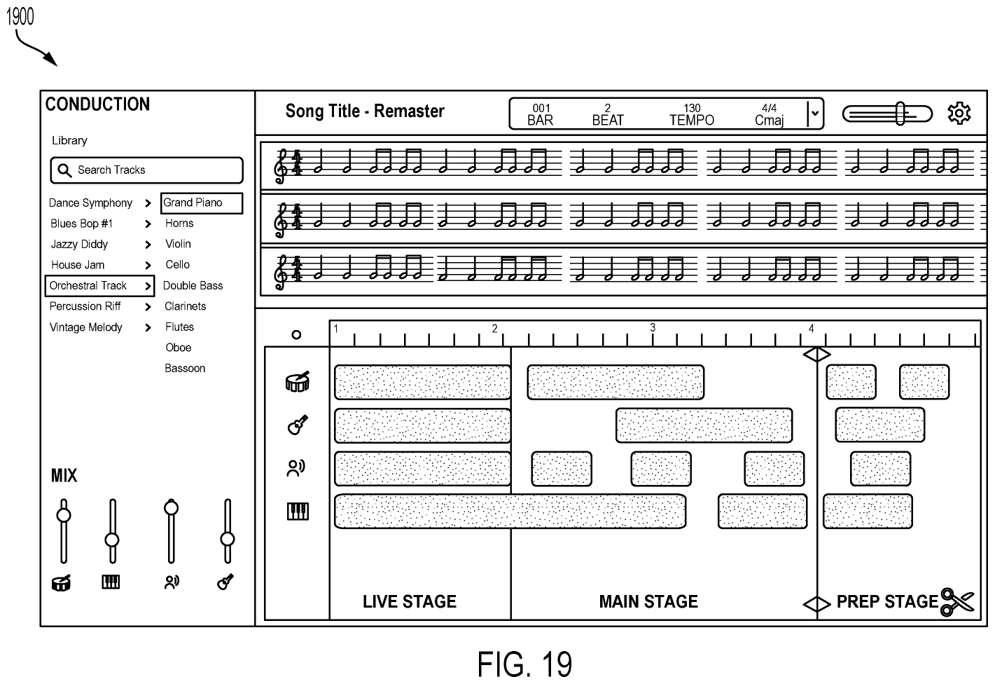

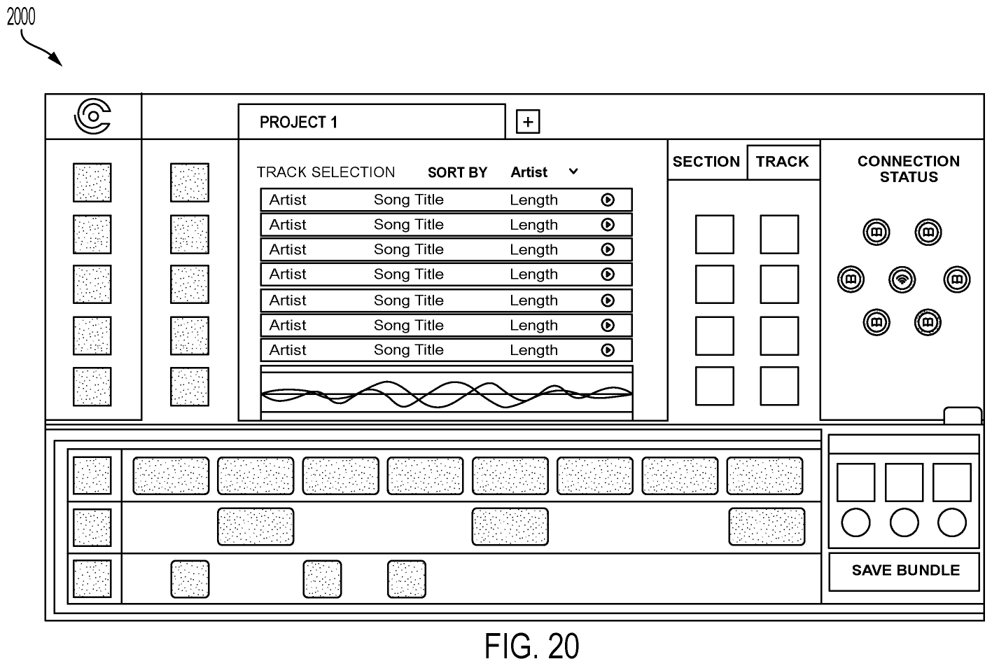

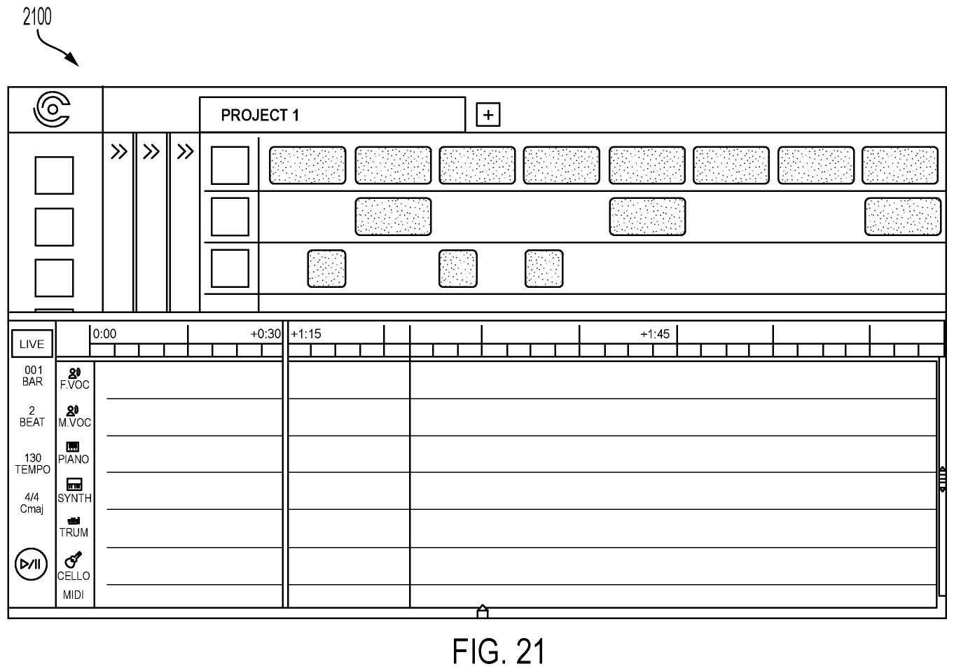

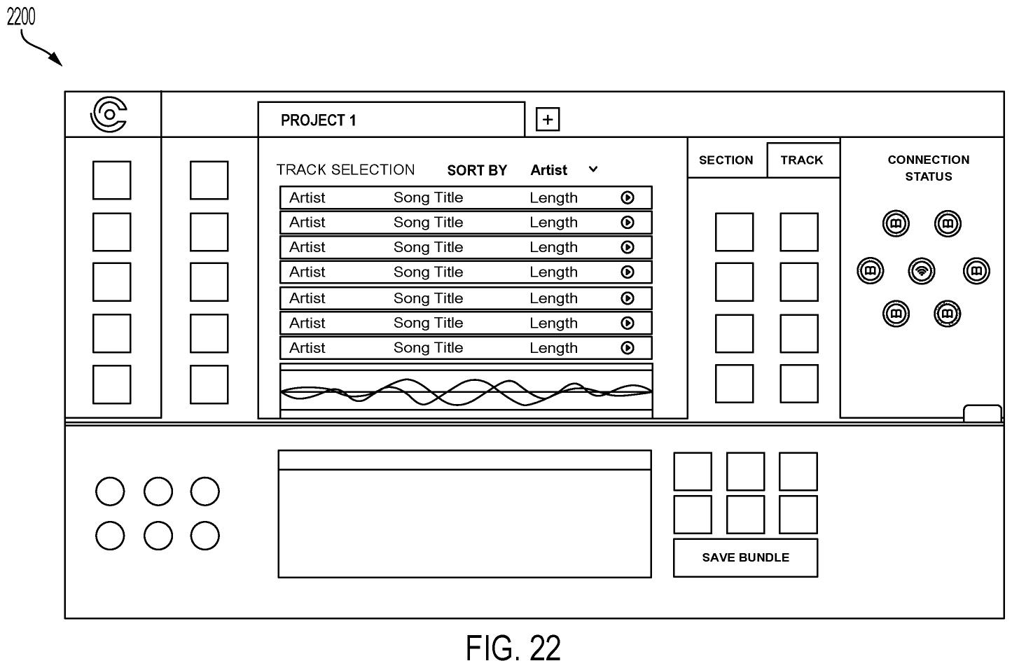

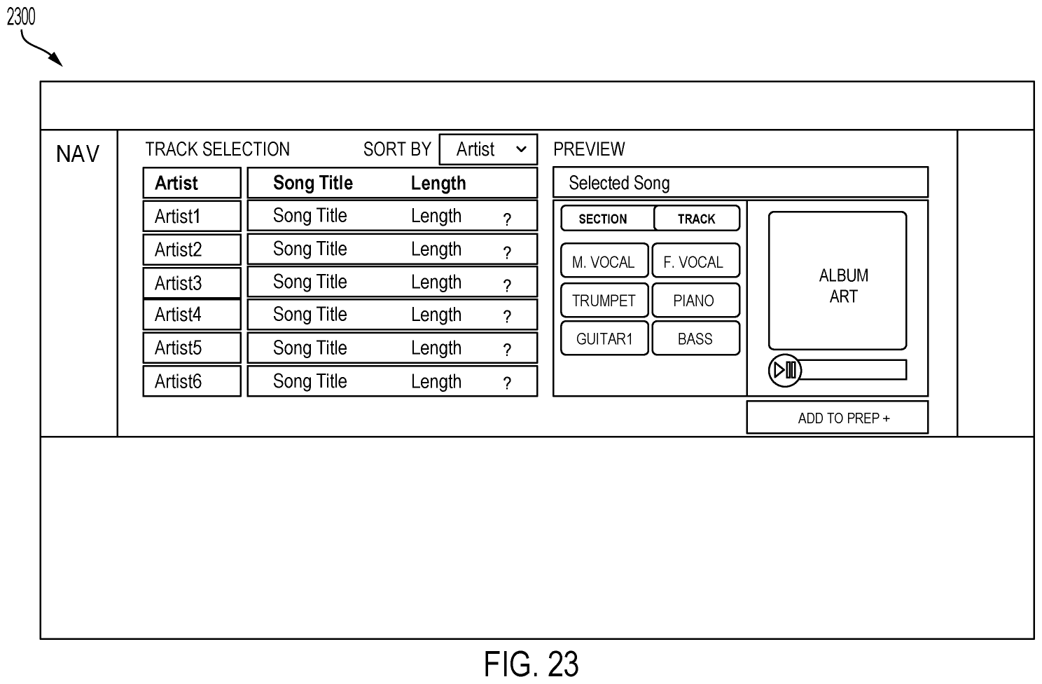

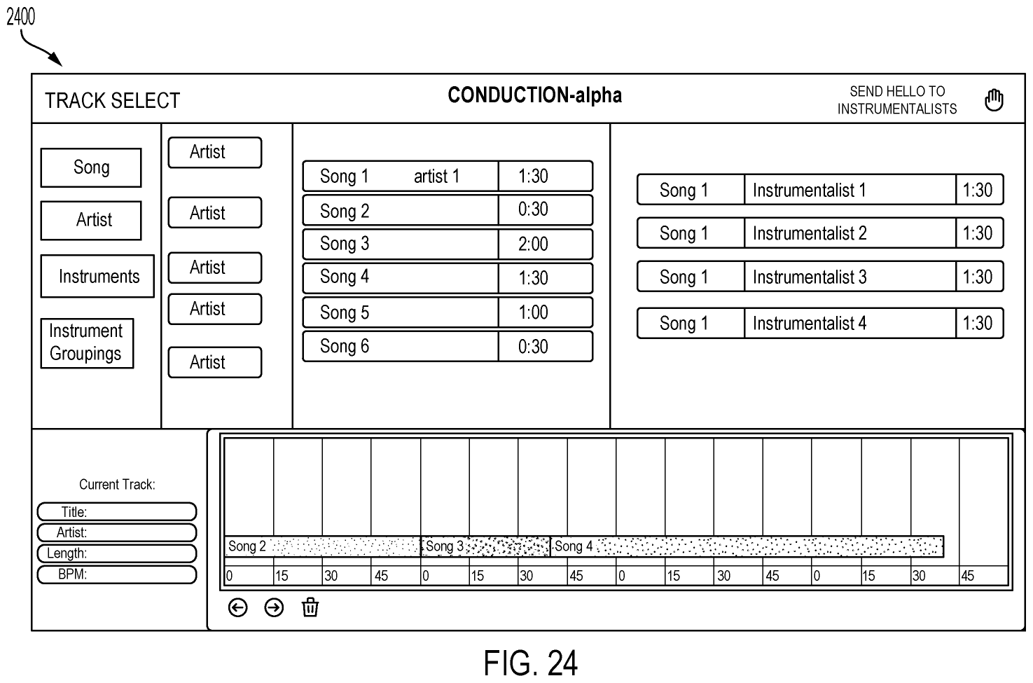

FIGS. 14-24, and FIG. 69 depict iterations of the user interface of the Primary Device along with its functional components.

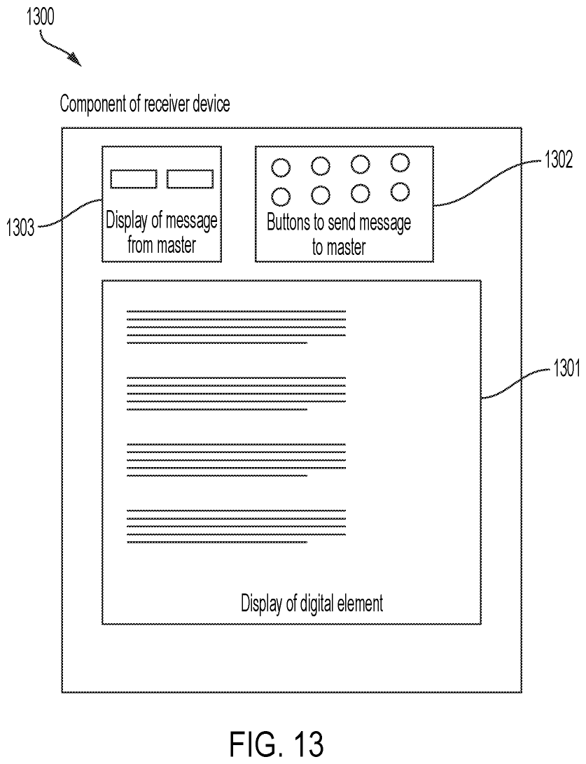

Turning to FIG. 13, the Receiver Device, similar to the Primary Device, has a user interface that reflects the functional uses and workflow of the device itself. The Receiver Device is used to display the digital sheet music, display signals from the Primary Device and send signals through the use of buttons to the Primary Device or other Receiver Devices. The Receiver Device, commonly an iPad but not limited to other devices such as tablets or computers or monitors, has an area on its graphical user interface that displays the digital sheet music (FIG. 13, Item 1301). The Receiver Device also has a panel of buttons that are used to communicate back with the Primary Device (FIG. 13, Item 1302). The Receiver Device also has a graphical user interface that allows for the receiving of other signals such as texts and images to relay messages being sent from the Primary Device (FIG. 13, Item 1303). Within the Receiver Device's display of digital elements (FIG. 13, Item 1301), there are regions that graphically indicate to a user which regions are ‘currently live’ within the synchronized clock between the Primary Device and the Receiver Device, which regions are ‘in the past’ (prior to the current time of the synchronized clock) and which regions are ‘in the future’ (future to the current time on the synchronized clock).

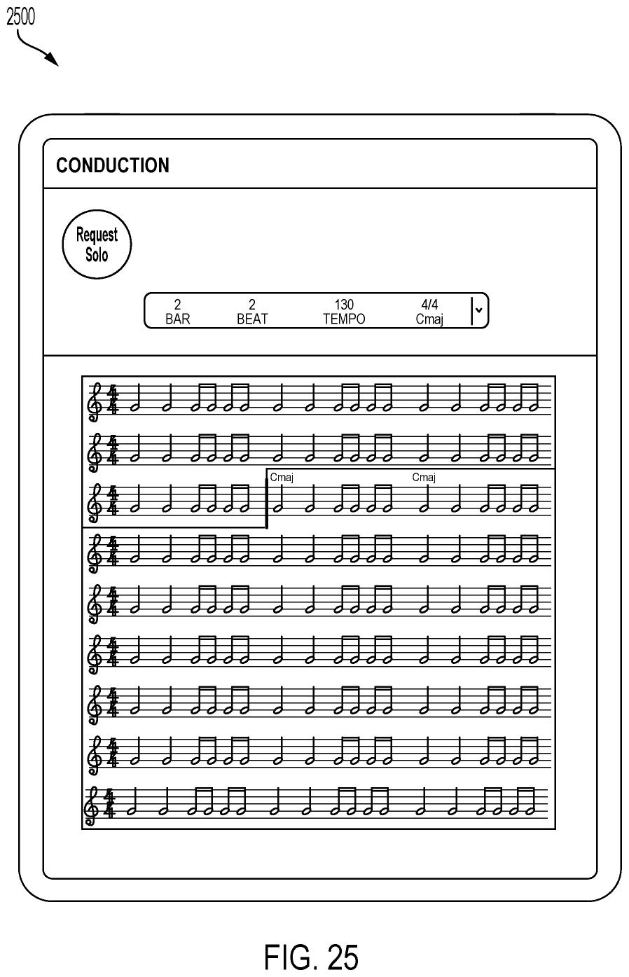

FIG. 25 depicts an example of the user interface for the Receiver Device. In this example, there is a display area showing what song is currently being displayed as the digital sheet music on the interface at the top of the user interface. There is also a display area that is showing what the current bar number, beat number, tempo of the songs, key signature, and time signature of the song. There is also an example interface shown for allowing the Receiver User to request a solo, which as a functionality is described in greater detail later. The Receiver Device depicted in this figure also has an example area for the display of the digital sheet music, color coded dependent on which portions have already been played, which portions are currently within the Burn Threshold and which regions are upcoming and may be from a different song. These visual characterizations are described in detail later in the document. There is also a time head that follows along on the display of the Digital Element in correspondence with the current time of the synchronized clock.

In one embodiment, the Primary and Receiver Devices are connected through an internet connection, enabling all Devices to exist on a common connection. As previously described, they may also be connected and synchronized via a specific set session ID that both devices input and set, so that multiple Primary and Receiver Devices may operate exclusive from one another. The connection between the devices can occur through a server connection or a direct wired connection or any other common method to allow devices to be connected and communicate with one another. This system also includes connection with a common repository of files that can exist on both the Primary and Receiver Devices, or in a cloud based system.

The Primary and Receiver Devices are aligned via a common clock system to enable a timed release and viewing of objects according to a schedule agreed upon by the Primary and Receiver Devices. This common clock can exist in units of minutes, seconds, milliseconds and hours, however can commonly be represented through a common time unit as dictated by the format of the Digital Element. For example, in sheet music, the agreed upon time unit may be music measure bars, or the tempo of the song.

The synchronization of the Primary and Receiver devices may additionally utilize an audible element to the synchronization, commonly or colloquially known as a ‘click’. Users of the Primary and Receiver Devices thereby all hear a commonly synchronized audio signal that indicates for example the start of measures and subsequent quarter notes of a song. These synchronized elements can additionally include audio messages such as indications of upcoming changes, or direct audio communication between the Primary User and Receiver Users. These audio messages may also be generated automatically and transmitted via the common clock based on modifications made by the Primary User. This synchronization between the Primary Device and Receiver Device is what enables the synchronized time displaying of representative block formats and digital elements on the primary and receiver device respectively. This can also be achieved through the use of an external audio machine that produces an audio ‘click tone’, that is connected to the Primary or Receiver Device, and then the system of synchronized clock can match the ‘click tone’ of the audio produced on the external device.

The connection between the Primary and Receiver Devices can also involve an audio system whereby they can communicate audio to one another through microphones. For example, the musician can press an intercom button to talk to the DJ and vice versa.

The functional unit of this system is a Linked Element. All linked elements are stored within a server or other common system for the storing of files. A Linked Element contains three key data structures. The first is a digital element. In the setting of music applications of this system, the digital element would be digital sheet music notation files. The second element stored with the Digital Element is a block representation of the Digital Element. This block representation of the Digital Element can be stored within the server as a numerical set of rows and columns that can be later reconstructed to display by the Primary Device. Finally, the Linked Element also contains metadata regarding the Digital Element. This information is both created by the system based on the Digital Element uploaded by the user, and both edited by the user. All files may be modified by the user through the use of the graphical user interfaces on the file uploading computer (FIG. 11, Item 1101), the Primary Device (FIG. 11, Item 1103), or the Receiver Device (FIG. 11, Item 1104).

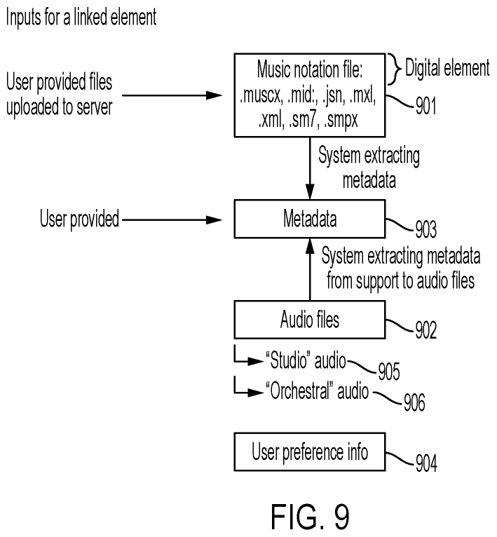

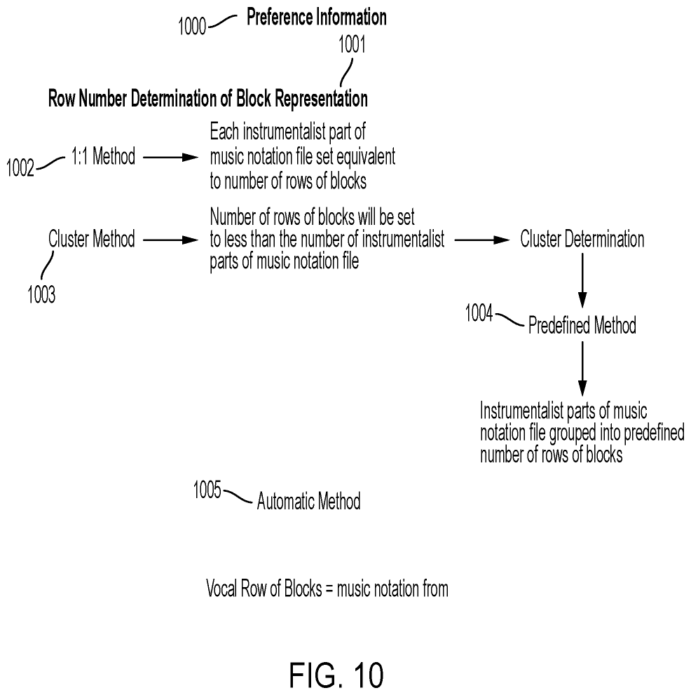

FIG. 9 illustrates the delineation of the types of files that serve as inputs to the example of the system illustrated in the figures. This system of Primary Device and Receiver Devices and all the functionalities that they do, ultimately relies on but is not limited to, four User provided types of data—music notation files (FIG. 9, Item 901), audio files (FIG. 9, Item 902), metadata (FIG. 9, Item 903), user preference information (FIG. 9, Item 904). These inputs within the system are associated with one another and saved to create a Linked Element. These files are further processed to generate a Block representation of the Linked Element, which is used by the Primary Device. It is common that a user uses a computer with a web-based interface to upload all of the input files into a server that stores this information so the Primary Device and Receiver Device may recall each of these files. However, it is possible for the files to also be stored directly onto a hardware device such as the Primary and Receiver devices, thus avoiding the Primary and Receiver Devices needing to access a cloud-based server. It is also possible for the files to be stored on a common hardware storage unit and the Primary and Receiver Devices each connect directly to the hardware storage unit.

The music notation files (FIG. 9, Item 901) are uploaded to a web passed portal that stores each of the files. The music notation file is a digital representation of sheet music for a particular audio sample. This exists in multiple different forms including file types such as .MUSX, .MIDI, .LSN, .MXL, .XML, .SMZ, .SMPX, .MUS, .MSCZ, .MSCX, .SCID. These are what are considered the Digital Elements. Digital Elements can exist as other file extensions and also be file types other than digital sheet music.

A user may or may not upload audio files that are associated with the music notation file. One audio file that may be uploaded is a ‘studio’ version of the music notation file (FIG. 9, Item 905). This is an audio file that represents a live performance or a recording of the music notation file being performed or the studio recording of the song that the music notation file represents. This may exist in any common audio file format. Another file that may be uploaded is an ‘orchestral’ audio version of the music notation file. This audio file represents a direct performance of the music notation file, or a MIDI version of the music notation file. This may exist in any common audio file format. If the ‘orchestral’ audio file is not provided, the music notation file is converted to an audio file format. These are two examples of how these audio requirements can be met, however it is possible for the user to put any kind of audio associated with each of these Linked Elements. As described later, if a given Digital Element, in this setting a digital sheet music, contains rehearsal markings or other markers within a digital sheet music file to indicate specific sections, each of the audio files will be matched with the rehearsal markings that exist within the digital sheet music. These rehearsal markings can then be graphically displayed on the region where audio files are displayed.

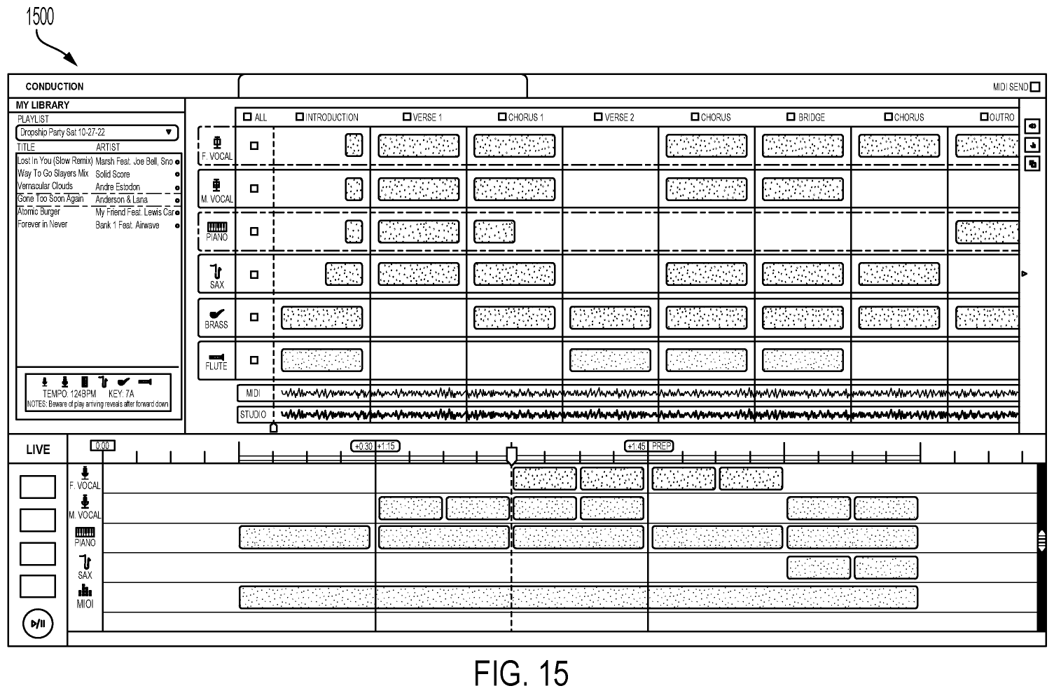

As shown in FIG. 15, in some examples, each of the audio files are aligned with the same rehearsal markings or time measure markings that are inherent to the digital sheet music or calculated by the system, as described further herein.

For every music notation file or Digital Element, there is a series of Metadata text and image-based information that is associated with the music notation file. This is input either through the Primary Device or through a separate web-based interface. This information can include but is not limited to, the tempo of the song, the name of the song, the artist of the song, the instruments provided within this song, the length of the song, the number of measures in the song, the key signature of the song, etc. This information can be provided either through text input of the information or selection from a drop-down menu or any other common methods for selection of text options. If any of the information is not provided by the user, the system parses through the user provided music notation file and the audio file and identifies this Metadata information if available within the other files, and uses that as stored Metadata. The user may overwrite any of the associated metadata identified by the system.

Within this system, it is possible for each of the files that are uploaded to be linked to specific user profiles and accounts that are stored within a server-based system. In this way, as users upload specific files, they can be directly recalled by logging into a given user profile on any of the Devices, logging into their given profile and accessing their files. Individual users through operating preferences for their individual account may be able to control the privacy of their files.

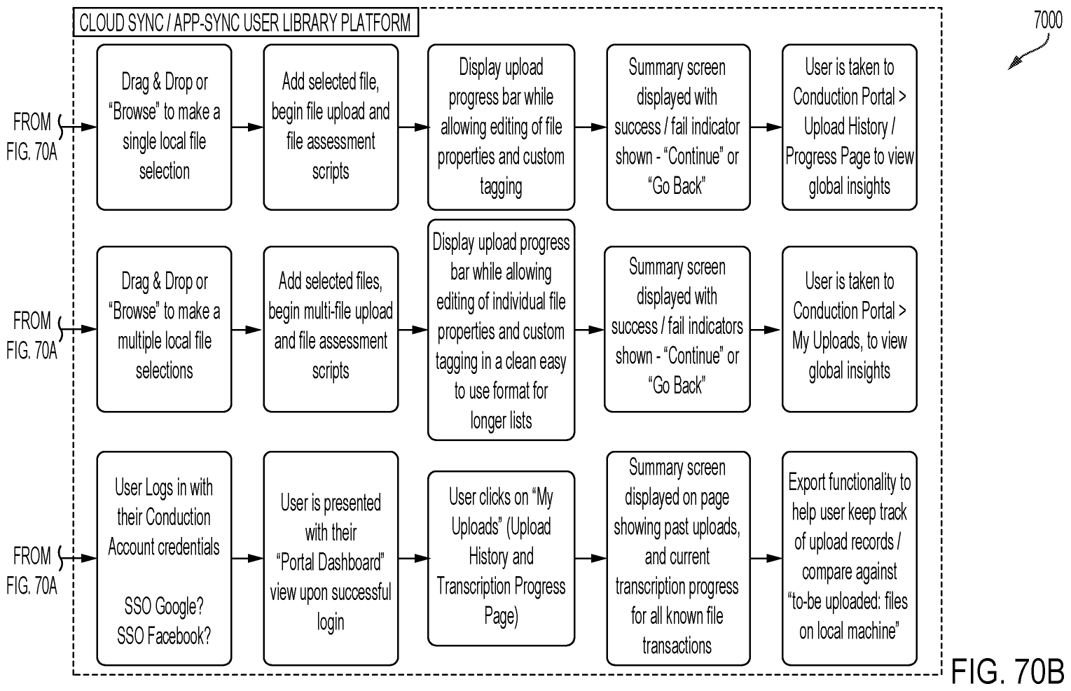

Turning to FIG. 70, an example workflow is described for the uploading of files and storing of files in a cloud-based system to enable recalling by Primary and Receiver Devices.

In the principal examples used herein, the Primary Device is ultimately used to modify Digital Elements such as digital sheet music. As discussed, this is accomplished by modifying the digital sheet music through an interface that removes the graphics of digital sheet music, and allows a Primary User to modulate the digital sheet music through a series of graphics that are easy to manipulate. One such manifestation of this, is to represent the Digital Elements such as digital sheet music as a series of blocks.

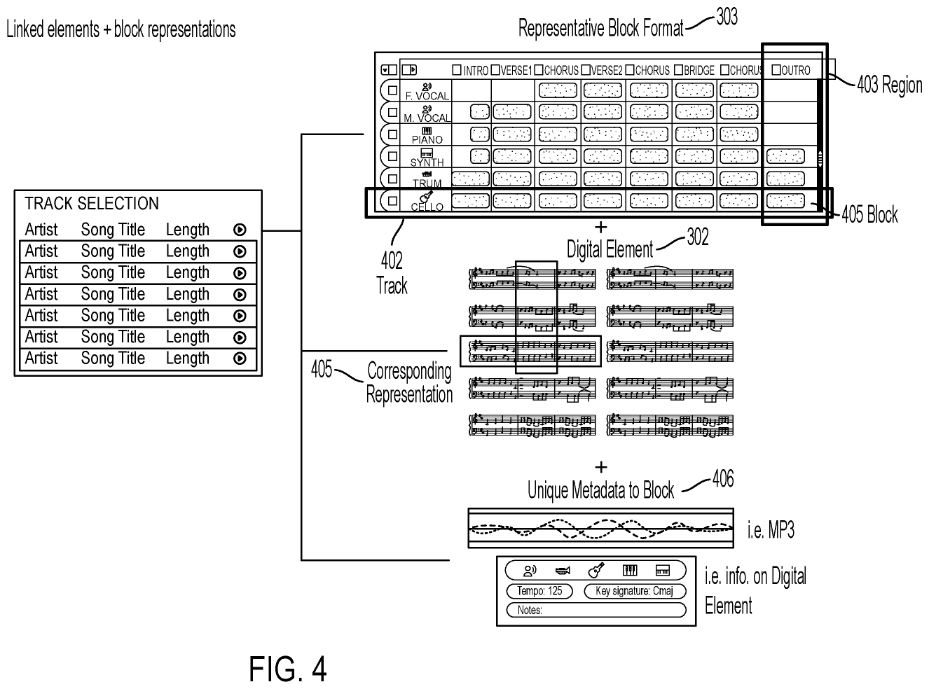

FIG. 4 illustrates a visual representation of blocks that correspond directly to individual locations within a Digital Element such as digital sheet music. The Block Representation is viewable as a system of blocks which correspond to individual parsed elements of the music notation file or Digital Element. Every individual Block represents a specific area or groups of areas within the Digital Element. The Digital Elements are represented as Blocks through a series of rows and columns that then contain Blocks based on the data within the Digital Element. Every Block Representation contained within a Linked Element has rows herein referred to as Tracks (FIG. 4, Item 402) and columns herein referred to as Regions (FIG. 4, Item 403). The smallest unit of parse-ability of a Block Representation is referred to as a Block (FIG. 4, Item 404). A functional example of a Block on the Block Representation Latent Space could correspond to one single music measure for one single instrumentalist in the Digital Element Space music notation file. In another functional example, the unit of a Block may be a multiple instrumentalist notations over a series of measures. Every Block corresponds to a particular component of the Digital Element format (FIG. 4, Item 405). Every Block is linked to specific Metadata that enables searching within the Library (FIG. 4, Item 406). In this way, Linked Elements contain Digital Elements and Block Representations, and is a sum of all the parse-able Blocks and Digital Elements units. Every Track or Region is the sum of the Blocks in which it contains. The Block representation in this way is a graphical interface wherein every Block corresponds to a region of the Digital Element. The system contains a method whereby the Block representation is created and then can be utilized to modify and process the Digital Element itself.

In order for the Primary Device and Receiver Device to operate utilizing the required files as described above, the systems and methods utilize a system for uploading and handling the files. This is accomplished through a series of graphical user interfaces on multiple devices that draw from files uploaded to a server.

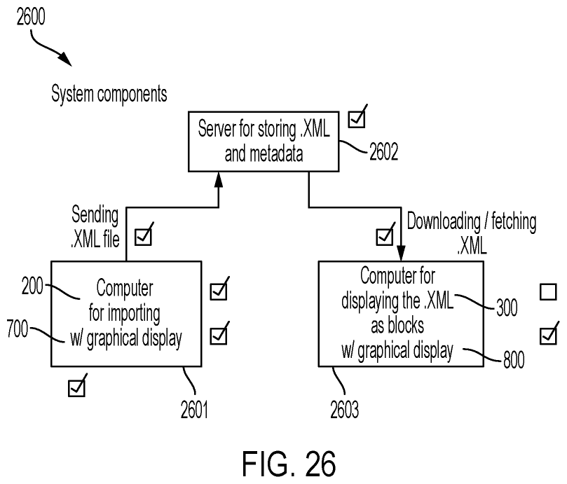

Turning to FIG. 26, an example workflow is described for the handling of the files required for the Primary Device and Receiver Device to function. The example system described here contains three devices that enable the method to work: a computer for importing .XML files, recording metadata of files and displaying files (FIG. 26, Item 2601); a server to store .XML files and associated metadata (FIG. 26, Item 2602); and a computer for displaying .XML files and further modifying files and associated metadata (FIG. 26, Item 2603). This system allows for a computer (FIG. 26, Item 2601) to upload .XML files and metadata to the server (FIG. 26, Item 2602) and subsequently recall/fetch the data from a separate computer for displaying and further modification (FIG. 26, Item 2603). In the following examples, a Digital Element is given in the setting of music notation where the Digital Element file type is commonly a .XML file, however, there may be other file types that can be used in this same way either digital sheet music file types or other file types.

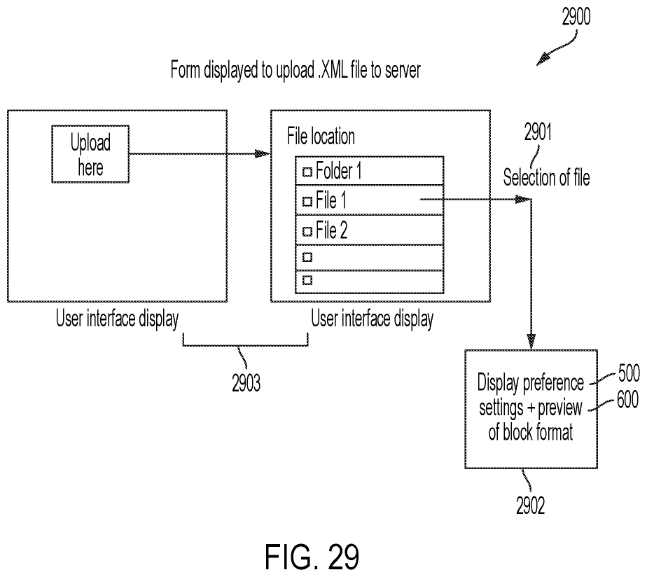

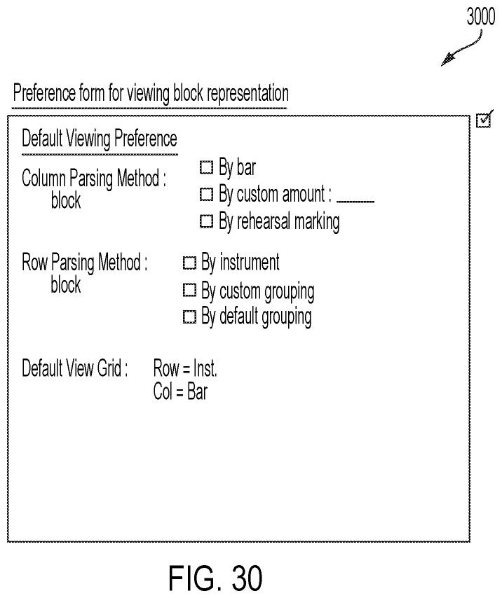

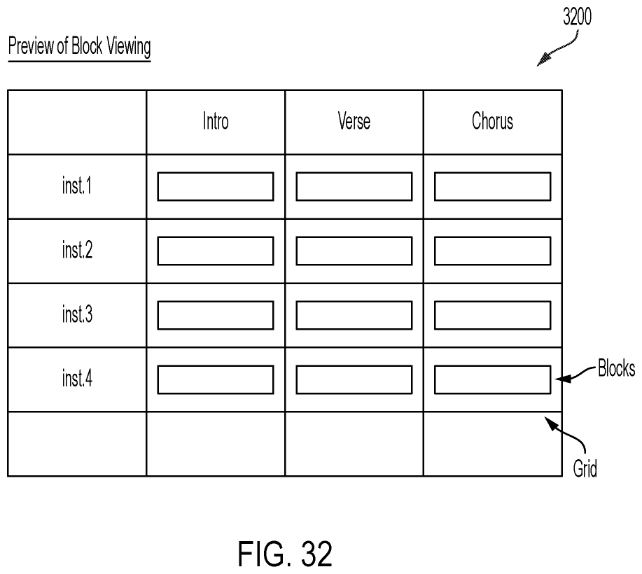

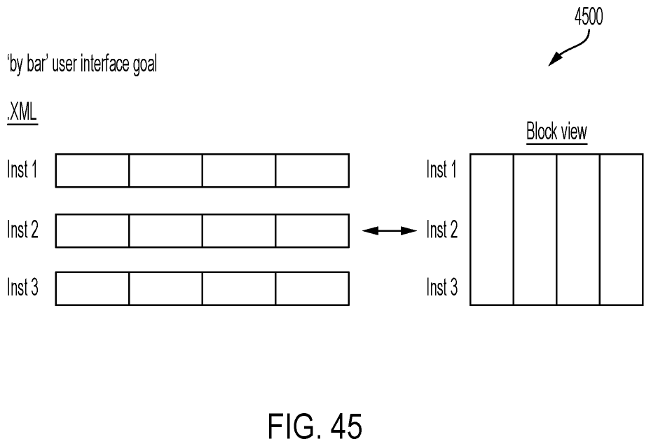

As described herein, the system includes a computer used to upload .XML files to a server. FIG. 29 illustrates an example of a user interface for visually conveying the file upload process to a user. FIG. 30 illustrates an example of a user interface for selecting user preferences for the block representation to be generated. FIG. 44 illustrates an example workflow extracting Metadata directly from a given Digital Element file. FIG. 32 illustrates an example of representing Digital Elements as a block representation.

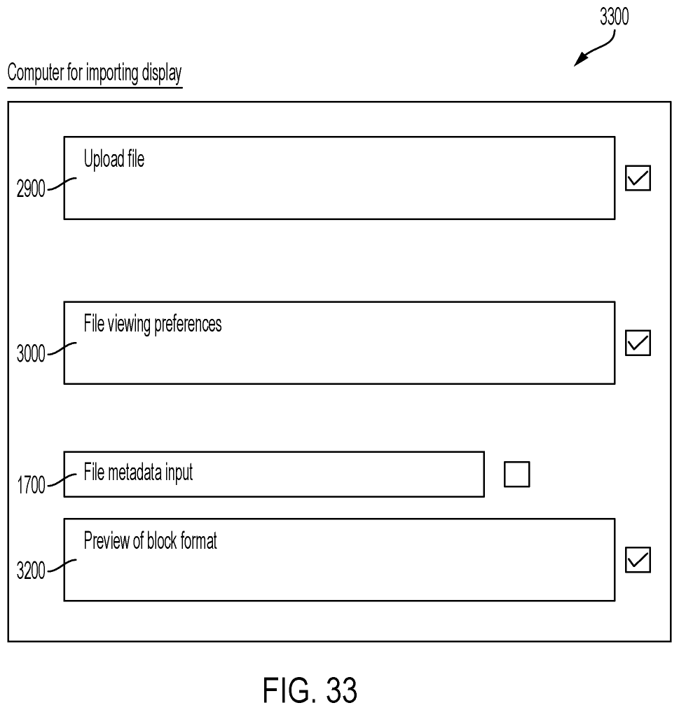

In an example workflow for uploading to the server, a graphical user interface is first displayed on a computer. An example of the graphical user interface is depicted in FIG. 33.

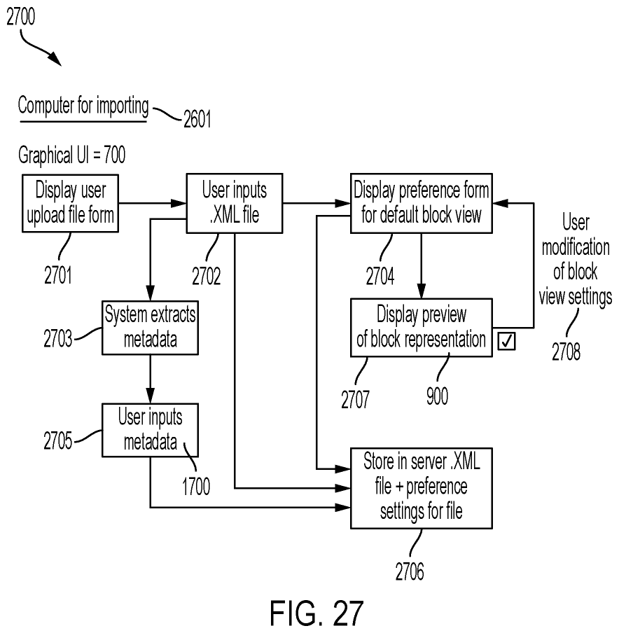

FIG. 27 depicts an example workflow for how files are managed to move the .XML files or any other required files for the system to the server. First, the user selects the .XML file from the computer's storage system (FIG. 27, Item 2702). The system then extracts available metadata from the .XML file and displays it in the metadata display area (FIG. 27, Item 2703). This metadata is displayed in a graphical user interface on the computer (4300). The extracted metadata from the .XML file populates the metadata fields if the data is present in the .XML file. The user may modify the text displayed in the metadata fields. Then the metadata is saved to the server and is linked to the .XML file that is also uploaded to the server (FIG. 27, Item 2706). Concurrently, the system displays the preference form for the viewing of the block representation (FIG. 27, Item 2704) which is then used to display a preview of the block representation (FIG. 27, Item 2707). A preference may be modified by the user (FIG. 27, Item 2708), which then enables the preview to be updated according to the user change. The .XML file along with the metadata and the viewing preference information is stored in the server (FIG. 27, Item 2706).

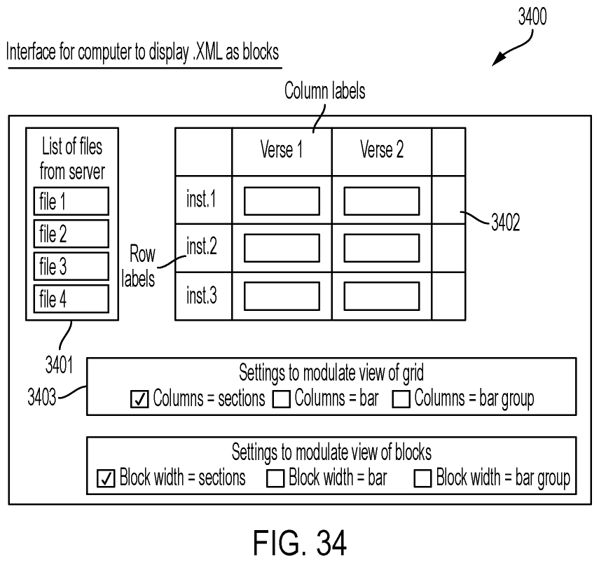

It is possible for any of the devices in this system to retrieve a list of all files that exist in a given users account or storage device, and view information regarding the Linked Elements. Turning to FIG. 34, an example graphical user interface is depicted showing how individual files Block Representation may be viewed, then modulated through a series of checkboxes to change the user preferences of the Block Representation formation.

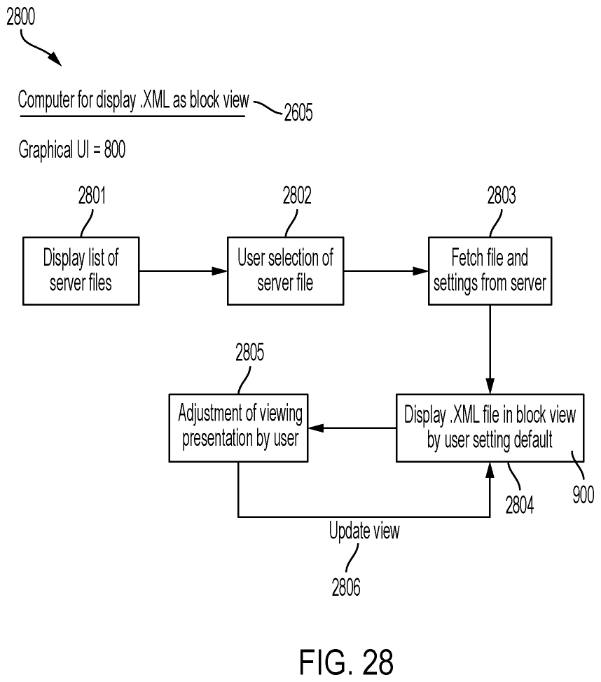

FIG. 28 illustrates a detailed example workflow demonstrating how Linked Element files can be recalled and viewed by a device. First, the system retrieves a list of the .XML files from the server (FIG. 28, Item 2801). A user can select a given file from the list of available files on the server (FIG. 28, Item 2802). The system then retrieves the .XML file and the associated metadata and viewing preference information from the server (FIG. 28, Item 2803). The .XML file is then displayed in a block format for viewing (2804). The viewing parameters for the block representation may be modified (FIG. 28, Item 2805) and the display is then updated to reflect the changes (FIG. 28, Item 2806).

The systems and methods described herein allow a given file in the server to be selected through a graphical user interface and then subsequently transformed into a visual display of a grid with associated blocks.

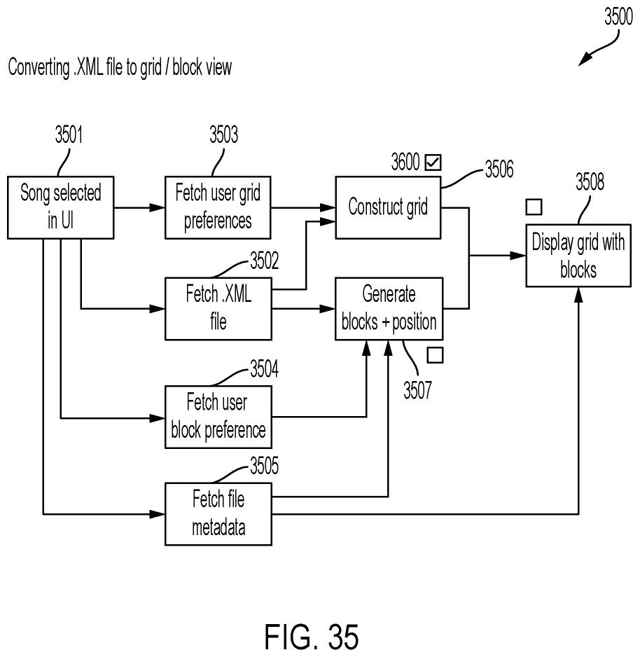

FIG. 35 illustrates how a Linked Element is displayed as a grid of blocks. First, a Linked Element (i.e. a song title) is selected in the graphical user interface (FIG. 35, Item 3501). Then, the system fetches from the server a .XML file (FIG. 35, Item 3502), associated user viewing preferences for a grid (FIG. 35, Item 3503), associated user viewing preferences for individual block formations (FIG. 35, Item 3504) and associated file metadata (FIG. 35, Item 3505). The user preferences that are defined per song along with the .XML file itself are used to generate a visual display of a grid consisting of columns and rows (3506). The user preferences for block formation along with the .XML file itself and associated metadata are used to then display a series of blocks within the grid of columns and rows (FIG. 35, Item 3507). Both the grid and the series of blocks can then be visually displayed in tandem to allow a user to visualize the block representation of the .XML file (FIG. 35, Item 3508).

One element required to display a block representation of a .XML file is a grid in which blocks can eventually be graphically overlayed on top of the grid so as to convey to a user that a given block exists within a specific row and column of the grid. The grid is generated through a series of calculations performed by the system that are dependent upon the user-defined grid preferences and the .XML file itself. The system uses these inputs to calculate a series of variables that are then used to display a grid of rows and columns. The calculations that the system performs ultimately results in variables which are used in the displaying of the grid. These variables include the total number of rows in the grid, the total number of columns in the grid, the calculated width per column of the grid, the calculated label per column, and the calculated label per row. These are then used to create a visual display of the grid. Then, the system parses the Digital Element file such as digital sheet music and if there is data contained within a given music measure, then a block is displayed within that grid location. While this system describes how a grid can be generated with a series of blocks within the grid to correspond to digital sheet music, this is just one example of how digital sheet music may be represented through a latent space whereby each individual shape or graphical display corresponds to a functional unit of digital sheet music data which can then be further manipulated.

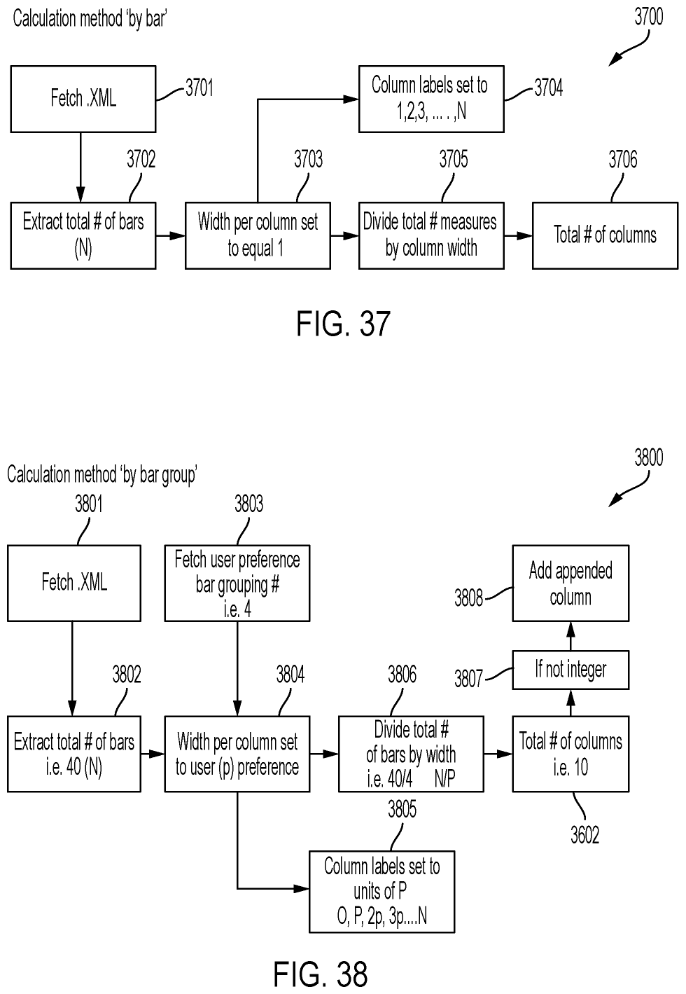

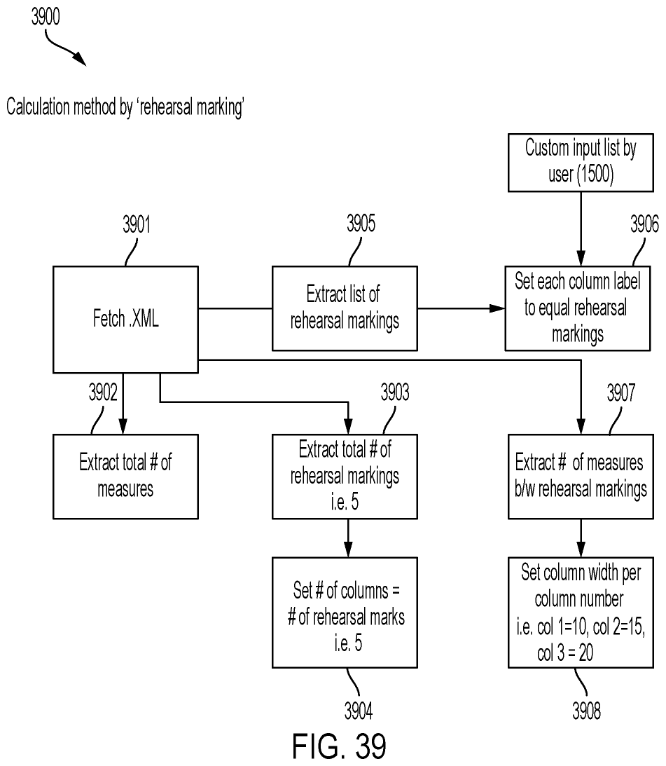

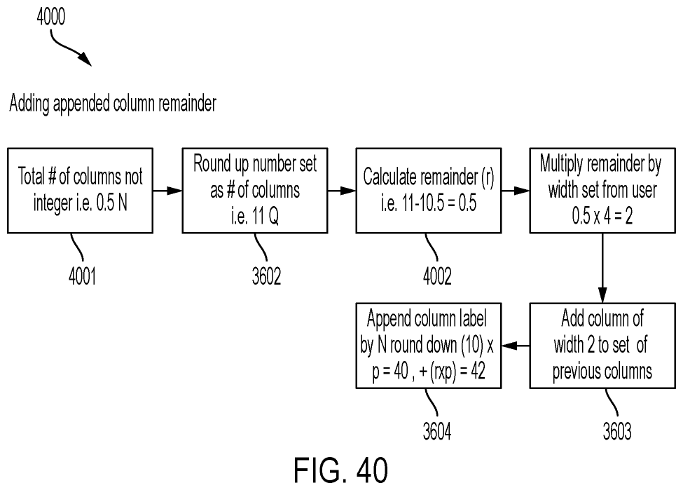

There are various methods whereby the variables necessary for grid display may be calculated. The calculation method is dependent upon the method that is specified by the user then associated and stored in the server. Ultimately, the user specifies per file the viewing parameters of the grid, then depending on these specified viewing parameters, the system calculates the variables necessary for viewing the grid in different methods. The methods can be grouped into methods for generating columns of the grid and methods for generating rows of the grid. The methods for generating columns of the grid include calculating/displaying ‘by bar’ (FIG. 37), ‘by bar group’ (FIG. 38), and ‘by rehearsal marking’ (FIG. 39). When a grid is required to be generated and displayed, the .XML file is first fetched from the server, and the user grid preferences are fetched based on that file selection, which then informs which method is utilized to calculate the necessary variables for the grid display.

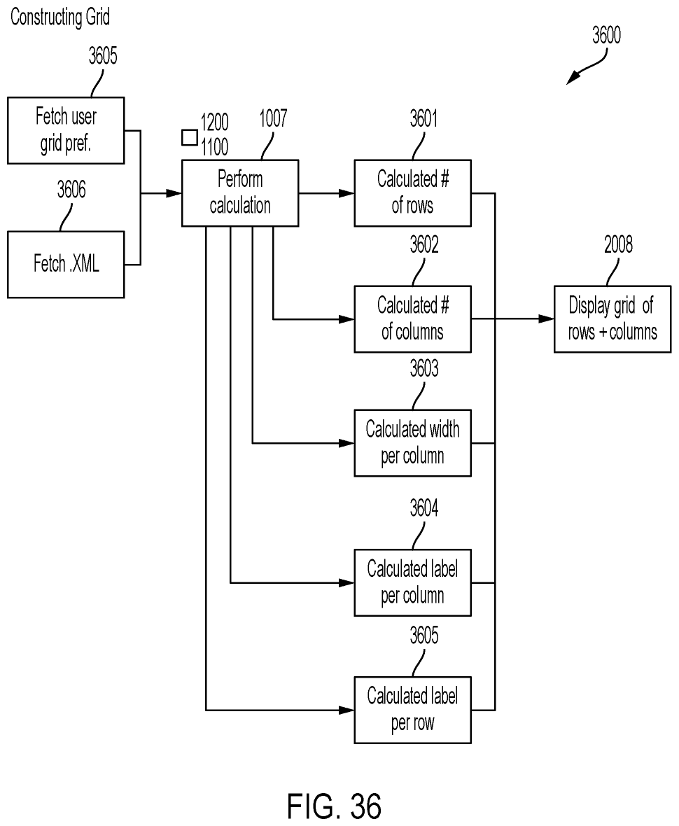

FIG. 36 illustrates a workflow depicting the variables and calculation process necessary in order to generate a grid from a Digital Element, in this case a digital sheet music file such as a .XML file. The variables necessary for generating columns within a grid are the total number of columns (FIG. 36, Item 3602), the width per column (FIG. 36, Item 3603) and a set of column labels for each column that is generated (FIG. 36, Item 3604). When these variables are calculated within each method described here, they are saved in the server and attached to the .XML file so each that the .XML file is retrieved, the set of variables that have been calculated are accessible for the system to then display the grid and blocks.

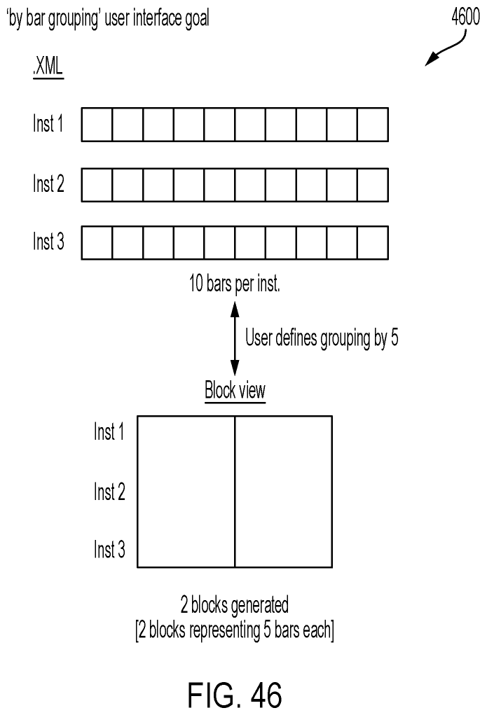

Turning to FIG. 45, one way a user may wish to display a digital sheet music file or any other Digital Element is through a latent block representation in which each block corresponds to a single music measure within a digital sheet music file. The user may utilize this method when they wish to view the .XML file in a graphical representation whereby every measure of sheet music corresponds to one column on a grid. This method ultimately aims to set one column equivalent to one bar in the .XML file.

FIG. 37 illustrates how the values necessary to create a grid are calculated when the method for displaying a grid ‘by bar’ is selected. When a .XML file is fetched for viewing of block representation and the user defined method as recorded in the server is ‘by bar’, the calculation method of ‘by bar’ is utilized. First, the .XML file is fetched (FIG. 37, Item 3701) and the total number of bars [individual measures in the .XML file] is calculated (FIG. 37, Item 3702). For this method, the width per column variable is set equal to 1 (FIG. 37, Item 3703). The extracted total number of bars is then divided by the column width (FIG. 37, Item 3705) to arrive at a value that is then set as the total number of columns (FIG. 37, Item 3706). The series of labels is then calculated based on the column width, which in this method is 1. The series of labels in this method is generated by creating a list of numbers ranging from 1 to the total number of columns/bars (FIG. 37, Item 3704). In this setting, all columns are set equal to the same calculated column width.

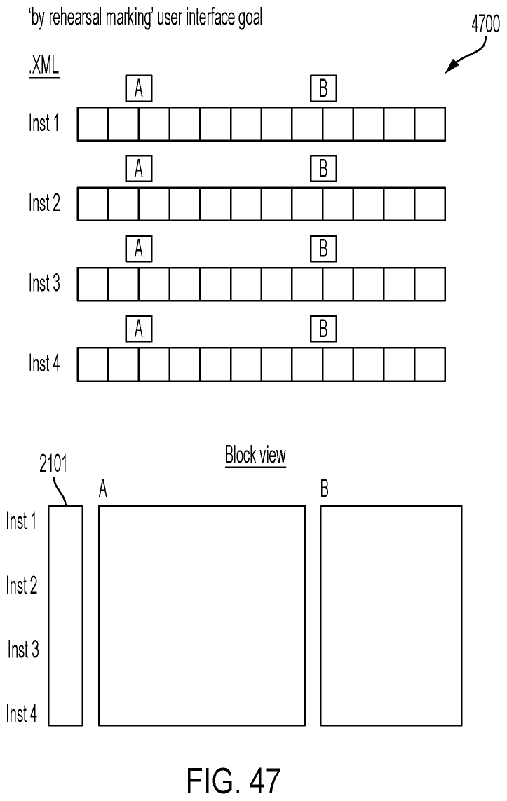

Turning to FIG. 46, one way a user may wish to display a digital sheet music file or any other Digital Element is through a latent block representation in which each block within the block representation may represent greater than one individual measure of the digital sheet music. The user may utilize this method when a user wishes to view individual measures of a .XML file as a group. This allows for the user to look past the details of individual measures, and focus on larger scale modifications and sections. In this setting the user defines a number at which each column should represent a specific number of bars and display it as such.

Turning to FIG. 37, an example workflow is described how the values necessary to create a grid are calculated when the method for displaying a grid ‘by bar grouping’ is selected. When a .XML file is fetched for viewing of block representation and the user defined method as recorded in the server is ‘by bar group’, the calculation method of ‘by bar group’ is utilized (FIG. 38, Item 3800). This is accomplished by first fetching the .XML file from the server (FIG. 38, Item 3801). The total number of bars in the .XML file is then calculated (N) (FIG. 38, Item 3802). The user preference for the column grouping is then fetched (FIG. 38, Item 3803). This value is then set as the column width amount (p) (FIG. 38, Item 3804). In this setting, all columns are set equal to the same calculated column width. The column labels are generated from this as defined by generating a list of values ranging in multiples of p from p to N (FIG. 38, Item 3805). To calculate the total number of columns necessary, the total number of bars (N) is divided by the bar width (p) (FIG. 38, Item 3806). If the total number of columns calculated is not an integer (FIG. 38, Item 3807), a further method must be deployed to calculate how to handle the remainder block formed (FIG. 38, Item 3808).

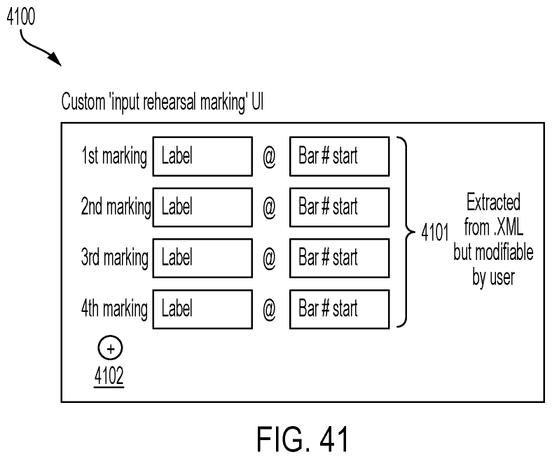

Turning to FIG. 40, an example method is included to describe how the bar groupings are created if there is a beginning series of Digital Element files in which there are an excess or lack of measures that renders the bar grouping value indivisible by the total number of bars. First, the total number of columns (N) is rounded up and this is the value that is set as the number of columns (Q). A remainder is then calculated by subtracting N and Q (N−Q=remainder [r]) (FIG. 40, Item 4002). To calculate the column width for this remainder block, the remainder (r), is multiplied by the user defined bar width (p). This remainder column width is then set as the column width for the final column. The list of column labels is then appended with an additional column label to account for the remainder by setting the remainder column label to be (Q−1)+(r×p).

Turning to FIG. 46, one way a user may wish to display a digital sheet music file or any other Digital Element is through a latent block representation wherein each block of the block representation corresponds to a specific region within the digital sheet music file that is defined by rehearsal markings or custom markings within the sheet music. Within a .XML file there sometimes exists rehearsal markings in the digital sheet music which are used to signify a label for a specific measure that generally represents a section or marking that can be referred to in a performance or rehearsal setting to signify a section of music. When the user of this invention selects this method, the grid that is ultimately formed has columns that are represented in width by the rehearsal markings and the number of measures each of the rehearsal markings delineate.

Turning to FIG. 39, an example method is described to allow for the variables necessary to be calculated for a grid display to be executed when a user desires to display the grid ‘by rehearsal marking’. When a .XML file is fetched for viewing of block representation and the user defined method as recorded in the server is ‘by rehearsal marking’, the calculation method of ‘by rehearsal marking’ is utilized. First the .XML file is fetched from the server (FIG. 39, Item 3901). The total number of measures is then extracted from the file (FIG. 39, Item 3902). Then, the total number of rehearsal markings is extracted from the .XML file (FIG. 39, Item 3903). This number is then set as the number of columns to be used in the grid formation. Next, the system calculates how many measures exist between each rehearsal marking, per rehearsal marking. Per rehearsal marking, and associated column defined in (FIG. 39, Item 3904), the number of measures between each rehearsal marking is set as the column width per column. Next, the list of rehearsal markings is extracted (FIG. 39, Item 3905) and recorded as a list of texts whereby each column label is then set as equal to the rehearsal marking (FIG. 39, Item 3906).

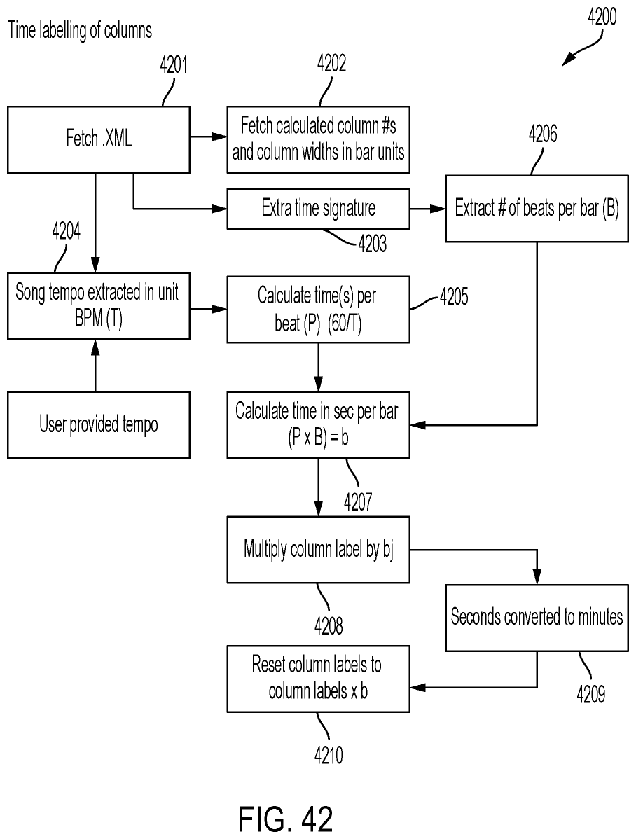

Turning to FIG. 41, an example user interface is depicted for modifying rehearsal markings that are extracted immediately from a Digital Element and then able to be modified on a user preference panel to then be used in calculating variables necessary for a grid. When the list of rehearsal markings is extracted, it is graphically displayed on the computer's user interface. Here, the user may modify the labels that are associated with each rehearsal marking and the positioning (FIG. 41, Item 4101). Additional rehearsal markings may be added to the .XML file through this graphical user interface (FIG. 41, Item 4102), whereby the method for ‘by rehearsal marking’ is repeated to allow for the newly appended rehearsal marking to be included in the column generation method.

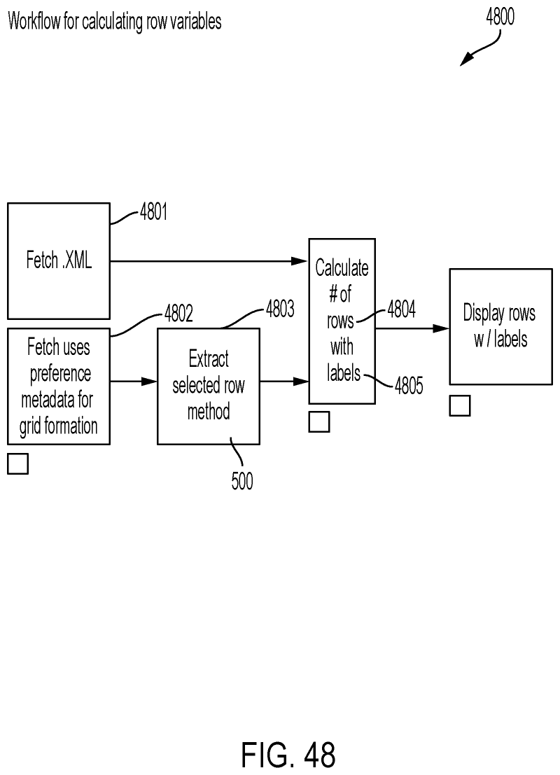

FIG. 47 illustrates an example user interface display on the Primary Device which demonstrates how in one example of a Digital Element such as a .XML file, when parsed by rehearsal markings is then displayed in block representation on the Primary Device.

Through each previously described method, there exists a set of column labels that are generated that are specific to each column. Ultimately, these labels are ascribed to individual columns. These individual columns represent segments of measures within the .XML file and thereby, represent sections of time since each measure represents a set of musical notation to be performed over time. Therefore, a user may implement a method to convert the labels of columns to timestamps where a time is placed as a label for each column representing the time at which a given column begins.

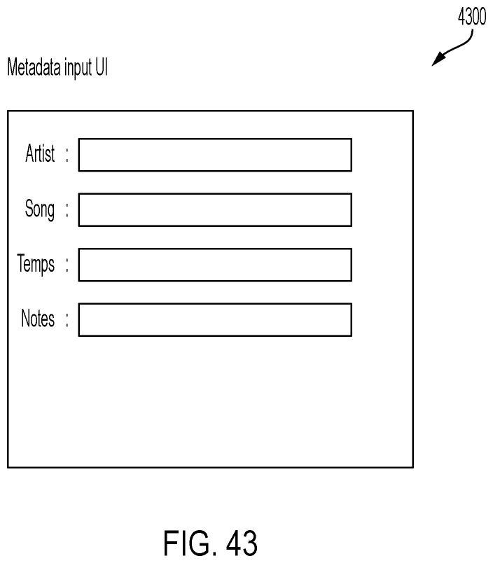

Turning to FIG. 42, an example method for labelling gridded columns with time labels is depicted. This method is executed when, through a graphical user interface, the user selects the option to view labels ‘as time’. This user input may be defined when the file is imported to the server and thereby saved as a metadata field, or the user may define this when viewing a block representation. First, the .XML file is fetched (FIG. 42, Item 4201). From the .XML file, the number of calculated columns and the column widths for each column are retrieved (FIG. 42, Item 4202). From the .XML file, the song tempo is extracted in units of BPM (T) (FIG. 42, Item 4204) and the time signature of the song is extracted (FIG. 42, Item 4203). From the extracted song tempo (T), the system calculates the time in seconds for each beat of the file (P), calculated as 60/T (FIG. 42, Item 4205). From the extracted time signature, the system calculates the number of beats per bar (B) (FIG. 42, Item 4206). Values P and B are then multiplied to calculate the time in seconds for each measure in the .XML file (b) (FIG. 42, Item 4207). Each column label is then multiplied by b (FIG. 42, Item 4208), thereby representing every column as a starting position of time in units of seconds. This value is then converted into minutes (FIG. 42, Item 4209). The column labels are then set to be this newly defined set of column labels (FIG. 42, Item 4210).

In this method, if there exists a series of measures that are at the start of the .XML file that contain no rehearsal marking, then the first column that is defined in the series of columns for the grid will contain no label (2101).

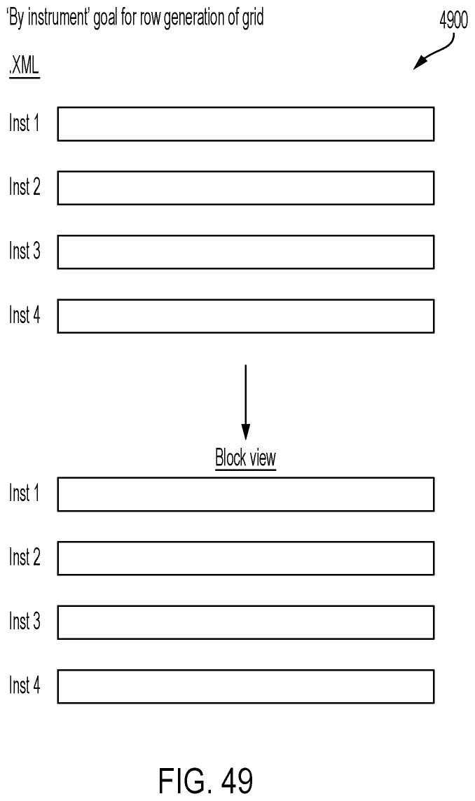

Turning to FIG. 48, an example workflow is depicted for generating the necessary row variables in order to label rows of a block representation grid of a digital sheet music file or other Digital Element. In order to generate and display rows for a grid, there are two variables that are necessary to be calculated in this system—the total number of rows (FIG. 48, Item 4804) and an associated label per row (FIG. 48, Item 4805). This system calculates these total number of rows and associated labels per row differently depending on the method selected by the user. There are two methods whereby rows can be generated and thereby the necessary variables calculated—‘by instrument’ and ‘by instrument grouping’.

When the system is called to display a grid, first the .XML file is fetched (FIG. 48, Item 4801). Next, the user preference metadata for grid formation is fetched (FIG. 48, Item 4802). From the user preference metadata, the row method selected by the user is extracted (FIG. 48, Item 4803). Depending on the calculation method, the total number of rows and associated row labels are then calculated (FIG. 48, Item 4804/4805). These values are then utilized to be displayed on the grid.

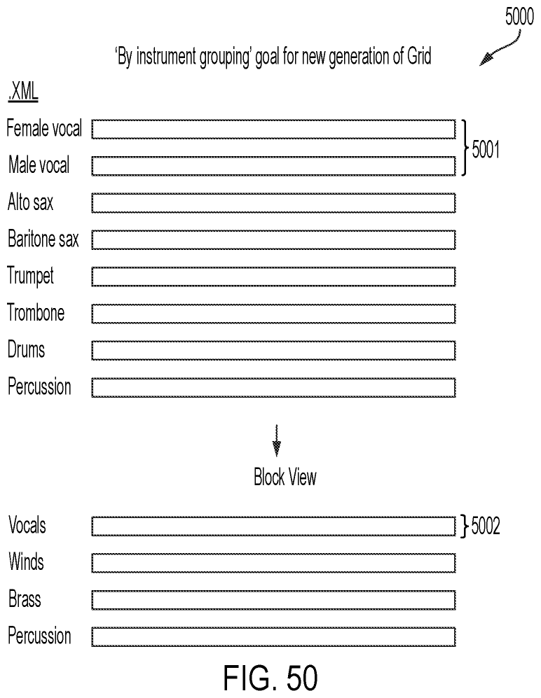

FIG. 49 illustrates an example of converting Digital Element rows, in this case instrumentalist names of a .XML digital sheet music file, to a block representation grid, whereby each row of the block representation corresponds to one instrumentalist of the .XML file. Within a .XML file, there exists multiple rows/instrumentalist parts. In many settings, a user may wish to display a grid formation whereby every instrumentalist part is viewable as a corresponding row within the grid.

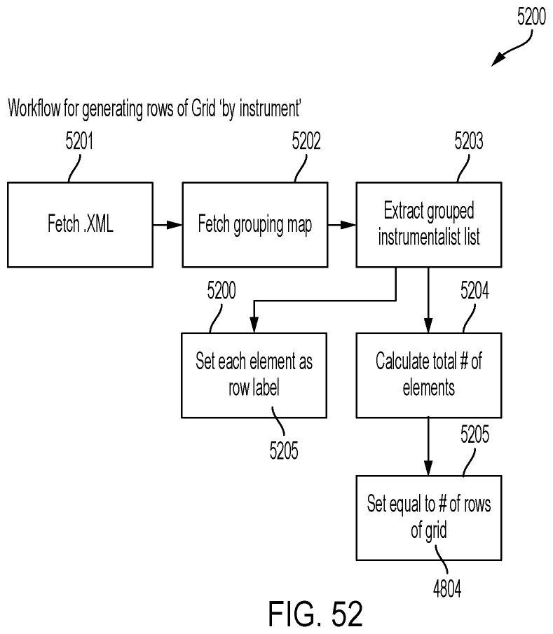

Turning to FIG. 51, an example of a calculation method for assigning rows of block representation to rows of a Digital Element, in this case digital sheet music .XML files is depicted. If this is the calculation method that is executed, defined by the user preference metadata, first the .XML file is fetched (FIG. 51, Item 5101). Next, from the .XML file, the system extracts a list of the labels for instrumentalist parts (FIG. 51, Item 5102). The system then calculates the total number of elements within this list (FIG. 51, Item 5103) and sets this value as equal to the total number of rows to be displayed in the grid (FIG. 51, Item 5104). Next, each row of the grid formation is assigned a label (FIG. 51, Item 5106) as per the individual instrumentalist labels extracted from the .XML file (FIG. 51, Item 5102).

In many settings, a .XML file may contain a large number of instrumentalist parts. In this setting, it is quite cumbersome to view a grid whereby every row is an individual instrumentalist part, since there are a large number of individual instrumentalists. For this reason, the system allows a user to view a grid whereby each row of the grid represents a group of individual instrumentalist parts.

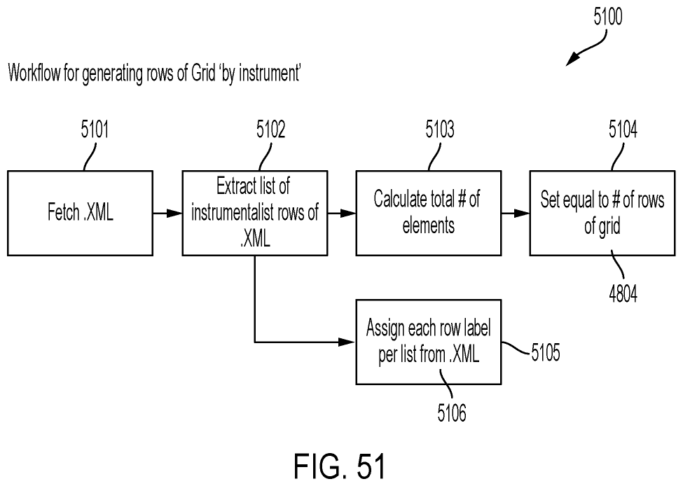

Turning to FIG. 50, an example is provided whereby a Digital Element, in this case a digital sheet music file in the format of a .XML file, where every row is an individual instrumentalist, is converted through this system and through a user defined preference to a grouped setting of rows where the individual rows of the block representation represent groups of rows in the .XML file. For example, whereby in the ‘by instrument’ method, all instrumentalist parts within a .XML file are viewed as individual rows, in the ‘by instrument grouping’ method (FIG. 50, Item 5000), the instrumentalist parts of female vocal and male vocal (FIG. 50, Item 5001) are both represented by a single row in the grid view as ‘vocals’ (FIG. 50, Item 5002). This method, as the ‘by instrument’ method, will also result with an output of the total number of rows and the assigned row label per row—in order to be utilized in the display of a grid.

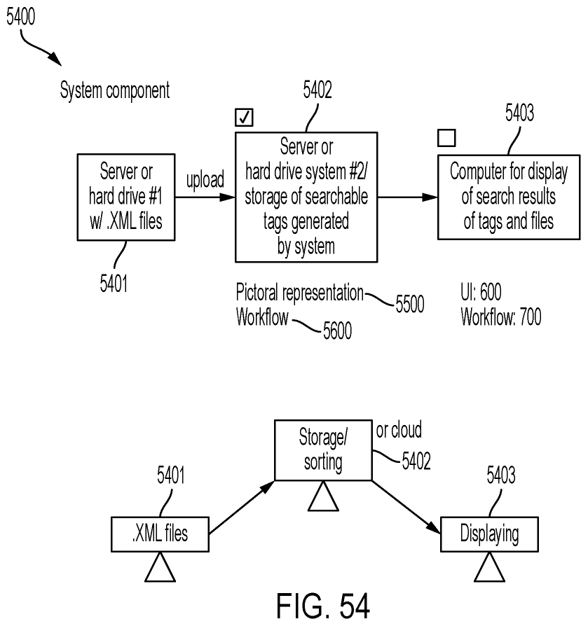

Turning to FIG. 53, an example is provided of a ‘grouping map’ whereby there is a corresponding key of individual Digital Element rows that get assigned to groups to inform the row assignments in the block representation. The grouping map contains two lists—the ‘grouped instrument list’ (FIG. 53, Item 5301) and the ‘individual components’ (FIG. 53, Item 5302). Both of these lists through a series of graphical user interfaces can be edited to reflect the preferences of the user. This ‘grouping map’ will ultimately be used in the ‘by instrument grouping’ calculation method for displaying rows in a grid. A ‘default setting’ can be defined by the user whereby if the ‘by instrument grouping’ method is selected, the .XML file will always use the same ‘grouping map’. Alternatively, per .XML file as imported, can be defined with its own ‘grouping map’ so that each individual .XML file when a grid view is generated, contains a different row grouping. In this way, the ‘grouping map’ is stored and associated with each individual .XML file.

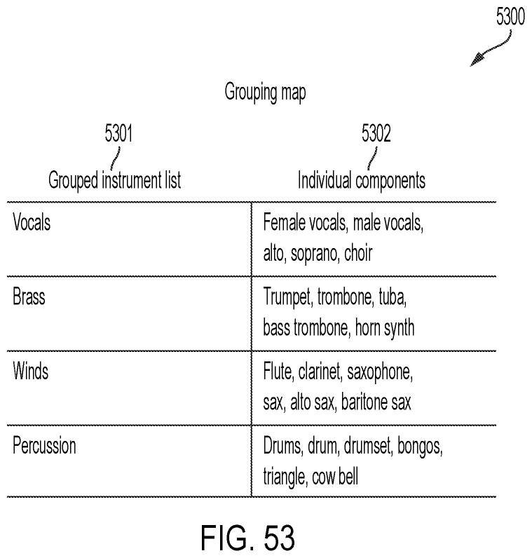

Turning to FIG. 52, an example method is depicted on how the system assigns row variables when the ‘by instrument grouping’ of FIG. 50 is executed. This method starts by fetching the .XML file (FIG. 52, Item 5201). The ‘grouping map’ for the .XML file is then fetched (FIG. 52, Item 5202). From the ‘grouping map’, the ‘grouped instrumentalist list’ is extracted (FIG. 52, Item 5203). The total number of elements in this list is calculated (FIG. 52, Item 5204) and set as equal to the total number of rows in the grid (5205). Next, each row of the grid formation is assigned a label as per the list of instrumentalist labels in the ‘grouped instrumentalist list’.

There do exists other alternative methods for grouping instrumentalist rows. One such method would be a method whereby the system takes as input each of the individual rows of the digital sheet music file and groups them into one row in the block representation format based on similarity of the contents of the rows of the digital sheet music file. For example, if in the Digital Element, digital sheet music file, there are multiple saxophone parts (alto, tenor, baritone saxophone), that each contain the same rhythmic notation, but simply have different musical note values, they can be considered rhythmically part of the same group and therefore when the block representation is created, there is one row in the block representation titled ‘saxophones’ or ‘group 1’ which correspond to all the parts that contain that same rhythmic notation. In this method it is possible to vary the level of granularity at which these groupings are made. For example, if there are two saxophone parts that are similar rhythmically, and over the course of the entire piece vary by a certain percentage, a threshold can be set within the systems interface to allow for those instruments to still be considered within the same grouping.

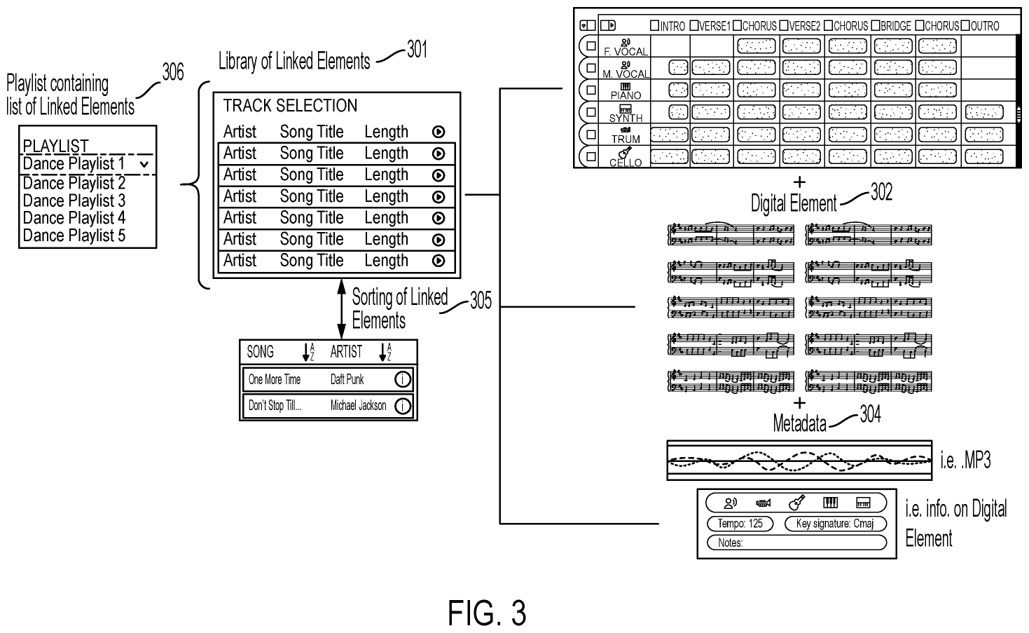

Turning to FIG. 3, an example graphical user interface with the associated linked elements is depicted. The Primary Device relies on a Library for viewing Linked Elements (FIG. 3, Item 301). These individual Linked Elements contain multiple data types. Linked Elements represent the summative file of: Digital Elements in whatever file format they may exist in (FIG. 3, Item 303), representative Block formats of the Digital Elements in whatever file format they may exist in (FIG. 3, Item 302), and Metadata (FIG. 3, Item 304) surrounding the Linked Element itself or any individual element of the Linked Element. Linked Elements can be expanded to view any element in which it contains. Linked Elements can be sorted within the Library of Linked Elements through Metadata fields or any custom set filtering system (FIG. 3, Item 305). Linked Elements may be grouped into overarching playlists, which are custom lists of specified Linked Elements (FIG. 3, Item 306). This Library of Linked Elements may be stored, and self-contained within the confines of the Primary Device, or the Library may draw from a server or cloud or any other method for storing files that other Primary Devices may also have access to. Linked Elements also may exist as unique file formats to the industry in which modifications to these Linked Elements can easily be made.

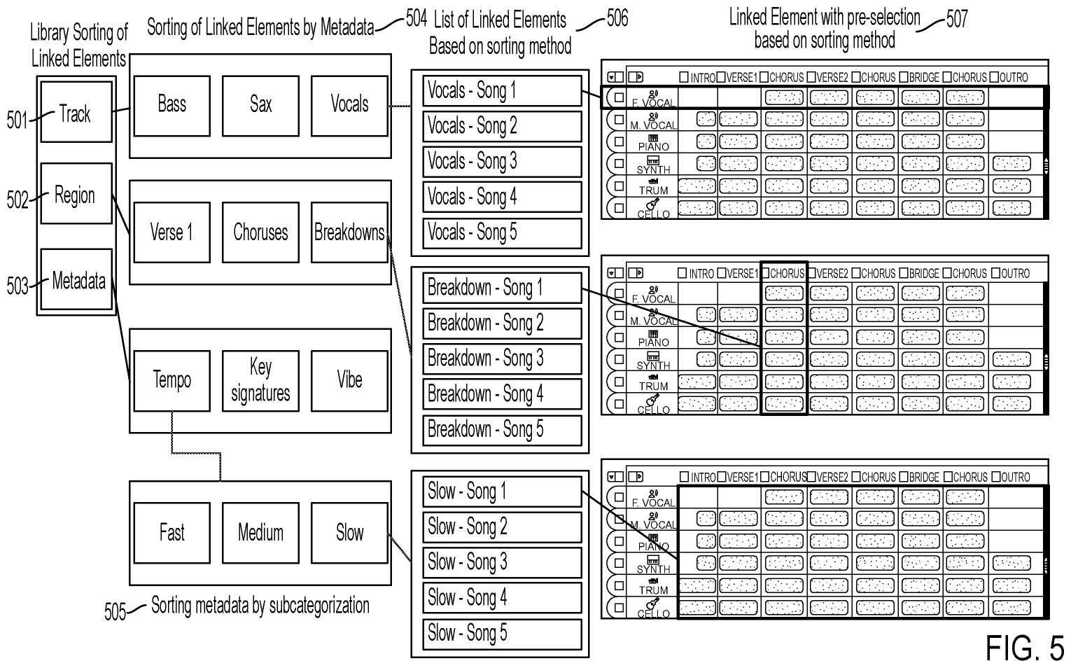

Turning to FIG. 5, an example of the filtering system that is possible through the sorting of Linked Elements is depicted. The Library may be organized by Track (FIG. 5, Item 501), Region (FIG. 5, Item 502), or any other searchable element of Metadata (FIG. 5, Item 503). When sorting Linked Elements by any of these methods, it is possible to view Linked Elements by any metadata linked to these elements (FIG. 5, Item 504). This can exist in an iterative fashion to sort within subcategories of metadata (FIG. 5, Item 505). This presentation includes a list of Linked Elements, sorted by a given Track/Region/Metadata selected (FIG. 5, Item 506). This list of Linked Elements ultimately contains a pre-selection based on the mechanism of sorting (FIG. 5, Item 507).

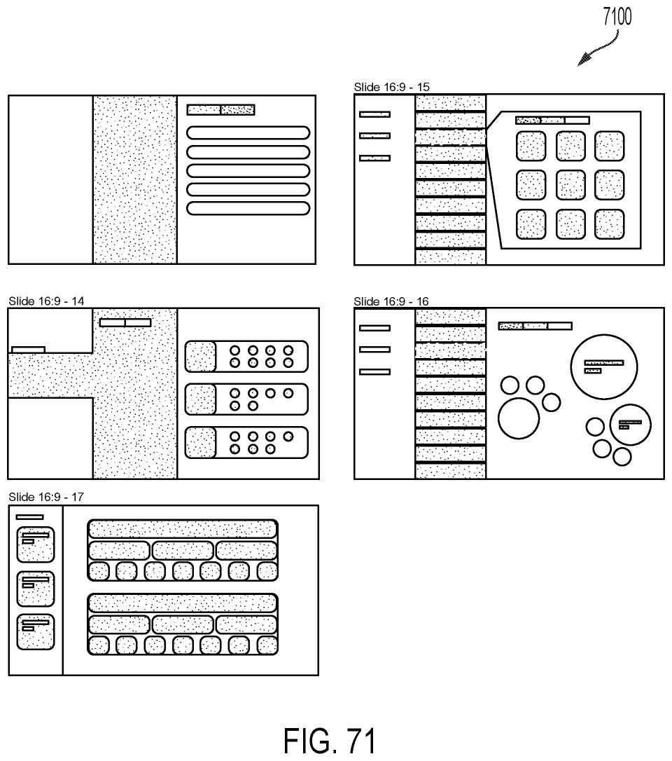

Turning to FIG. 71, various examples of graphical user interfaces for the displaying of Linked Elements are depicted. As depicted, linked elements can be simply listed in individual rows, can be expanded to show the details of the block representations, or be structured as other shapes to expand and show and hide other information related to each Linked Element.

Blocks, Tracks and Regions, as previously defined, can represent different functional units within the scope of the Digital Element. For example, in a musical score, a Block may represent one measure, or a group of measures. Similarly, in a musical score, a Track may represent one instrumentalist part or a group of instrumentalists. This can be defined on a user-by-user basis when Linked Elements are first generated within the database. This viewing preference then allows for the Block Representation of the Digital Element, the Prep Area, Mid-Prep Area and the Live Area to contain the units of measure predefined by the Primary User.

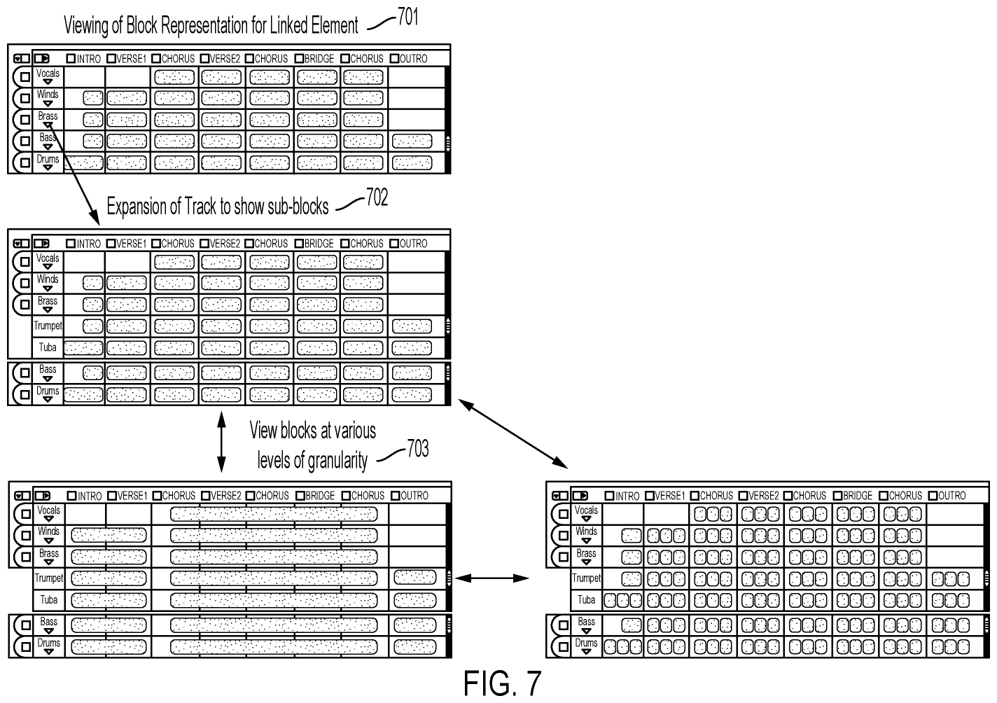

Turning to FIG. 7, an example graphical user interface depicting a block representation of digital sheet music is depicted. When a Linked Element has been selected in the Library, the Block Representation of the Linked Element can be viewed (FIG. 7, Item 701). The Tracks, Regions and Blocks may be expanded in Block Representation to view sub-tracks, sub-regions and sub blocks (FIG. 7, Item 702). Through any other commonly used methods, there may be control over viewing the granularity of Blocks. Blocks can be viewed as individual blocks, or as groups of Blocks (FIG. 7, Item 703). This same adjustment to scale the viewing of Blocks can also be applied to the viewing of Blocks or Series of Blocks in the Prep Region, Mid-Live Region or Live Region. Where no Blocks exist within the Block Representation view indicates that within the Digital Element, there is no content in that area. In music notation, this would be synonymous with measures of rest.

The following describes systems and methods that allows a user to store Digital Elements, in this case, .XML files, with parsable, searchable tags, so as to allow for an easy searching of a big library of .XML files by specific key words or key functionalities.

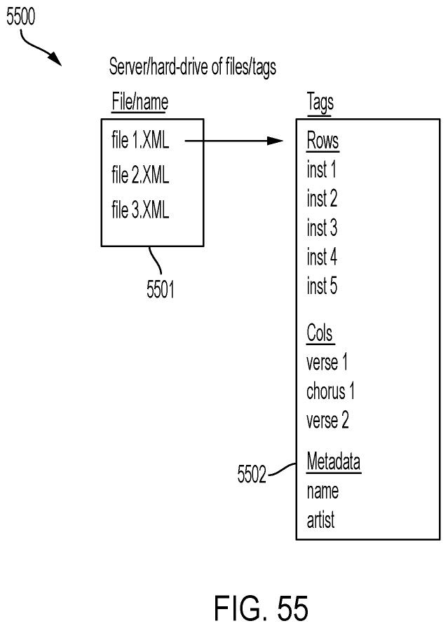

Turning to FIG. 54, an example workflow is described showing how multiple servers and computers work in tandem to enable a library of .XML files or any other digital sheet music files or Digital Elements can be searched by their individual rows and columns. The overall system described in this application, describes a system of three computers or servers. It is possible for one server or computer to accomplish all of the steps in the overall described workflow, however in this case example, there are three functional computers/servers. The first computer (FIG. 54, Item 5401) stores either on a server or a hard drive a series of .XML files. The graphical user interface of the first computer contains a method whereby a user can prescribe tags associated with each individual .XML file. It is additionally possible through the method described in this application for the system to provide metadata associated with each .XML file which then can be modified by the user further before being passed to storage. Through methods described in this application, the .XML files are then uploaded to a server, other hard drive or cloud based storage system whereby the .XML file along with key metadata including tags are stored (FIG. 54, Item 5402). Finally, there is a third computer which fetches and accesses the .XML files along with the associated metadata/tags for each .XML file. This computer then can use the .XML files to display the .XML file and interact with the searching system of all the .XML files contained in the second computer (FIG. 54, Item 5403).

The summarized steps of the workflow can be summated as: uploading the .XML file from a computer to a server; the server computing tags and metadata to be associated with each .XML file; a user modifying these tags and metadata; the .XML files with their associated metadata and tags being stored in a server/hard drive/cloud based system; the full library of .XML files being searched through another computer; the full library of .XML files being searched through a means of using the tags or associated metadata.

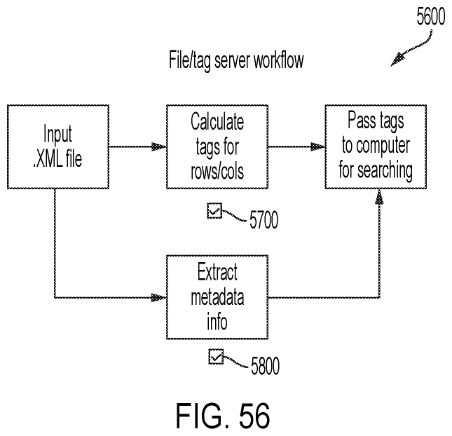

FIG. 55 illustrates an example storage system whereby digital sheet music files are parsed by row and column tags along with metadata to allow for digital sheet music files to be recalled as a full entity or individual elements of rows, columns, measure units or specific blocks. The second computer/server/hard drive which houses the .XML files along with associated metadata/tags can be thought of as a .XML file that is linked with information defined by the user within the first computer. This second computer stores these files by keeping a list of .XML files (FIG. 55, Item 5501), that then each contain further information, including, but not limited to tags. These tags can include information such as row names, column names or metadata (FIG. 55, Item 5502). These tags are generated and computed through a series of methods as described in this application.

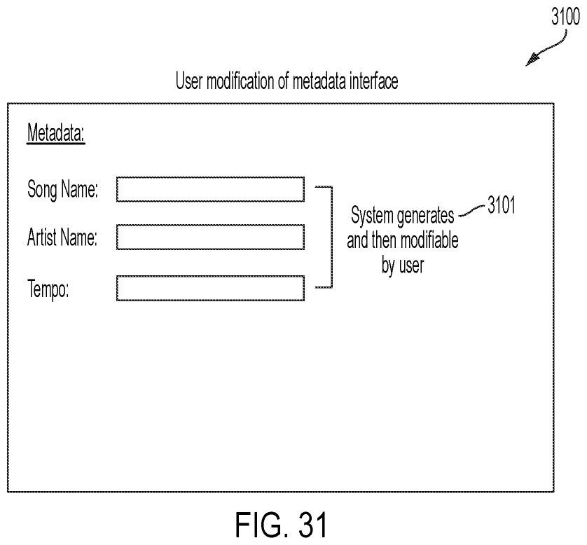

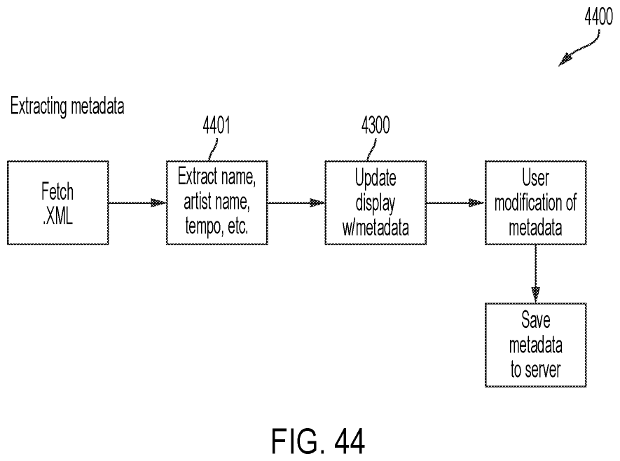

The system relies on a server/hard drive which contains the library of .XML files (FIG. 55, Item 5501) that are linked to specific metadata (FIG. 55, Item 5502). There are three critical datatypes that can be linked to each .XML file—‘row names’, ‘column names’ and ‘metadata’. The row names and column names will be used when a visual reconstruction of the .XML file is generated and thus relies on a labelling system of rows and columns. Turning to FIG. 44, an example workflow is provided whereby a Digital Element, in example, a .XML file is fetched from a server, then the file metadata is extracted such as artist name, tempo, etc. (FIG. 44, Item 4401), the information is then displayed on the graphical user interface of the Primary Device (FIG. 43), the user may modify this data, then the data may be resaved into the native server. The ‘metadata’ that is extracted, is information relevant and contained within the .XML file that includes but is not limited to information such as filename, tempo of song, artist of song, transcriber etc. All of these datafields (FIG. 55, Item 5502) are searchable by the system. This information that is extracted from the .XML file or other Digital Element may be further revised or edited using the graphical user interface on the Primary Device. An example of this interface is displayed in FIG. 31. Here, is shown an example of information that was extracted from an example Digital Element such as a .XML file and then is displayed through a graphical user interface for a user to modify then be restored as revised metadata in the database of Linked Elements.

The system takes as input a .XML file, then calculates through the method described here the row and column names; along with extracting the metadata; then, passes these datatypes to the server to store as linked to the .XML file.

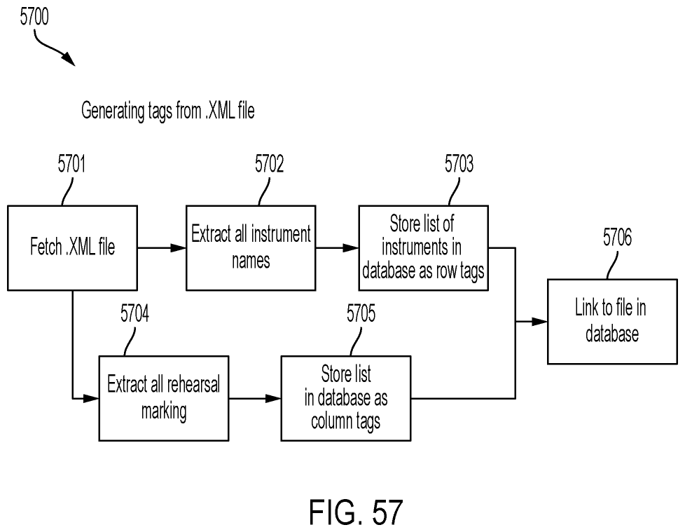

This system aims to generate a list of row names and column names that will be included within the ‘row’ and ‘column’ metadata linked to each .XML file. One example workflow is illustrated in FIG. 56. An input Digital Element such as a .XML file is input to the system, metadata is extracted from the .XML file, tags are calculated based on file properties such as the rows/columns of the .XML file, then tags are generated and passed to the Primary Device for searching and filtering. These names searchable tags are calculated by the system in the following way.

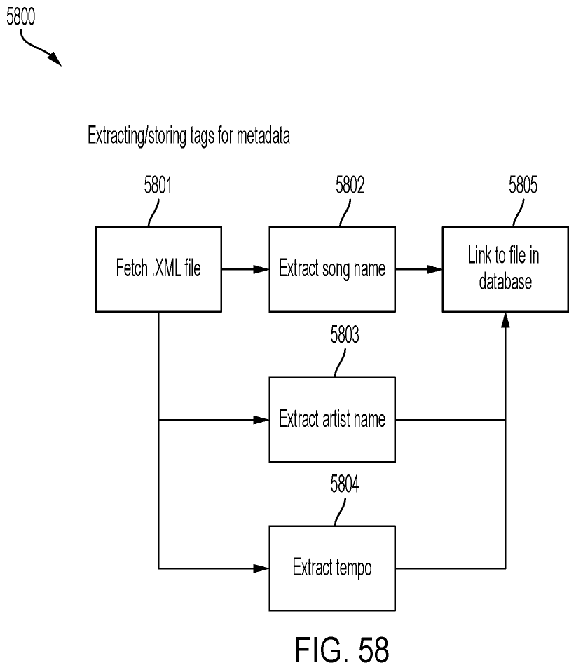

Turning to FIG. 57, an example workflow is depicted for how searchable tags can be generated from digital sheet music files. The system first fetches the .XML file (FIG. 57, Item 5701). The system then extracts all the instrument names within the .XML file (FIG. 57, Item 5702), and a list of all the rehearsal markings (FIG. 57, Item 5702/5704). All of the instrument names are then assigned to the row names and all of the rehearsal markings within the .XML file are assigned as the column names (FIG. 57, Item 5703/5705). The row names and the column names are then linked to the .XML file and stored in the database/server to be accessed and searched through (FIG. 57, Item 5706).

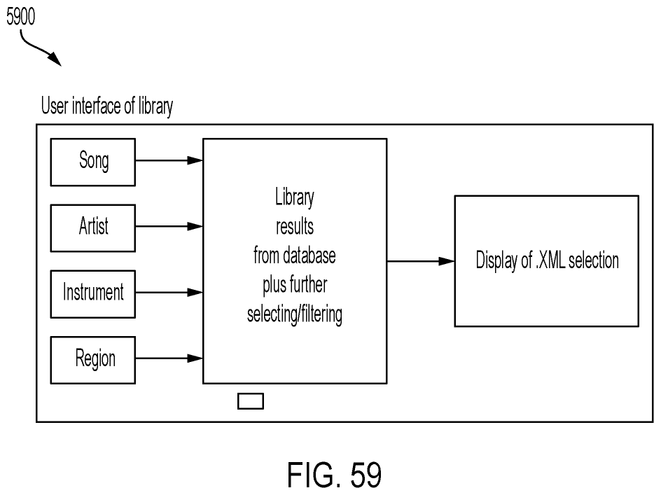

Turning to FIG. 58, an example workflow is depicted how specific tags are extracted from digital sheet music and stored in within a searchable database. In order to extract the ‘metadata’ that will be linked to an .XML file, a similar method is utilized. First, the .XML file is fetched (FIG. 58, Item 5801). Next, from the .XML file, the song name, the artist name and the tempo are extracted from the .XML file (FIG. 58, Item 5802-5804). Similarly, these extracted data are then linked to the .XML file so as to be recalled, searched, displayed and parsed by another computer or user.

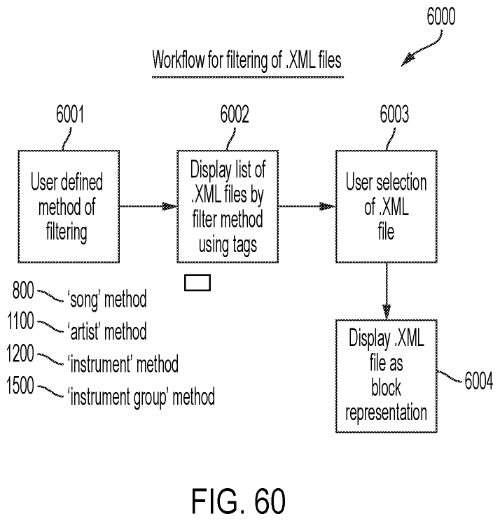

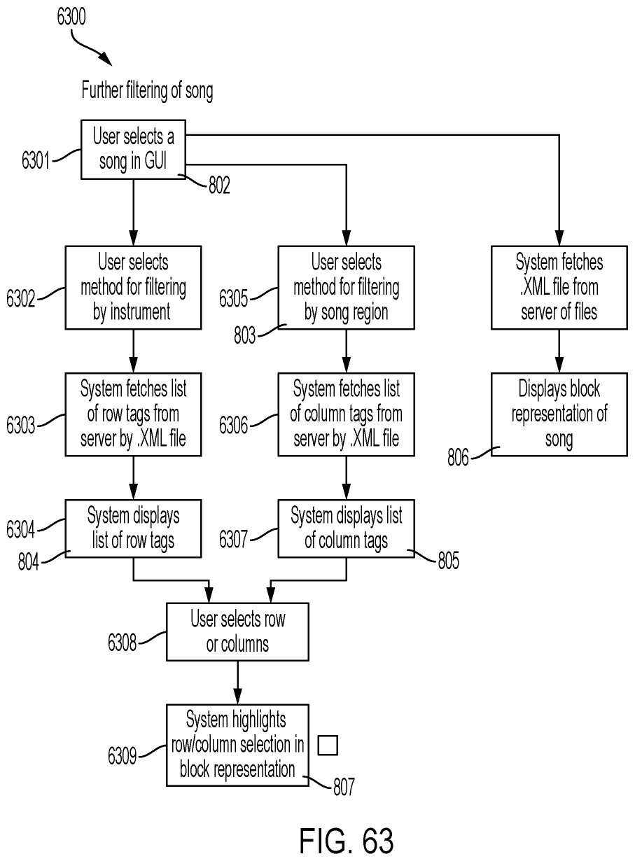

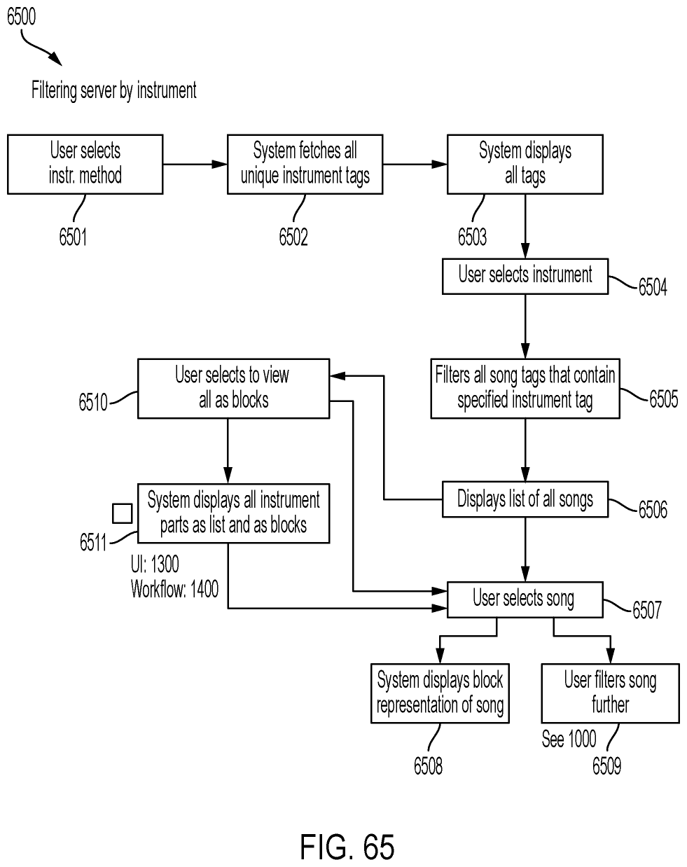

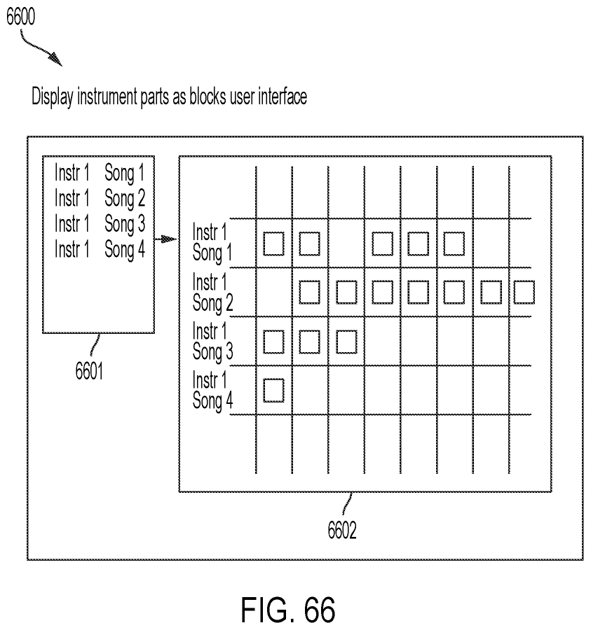

Turning to FIG. 59, an example user interface is depicted for how the library of digital sheet music can be structured to be searched by its individual components found within the Linked elements. As described above, there is a mechanism whereby the server/storage container of all .XML files with associated linked tags, can be searched and the results can be displayed. This user interface is depicted in FIG. 59 whereby a user can search through the database of .XML files by song name, artist name, instrument, or region (FIG. 59, Item 5901). The search results based on these search methods is then graphically displayed for the user based on the .XML file names (FIG. 59, Item 5902). With further selection of a given .XML file, the file then can be viewed (FIG. 59, Item 5903). Through this described graphical user interface, there is a clear workflow defined by the system. First, the user must select the method whereby they wish to filter the database of .XML files and tags. The methods of filtering the .XML files include but are not limited to filtering by song (FIG. 62), filtering by artist (FIG. 64), filtering by instrument (FIG. 65) and filtering by instrument group.

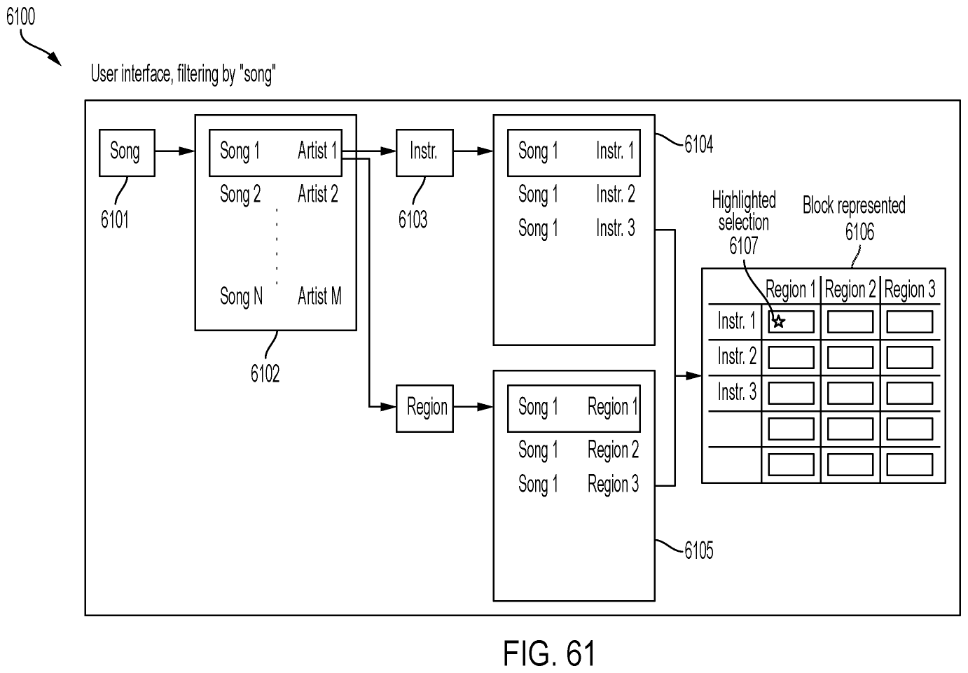

The following describes the various methods whereby a user may search through a database of .XML files with parsed tags, which then are displayed for the user to interact with further. An overall example workflow of how this system works is described in FIG. 60. A user defines a filtering method on the Primary Device, which then displays a list of .XML files or other Digital Elements associated with Linked Elements, which contain a series of tags associated with the .XML file. Then the user is able to select a specific .XML file which then triggers the system to display the .XML file or other Digital Element on the Primary Device in its block representation format.

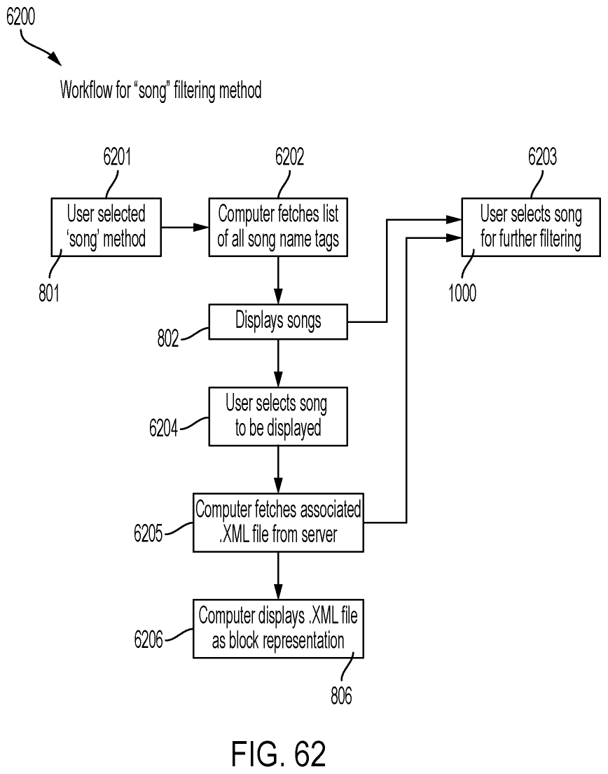

Turning to FIG. 61, .XML files or other digital sheet music or Digital Elements, can be searched by song name and an example of the graphical user interface and associated workflow are depicted. Through this method, the user may wish to search through all .XML files by their song name. This is achieved through a graphical user interface which allows the user to select the ‘by song’ filtering method (FIG. 61, Item 6101). The user interface has a display functionality for the viewing of all songs listed by song name (FIG. 61, Item 6102). The user interface enables for the selection of one individual song for further filtering ‘by instrument’ or ‘by region’ or ‘by instrument grouping’ (FIG. 61, Item 6103). The results of this further filtering can then be displayed (FIG. 61, Item 6104). From here, the graphical user interface enables a user to make a selection of a given .XML file from the list of filtered selections (FIG. 61, Item 6104) and view the .XML in a block format or edit (FIG. 61, Item 6106/6107).

Turning to FIG. 62, an example workflow of the system's method for filtering digital sheet music by song is depicted. The system described here accomplishes the filtering of .XML files through the graphical user interface described when the user first selects that the songs are to be filtered ‘by song’ (FIG. 62, Item 6201). The computer then fetches a list of all songs and their associated ‘song name’ tag stored in the server (FIG. 62, Item 6202). The system then displays this list of all songs along with other further tags. Once a user selects a given song from the listed display, the computer then fetches that associated .XML file from the server (FIG. 62, Item 6204/6205). The system then displays the .XML file as a block representation, thus enabling the user to further edit the .XML file or modulate it in another way (FIG. 62, Item 6206). It is also possible once a .XML song is selected, for the user to then filter the .XML song further by a different method—for example, a user may select a given .XML file, then wish to view all the instrumental parts and filter the list of instrumentalist parts further.

When a song is selected by a user, the user may wish to filter the song further ‘by instrument’ or ‘by song region’.

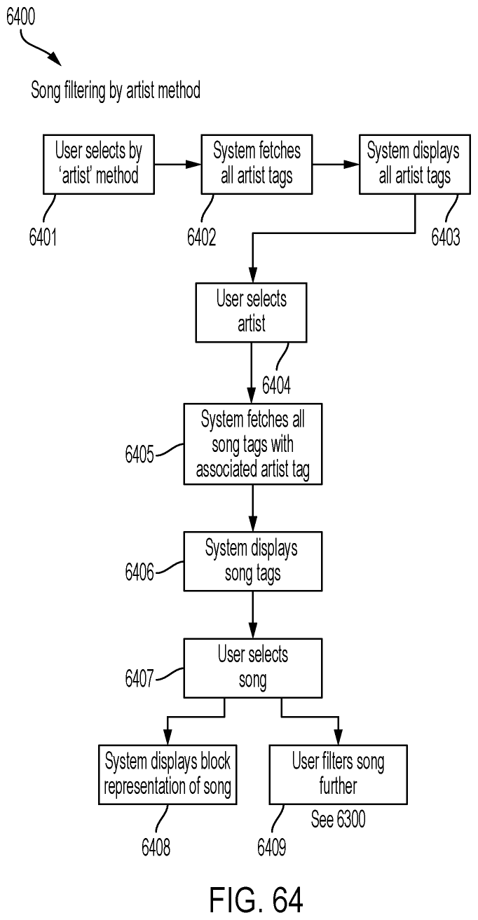

Now turning to FIG. 63, a workflow for further filtering a given song by a series of its individual components such as instrument or song region is depicted. Once a given song has been selected within the graphical user interface of the system (FIG. 63, Item 6301), a user may wish to then filter a song further—viewing, then selecting a specific set of instrumentalist parts or song regions that are included within the .XML file. If a user wishes to filter a song further ‘by instrument’, the user selects on the graphical user interface the option to filter ‘by instrument’ (FIG. 63, Item 6302). When this is triggered, the system then fetches the list of ‘row tags’ that are stored within the server for that given .XML file (FIG. 63, Item 6303). The system then displays this list of row tags on the graphical user interface (FIG. 63, Item 6304). Similarly, a user may select that they wish to filter by ‘song region’ which in that case they would select through the graphical user interface the ability to filter ‘by song region’ (FIG. 63, Item 6305). This would trigger the system to fetch a list of ‘column tags’ for the given .XML file. This list of column tags would then be displayed as a list (FIG. 63, Item 6307) where once either a column name or row name is selected within the graphical user interface (FIG. 63, Item 6308), the system then highlights and pre-selects that given row or column within the block representation of the .XML file.

Turning to FIG. 64, an example workflow is provided depicting the filtering method for searching for digital sheet music by a specific artist. A user may wish through the system to filter through the list of .XML files by artist. This method is executed when a user selects through the systems graphical user interface the ‘by artist’ method (FIG. 64, Item 6401). The system then fetches all the artist tags that exist across all .XML files in the server (FIG. 64, Item 6402). The system then displays the list of all artist tags (FIG. 64, Item 6403). A user then can select a given artist name through the display (FIG. 64, Item 6404). When this occurs, the system fetches all song tags that are associated with that artist tag name (FIG. 64, Item 6405). The system then displays that list of all song tags (FIG. 64, Item 6406) for that given artist. The user may then select a given song (FIG. 64, Item 6407) to view as a block representation and use for further editing or manipulating (FIG. 64, Item 6408); or they may now filter the song further as previously described, ‘by instrument’ or ‘by song region’ (FIG. 64, Item 6409).

Turning to FIG. 65, an example workflow is provided whereby a series of digital sheet music files may be searched for individual block representations or digital sheet music notation by a specific instrument. A user may wish through the system to filter the list of .XML files by the instruments in which they contain. For example, a user may wish to view all of the .XML file song tags that contain a trumpet part. When a user wishes to execute this method, they select through the graphical user interface the ‘by instrument’ method (FIG. 65, Item 6501). When this is executed, the system fetches a list of all the unique instrument tags that exist within the server (FIG. 65, Item 6502). The system then displays on the graphical user interface the list of instrument tags (FIG. 65, Item 6503). At this point, the user may select a given instrument tag from the display of instrument tags (FIG. 65, Item 6504). When this occurs, the system filters all the .XML file song tags that only include the specified instrument tag (FIG. 65, Item 6505). The system then displays this specific list of song tags (FIG. 65, Item 6506). From here, a user may select a given song tag through the graphical user interface (FIG. 65, Item 6507), whereby the system can display the song as a block representation or allow for any further editing of the song (FIG. 65, Item 6508), or the system can be used to filter the song further (FIG. 65, Item 6509). Additionally, once an instrument tag was selected (FIG. 65, Item 6504) and the list of all songs that contain that instrument tag is displayed (FIG. 65, Item 6506), the user may wish to view all the individual songs as blocks (FIG. 65, Item 6510). In this setting, the system displays the song list as filtered by specified instrument as a block representation (FIG. 65, Item 6511; FIG. 6600; FIG. 6700).

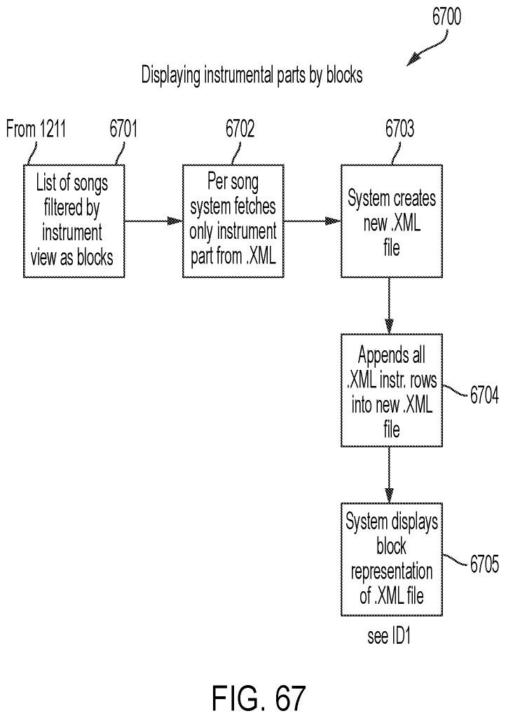

Turning to FIG. 66, an example graphical depiction is shown how lists of how results from instrumentalist searches can be viewed as a series of blocks within a grid. When a user has selected to filter songs ‘by instrument’, and thus view a list of filtered .XML file song tags as filtered by the only songs that contain the given selected instrument, the user may wish to view a graphical representation of the search results. For example, they may wish to view the block representation view of each of the instrumental parts (FIG. 66, Item 6602) as opposed to a list of the filtered songs (FIG. 66, Item 6601).

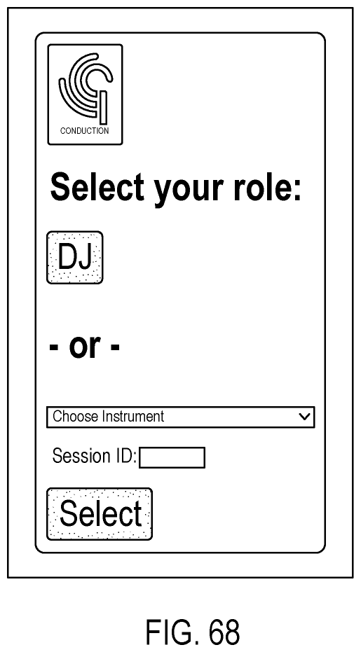

Turning to FIG. 67, an example workflow of the method used to display the list of parsed instrumental parts as a series of blocks is depicted. When a user selects to view a list of filtered songs by instrument as blocks (FIG. 67, Item 6701), the system iterates through the list of filtered songs and extracts per song only the instrument part selected from the .XML file (FIG. 67, Item 6702). Concurrently or afterward, the system also creates a new .XML file (FIG. 67, Item 6703). As each instrumentalist part is extracted from each individual .XML file, it is appended into the new .XML file as a new row in the .XML file (FIG. 67, Item 6704). The system then displays the block representation of the .XML file (FIG. 67, Item 6705), using only specific metadata such as the song name as the row names of the block representation (FIG. 67, Item 6705).

When a Linked Element is selected in the library, the user may wish to preview the song's audio and listen to it. The user can press a button so that the audio only plays through a set of headphones or speakers. The user can then define whether they want to listen to two versions of the song, either the studio version of the song or the MIDI orchestra version of the song. They can hit a button to play the song and it will play. Similarly, they can use a scroll wheel or some other kind of tool to move the playhead to a certain region of the block and then listen to that specific block.

Turning now to the Prep, Mid-Live, and Live Areas, Blocks, Bundles or a Series of Blocks and Bundles may be edited, assembled and sent to Receiver Devices. This is accomplished through dedicated areas within the graphical display of the Primary Device. The Primary User may have control over some elements of the display of all three of these regions. These regions may be continuous with one another in their display, or they may be rendered as separate entities that are removable and resizable. This level of control can include, but is not limited to the following methods.
1. Zooming in horizontally to examine Blocks at finer details within time; zooming in/out vertically to view more Tracks.
2. Scrolling horizontally or vertically to view more Blocks/Bundles, Tracks, or Regions.
3. Sliding of the boundaries between the Live/Mid-Live or Mid-Live/Prep in order to allow for one region to take up more space on the graphical display. This can occur through having ‘handles’ that the Primary User can drag to move the boundaries, or can occur automatically when a Primary User touches one area of a screen, that specific Area expands while other Areas contract in size.
4. Expanding of Tracks or expanding of Regions to show a higher granularity of the Track or Region, i.e., expanding the Brass section block to show the trumpet, trombone and tuba part individually.

The Prep, Mid-Live, and Live Areas each have an intended purpose for the Primary User and thus have specific functionalities that enable these actions. The Prep Area allows for the Primary User to assemble Blocks or Bundles and modify these Blocks or Bundles irrespective of a moving, live timeline. The Blocks or Bundles can be assembled and modified, then saved or exported as another Bundle and processed for saving, exporting, or further assembling. Additionally, the Blocks or Bundles within the Prep Area may be moved directly into the Mid-Live or Live Area when the Primary User is ready for a specific selection to be performed live by the Receiver Users.

The Mid-Live and Live Areas are continuous in time with one another. The Live Area ranges in time from 0:00 to the Burn Threshold, while the Mid-Live Area ranges from the Burn Threshold to an infinite amount of time. The graphical display of the Live Area is distinct from the Mid-Live Area in that it demonstrates through the use of coloring and shading that the Live Area is a graphical area in which modifications may not be made. Within the Live Area, modifications to Blocks or adjustments of Blocks or Bundles may not be made in any way. Within the Mid-Live Area, Blocks or Bundles may be modified or assembled or rearranged in any ways that exist within the Prep Area, except they are on a timeline that is continuous with the Live Area, and thus, when the performance begins, the entire timeline will in real-time begin moving toward 0:00, with content continually passing through the Burn Threshold, and thus being locked in space and prevented from being further modified. As Blocks pass 0:00, it is possible for the Primary User to scroll into negative time past 0:00 to view Blocks that have already been performed Live.

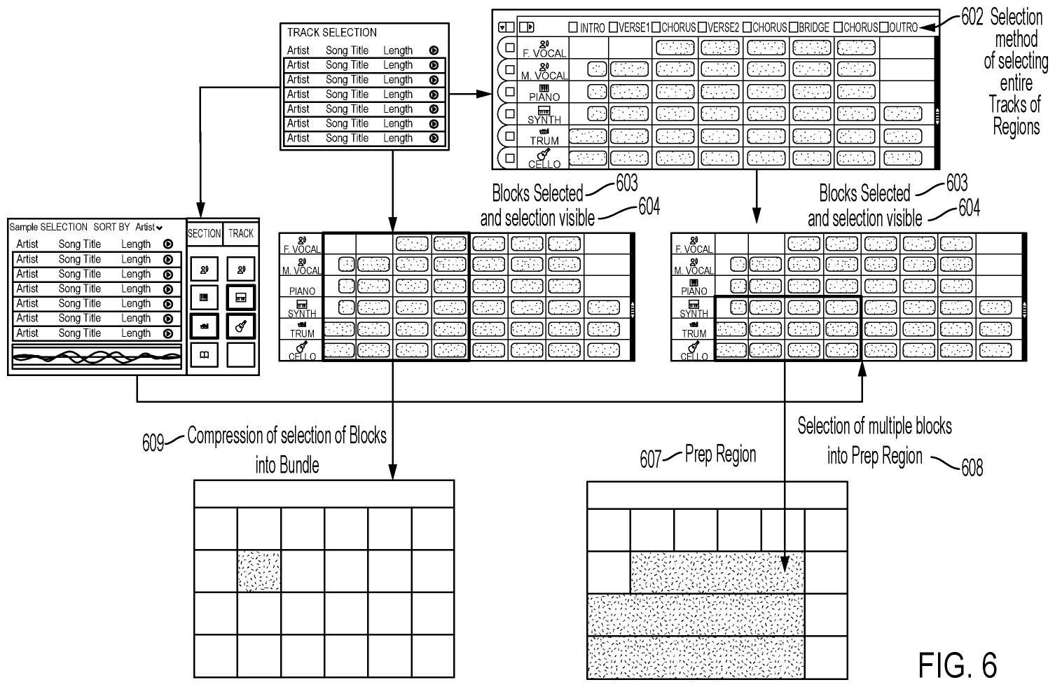

Turning to FIG. 6, a graphic depicts how blocks or groups of blocks or any grouping of a latent representation of a digital sheet music file through this system can be assembled in a prep region and aligned within a grid to be further manipulated. Through any number of methods, specific Blocks may be selected (FIG. 6, Item 603). These can exist as part of one Track or Region. This selection method encompasses the direct selection of Blocks or the use of grid-like selection check boxes that highlight full Tracks or Regions (FIG. 6, Item 602) or a highlighting method of selection in which an area is selected by dragging a region of interest to highlight a series of blocks. When blocks are selected the selected Block or Blocks become highlighted but is not limited to any other method of visual indication of selection (FIG. 6, Item 604). Blocks may also be selected in bulk through the use of a labelling system (FIG. 6, Item 605). This consists of, but is not limited to, an icon labelling system of Tracks or Regions to allow a predefined selection of Blocks (FIG. 6, Item 606). The selection of labels (FIG. 6, Item 605) is equivalent to selection of individual blocks in the Block Representation Latent Space (FIG. 6, Item 601/602/603).

Selected Blocks, groups of Blocks or entire Linked Elements may be combined, modified, manipulated, or edited in any other way. The Primary Device enables this through a Prep Region (FIG. 6, Item 607). Selection of Blocks may be directly added to the Prep Region (FIG. 6, Item 608), or the selection of Blocks may be compressed into one Bundle (FIG. 6, Item 609). Blocks may be moved to the Prep Area, Mid-Live Area or the Live Area by dragging the Blocks to that given Area or through the use of a series of buttons that allows a Primary User to move the Blocks to that given Area or any other method. Blocks or Bundles are visually represented by the Linked Element that they represent. Blocks and Bundles can be color coded by Linked Element and also labelled with Metadata to visually aid the assembly of multiple Blocks.

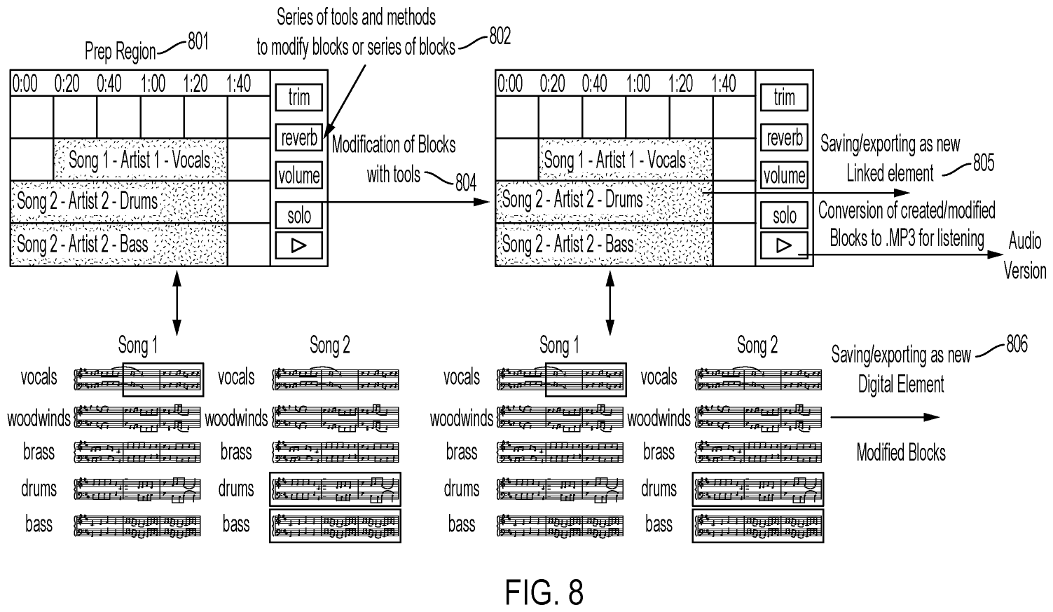

Turning to FIG. 8, an overall workflow is demonstrated how through a series of modulations of blocks within a latent representation, the inherent Digital Element in this case a digital sheet music file can be modulated. Within the Prep Region (FIG. 8, Item 801), blocks may be modified in multiple ways. These methods of modification are directly related to the common modification methods inherent to the Digital Element. For example, if the Digital Element within the Linked Element is a music score, common edits to music scores include, but are not limited to, dynamic (volume) changes, expressive changes, note modifications, solo indications, etc. Blocks in the Prep Region may be edited at the same granularity through a series of tools and methods (FIG. 8, Item 802). When Blocks or Series of Blocks are edited (804), the change is reflected in the Digital Element representation of the Block (FIG. 8, Item 803).

At any point modifications of Blocks and assembly of Blocks may be saved as entire new Linked Element files so as to be recalled at any later date (FIG. 8, Item 805). Any modifications to Blocks may also be exported or saved in the Digital Element format (FIG. 8, Item 806). At any point when Blocks are assembled or modified, the system allows for conversion of the Blocks through their Digital Element representation to MIDI files or any other file system or conversion method to audio representations as .MP3 files so as to be able to listen to the newly modified creation (FIG. 8, Item 807).

All modifications to Blocks, Bundles or a Series of Blocks or Bundles may occur within the Prep Region or Mid-Live Region. Blocks or Bundles may be modified individually, or through a series of selections, multiple Blocks or Bundles can be selected and be modified in bulk. Modifications on Blocks or Series of Blocks or Bundles are not automatically saved into the Linked Element file, however, if specifically executed, the modified region can be overwritten for the Linked Element or saved as a new Linked Element. For all modification methods to Blocks, in length, or any modification herein described, the nature of this system and method enables the same direct modification to occur to the Digital Element Representation.

Any time a block is modified, there is a notification that appears on the receiver device graphical user interface notifying them that a change has been made.

Blocks, Bundles or a Series of Blocks within the Prep Region or Mid-Live Region can be trimmed in order to make the selection and the associated Linked Element shorter in length. The Block or Bundle can be shortened from the starting position or the ending position. When a Block is shortened, the associated Digital Element is shortened. This may occur at various timescales. A Block may be trimmed at a scale of Regions (i.e. shortening from two verses to one verse) or at a much more granular scale of the Digital Element (i.e. shortening from 20 music bars to one music bar). Units of trimming can occur at the granularity of fractions of Blocks or as entire blocks (i.e. trimming a Block in half which would equate as a Digital Element to half a bar [measure] of music).

Blocks, Bundles of a Series of Blocks within the Prep Region or Mid-Live Region may be elongated by drawing on the next occurring Blocks in the Linked Element. If a Block is selected and ‘elongated’ the Block extends in units of time. This equates to an adding of Blocks concordant with the Blocks that exist after the current selected Block in the Linked Element.

Blocks, Bundles or a Series of Blocks within the Prep Region or Mid-Live Region may be elongated in time, by repeating the selected Block a number of times (i.e. looped). The selection may be repeated in units of the selected Block or in fractions of the Selected Block.

Blocks, Bundles or a Series of Blocks within the Prep Region or Mid-Live Region can be altered to adjust the volume of the given Block. When the volume is altered through a series of controls to a given Block, the associated Digital Element is adjusted to contain visual notation (i.e. dynamic signaling in music notation). In an example, if the volume is increased on one given block, then ‘forte’ will be written on that instrumentalists musician part.

In one specific example of the implementation of this setup, a series of blocks may exist within the Prep Region. Graphically displayed next to the Prep Region can be a dial, a knob or a fader. When a block or series of blocks are selected within the Prep Region, the dial can be turned clockwise or the fader can be increased. When this is modulated, the traditional dynamic music notation that is transcribed into sheet music, is ascribed to that region. The maximum value on the dial or the fader corresponds to ‘fortissimo’ and the minimum value is ‘pianissimo’. In this way, when the block is modulated with the volume control, the Digital Elements, or digital sheet music notation that the given block corresponds to then gets written into each part the value between pianissimo and fortissimo.

Blocks, Bundles or a Series of Blocks or Bundles within the Prep Region or Mid-Live Region can be modified to include a text signal. This text signal then can be incorporated directly into the Digital Element. In one example, there is a text signaling box that graphically exists at the top of the Receiver Device's interface. When the Primary User through the Primary Device selects a block or the symbol of a Track, they can choose from a variety of preset buttons that include direct messages that will be sent to that Track's Receiver Devices. In a specific example, a Primary User can select on the Primary Device, a track that is labelled ‘brass’, then a button that says ‘play softly’. When this is executed, the trumpet, trombone and tuba Receiver Device's then have a display on their text signaling center that reads ‘play softly’. It is also possible for the Primary User to type through the use of a digital keyboard or a manual keyboard a custom text message that is not displayed on a series of preset buttons.

If multiple Receiver Devices are assigned to display the same Digital Element, it is possible to offset the synchronized clock from one another to create a ‘reverb’ effect on the performance of the Digital Element. When a block is assigned to contain a reverb effect, the Digital Element of one Receiver Device may be slightly offset from the other Receiver Device. Additionally, if a ‘click-track’ is being used by the Receiver Users, these ‘click-tracks’ may be offset from one another to create the effect of an echo.

There are multiple variations on how the reverb effect can be applied to a specific set of blocks. One method is achieved through the use of a knob that is labelled as reverb. When a block or a series of blocks are selected, the reverb knob becomes graphically visible or changes in visual appearance to notify the Primary User that the effect is executable. Once this occurs, the Primary User may turn the knob to its maximum position or its minimum position. The Primary User may define within their setting preferences the amount of offset that is assigned to the minimum and maximum of the reverb dial. By default the minimum value is 1/16th note and the maximum is a quarter note. When the reverb dial is turned, depending on its location within the minimum and maximum, a fraction may be calculated between 1/16th note and a quarter note. This may or may not occur in units of common divisibility musically, depending on the preferences set by the user. In one example, if the knob is turned to half its position, it would engage a ⅛th note delay on the set of blocks. When this occurs there are multiple different possibilities.

Depending on the user preferences that are defined on any of the devices, one method that could be activated is for the reverb to take effect ‘in notation’. If this method is selected through the user interface, then, if there are multiple receiver devices that are open for one given instrumentalist part, then each of the music notation .XML files are adjusted so that there is a dedicated first player, second player, third player etc. Each player's .XML or any other digital sheet music notation is then offset by the defined amount.

A different method that could be enabled, is that instead of the digital sheet music being offset by the offset value determined by the knob, if each of the instrumentalists are hearing an auditory ‘click’, all of their clicks may become offset from one another by the defined amount so that as long as the instrumentalists are following the ‘click’ for the performance of the digital sheet music, each of their performances then ultimately becomes offset from one another by the dedicated amount.

Blocks, Bundles or a series of Blocks or Bundles may be altered to indicate a solo performance. In the setting of musical performance, the Digital Element sheet music is replaced by bars of rests or just indicates chord progressions, replacing any existing notation that was in the Digital Element at that region.

One alternative to this method can be executed by the Primary User on the Primary Device. In this setting, within the library for each ‘song’ that exists in the library, there also exists a Linked Element that is labelled ‘solo’, wherein the digital sheet music that corresponds to that block representation of the Linked Element is empty bars with key changes/chords labelling each bar. This ‘solo’ block can be dragged into any instrumentalist row within the Prep, Mid-Prep or Live area and the chord notation will either be altered depending on the instrumentalist's native music key signature, or it will display the default chords for the song.

It is also possible within the Primary Device's interface to select blocks within a library that are labelled with specific chord names. When a block with a specific chord name on it is moved into any area corresponding to an instrumentalist's row, the Linked Element, digital sheet music that corresponds to this block would be an empty series of music measures with the block labelled chord corresponding to it. This can be in units that are set as default through the user of the Primary Device. In this way, a given Primary User can define through the use of the Primary Device individual chords one at a time or in tandem to one another that one or multiple Receiver Devices should display and thereby the Receiver Users should solo on.

As described previously, accompanying this added modulation of a block and thereby presentation of digital sheet music to the Receiver Device may be a display and auditory signaling conveying that a solo region is upcoming.

Blocks, Bundles or a series of Blocks or Bundles may be ‘muted’ in the Prep Region or Mid-Live Region. There are several possible implementations of the muting function dependent on the user preferences delineated by the Primary or Receiver User through the use of the Primary or Receiver Device.

One variation of how a Primary User can ‘mute’ a given block or series of blocks in the timeline by selecting a button on one instrumentalist's row in the timeline that corresponds to the ‘mute’ button. When this is selected, all of the blocks within the given row are effectively ‘muted’. Another variation of this method for selecting blocks to be muted can be through the use of multi-selecting blocks one at a time, then selecting a button on the user interface of the Primary Device that indicates to mute those selected blocks.

When blocks are muted, on the Primary Device's user interface, the blocks change visually to indicate that they have become muted. This can occur by a change of color, or a change in the texture of the color of the block or they can disappear, depending on the user defined preference or the default preference for the implemented version.

On the Receiver Device, the blocks or bundles or series of blocks that have been muted correspond with digital sheet music as previously described. Similar to the graphical change that occurs on the Primary Device. When blocks are muted, they are visually changed to either disappear entirely, or are replaced by measures of rest, or are visually changed with a color change, or are modulated to contain music notation to be performed as quiet as possible (i.e. ‘ppppp’), or changed in another graphical representation so that the Receiver User understands that the bars that were muted, should not be performed. As previously described, this can also be accompanied by a notification or message to be displayed visually and auditorily on the Receiver Device.

Additionally, if the blocks that are ‘muted’ exist within the Burn Threshold, it is possible through user defined preferences for the blocks to still be able to be muted, however, it may be accompanied by a ‘count-in’ which is either displayed visually or auditorily on the Receiver Device to allow for a scheduled count down of a few beats, so the Receiver User has notification that a change is about to occur.

When a section is ‘unmuted’, meaning that the blocks that were muted now are disengaged to become active again, the inverse of the graphical display changes on the Primary and Receiver Devices are engaged. For a region of blocks that were initially grayed out or changed in color, they now revert back to their normal color. As occurs if the changes are executed while in the Burn Threshold, it is also possible that when sections of blocks are ‘unmuted’, there is also another displayed count-in for the Receiver Devices, so that the Receiver Users have a few beats or bars (as defined by any of the Users through their Devices) notification before the change takes effect.

Blocks or Bundles can be duplicated. When the duplication is created within the Prep or Mid-Prep region the duplication of the Block or Bundle is appended to the end of the current Block or Bundle that is selected. This duplicated Block or Bundle or any other selected Block or Bundle can then be moved to a different Track. The notation that is inherent to that Block can be then replicated into another instrumentalist's notation. Any necessary key signature changes or notation changes to reflect this alteration are possible.

Duplication can occur through multiple methods. One method is that the Primary User through the use of the Primary Device can select a block or multiple blocks. When these blocks are selected, a series of buttons may become visually depicted. One of these buttons can be a ‘duplicate’ button, either depicted in text or graphically. When this button is engaged, the selected blocks become duplicated, and appended to the current row and block. Since blocks correspond to digital sheet music notation, the change is also reflected on the Receiver Device's interface with the corresponding sheet music appended. This also may correspond with a notification either graphically or auditorily notifying the Receiver User of the modification.

Blocks or Bundles can be modified into a different key signature. This key signature change is adjusted in the Digital Element format.

There are multiple methods whereby this can be executed. One method is whereby a selection of blocks, bundles or entire instrumentalist rows may be selected on the Primary Device, then a button labelled either with text or graphical indication may be selected to modulate the key signature of the given selection. This enables the selection of a specific key signature through any common methods or a predefined typing of the key signature. When this is enabled, the key signature for the corresponding digital sheet music is altered to then correspond to the selected key signature. If a Primary User makes an adjustment to the key signature on a block that is also in the same timeline point as a block with a different key signature, a display message or auditory signal may notify the Primary User that there are two blocks on the timeline with varying key signatures.

An alternative method may exist whereby when a block or bundle or series of blocks or Track or Region is selected, and when the key signature modification method is selected on the Primary Device, instead of selecting a key signature, it is possible to select another Linked Element within the Library. When another Linked Element is selected, the key signature that the selected blocks will modulate to, is the key signature of the Linked Element that is selected. For example, if the blocks that are selected originate from song X, and the key signature modification is selected and Linked Element Y is selected, then the blocks from song X will transpose on the digital sheet music notation to the key signature of Linked Element Y.

A series of Blocks or Bundles can be filtered using traditional frequency filter gates (high pass, low pass, mid pass, etc.). When filter gates are applied to a series of Blocks or Bundles, the dynamics of the individual digital elements are modified according to the filter that is selected. For example, when a high pass filter is applied to a Series of Blocks that contain instruments that are high (alto saxophones) and low (tubas), the alto saxophones Digital Element sheet music representations are modified to contain dynamic changes that are loud, while the tuba Digital Element sheet music representations are modified to contain dynamic changes that are soft. The inverse is true for low pass filters. Custom filters can be generated. The dynamic changes that are possible when a filter is applied are not binary as in ‘loud’ or ‘soft’. They can be displayed on the Digital Element through a variety of methods either as traditional music notation nomenclature such as ‘piano’ or ‘forte’, or as a percentage of volume such as ‘100%’ or ‘75%’. The method for controlling the filters may include a binary feature such as ‘apply high pass filter’, in which a set filter is applied to a series of Blocks or Bundles. Another method for controlling filters can exist as a dial knob in which the dynamic change gating amplitude and difference of change can be controlled on a sliding scale. For example, when the knob is turned to its maximum position for a high-pass filtering, the difference between the ‘pass-able’ instruments and containing Digital Elements for those instruments would be set to 100% volume while the Digital Elements for the cut-out instruments would be set to 0% volume. If the knob was turned to half its maximum position, the Digital Element sheet music notation would reflect only a 50% difference in volume notation.

One way that this is executed is through the use of defining given instruments on a scale of highest in frequency to lowest in frequency. This can be determined multiple ways. One way can be through a manual assignment, whereby the Primary User can assign each instrumentalist a value on a scale of values from highest to lowest frequency. This way, when multiple blocks are engaged for EQ'ing, the assignment of scaling the high-pass and low-pass filtering can occur based on the gradation defined by the Primary User.

This gradation can also be assigned by the Primary Device. If this is executed, then a default assignment of average frequencies is assigned to each instrumentalist part as a predefined reference list. When EQ'ing is thereby engaged on a series of blocks, the reference list is checked to see which instrumentalist parts should change according to the principles described above for the pass filtering.

Through the use of multiple types of controls Regions of Blocks may be altered for their tempo. The tempo of Blocks and thereby the tempo notations of the Digital Element representation may be altered through a knob system or through the direct typing of the BPM or through a slider. Through this method, the selected blocks' tempo is directly changed and reflected in the notation for those Digital Elements. Additionally, tempo may be adjusted through the use of a graph function in which gradients to the tempo across multiple Block Regions can be effected. In this way, as a tempo change is indicated, every bar measure is altered with a tempo change notated on the Digital Element. The audio component of the clock synchronization is changed as reflected by the tempo adjustments.

The tempo may also be adjusted by allowing the Primary User to tap a button repeatedly on the interface. The average time in between taps is calculated and an average BPM is calculated for the tapping. This then translates to alter the tempo for that individual section that is being modulated.

A Block or Bundle or Series of Blocks or Bundles may be modified to create a Half Loop. A Half Loop modification allows for the duplication of a selection of Blocks with the added modification of the duplicated selection being duplicated as only half its current length. For example, a 16-bar section of music can be Half Looped which would then create a duplicated version of this selection only duplicating the first 8 bars. If the subsequent selection was continually Half Looped it could be duplicated from 16 to 8 to 4 to 2 to 1 bar. This change is reflected in both the Block Representation and the Digital Element representation.

A block or Bundle or Series of Blocks or Bundles within the Prep or Mid-Live Area may be moved from one row (Origin) of this Area to another (Destination). When a Block is moved from an Origin to a Destination, the instruments which belonged to the Origin will now contain bars of rest in the music notation, while the instruments which belong to the Destination, will now contain the music notation that is now transcribed and translated appropriately into their key signature and music notation format.

A block or Bundle within the Prep or Mid-Live Area may be split using a variety of methods. A selection may be split directly in half allowing for the subsequent moving and altering of the individual halves of the Block or Bundle. Through another method, the Block or Bundle may be split in non-equivalent parts through the use of a scissor tool or any other method. When this alteration is made the Digital Element Representation is also split by the same amount and the individual parts are able to be further altered.

Within the Prep Area or the Mid-Live Area, Blocks or Bundles or a Series of Blocks or Bundles within one individual row may be compressed into one Bundle. When this occurs, it links that Digital Element selection contained within the Bundle to now be edited in bulk as one selection. Additionally, Blocks or Bundles across multiple rows may be compressed into one Bundle which then would appear in the Bundle row of the Prep, Mid-Prep or Live Area. This does not create any change within the Digital Element representation of the notation, unless further altered, however allows for the mass editing of this selection to occur.

When a Series of Blocks or Bundles spanning multiple rows is selected and modified using a Jigsaw method, the selection is modified to remove segments of the Digital Elements in a ‘jigsaw’ fashion. For example, if the selected Blocks or Bundles spans three rows and contains 9 units of measure in columns, when the Jigsaw method is applied to this selection, the first row would now contain only 3 units of measure, the second row would contain 6 units of measure and the third row would be unmodified to still contain 9 units of measure in the Digital Element space. Any remaining space would be replaced by bars of rest in the Digital Element space. Through a series of methods, the orientation of the jigsaw may be modified so as to create a gradient from the top down or the bottom up or any other orientation.

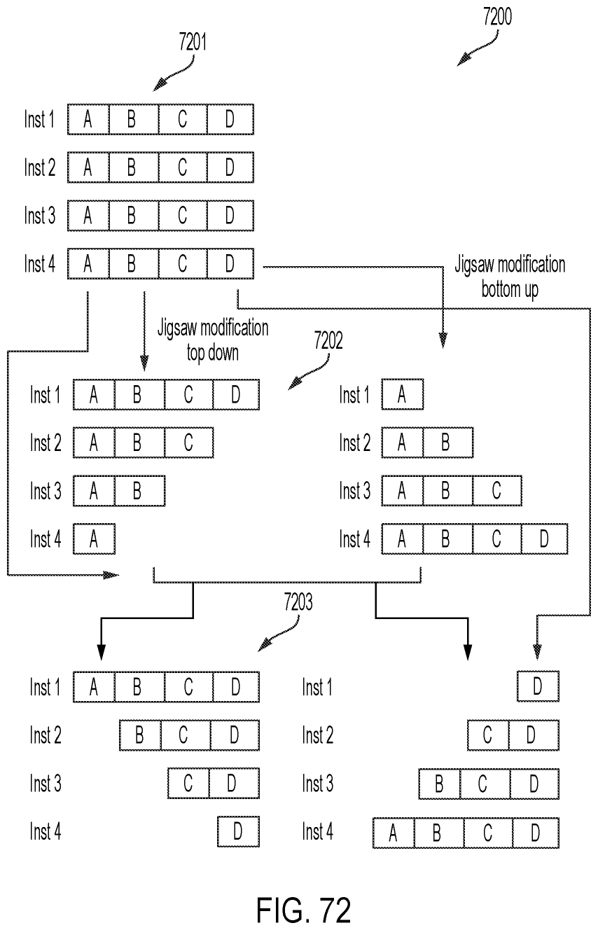

Turning to FIG. 72, a graphic is depicted showing the effect of engaging a Jigsaw Fit on a series of blocks. In the example, there are four Tracks with four corresponding Regions (A, B, C, D) (FIG. 72, Item 7201). When the Jigsaw fit modification is enabled on this series of blocks, the instrumentalist regions are modified so as to go either top-down or bottom-up, dividing the blocks, removing one block at a time since there are four instrumentalist rows and four Regions (FIG. 72, Item 7202). It is also possible for the modification to be inverted laterally so that the orientation can be flipped side to side (FIG. 72, Item 7203). Since these blocks correspond to digital sheet music or any other Digital Elements, when the Jigsaw modification is enabled, the changes are reflected for the Receiver Devices as digital sheet music alterations. Where there exists empty spaces in the block format, there exists empty digital sheet music notation for the Receiver Device interfaces.

Within the Timeline, as blocks are assembled and modified, it is possible for a Primary User through the user of the Primary Device, to select multiple blocks or individual blocks or entire Tracks or Regions, and save the selected blocks as new Linked Elements to be recalled either through the specific account of the Primary User saved in a database or made available to other Receiver Devices or Receiver User accounts. When a group of blocks are saved, the block representations are saved as digital sheet music files whereby all of the empty regions of the maximum fit of the blocks are saved as empty music notation measures. This new Linked Element can then be saved as a file in the server or database of Linked Elements with its own custom metadata.

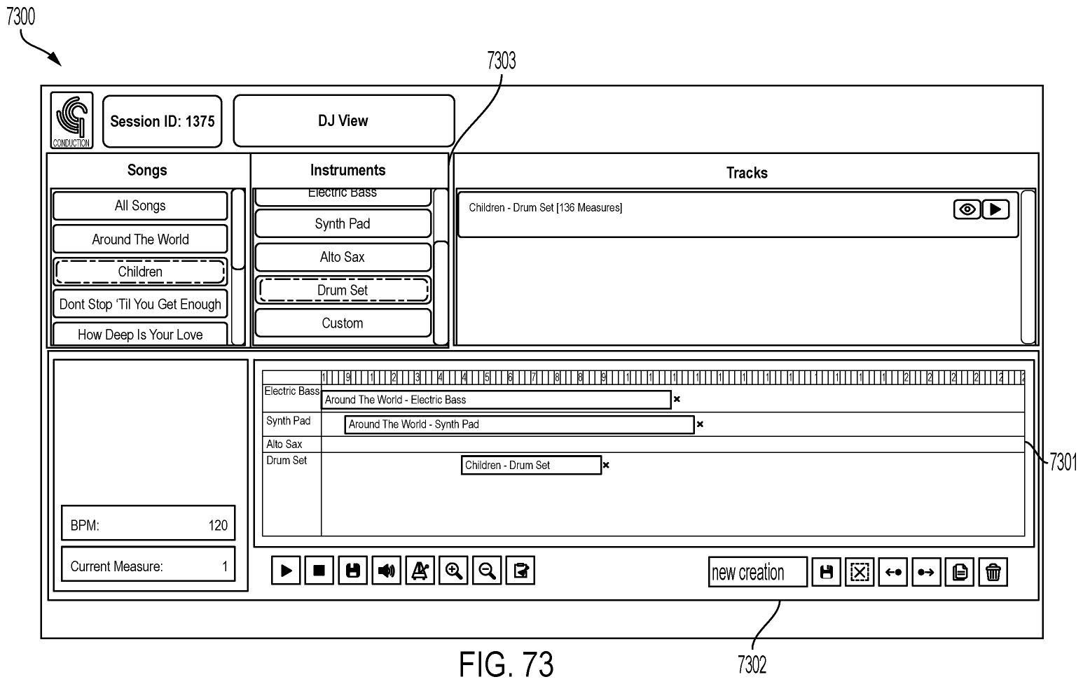

Turning to FIG. 73, an example graphical interface is depicted, showing how multiple blocks within the Timeline can be selected (FIG. 73, Item 7301), then saved with custom metadata such as a name (FIG. 73, Item 7302), then be later recalled in the library of Linked Elements in a grouping of ‘custom’ songs (FIG. 73, Item 7303).

Blocks, Bundles or a Series of Blocks or Bundles may be moved from the Library, Quick Selection, Block Representation View, or Prep Area directly into the Mid-Live or Live Area. These selections may be brought in to a given row at any timepoint within these two spaces. These selections may be brought into these areas through a number of methods including, but not limited to, dragging or sending through the use of buttons the selections directly to a specified timepoint, dragging or sending through the use of buttons the selections to the nearest available location, or dragging or sending through the use of buttons the selections to a predefined timepoint through the use of a bookmark or timepoint cursor.

When Blocks, Bundles or a Series of Blocks or Bundles are moved to the Mid-Live or Live Area, the corresponding Digital Element of the Block Representation is displayed on the Receiver Device's interface. If the Block is not within the Burn Threshold, the Digital Element that is displayed on the Receiver Device is graphically changed to indicate that there is still time for the Primary Device to change the contents of that specified Digital Element. This may be indicated through various methods, including but not limited to, changing the opacity of the Digital Element, changing the color of the Digital Element, placing text over the Digital Element, shading the Digital Element in some format, or sending an audio signal to the Receiver User. If the Block is not within the Burn Threshold for the Primary Device, the Primary Device will display the Blocks in the Mid-Live Area with their usual graphical display. The Blocks will continually approach the Burn Threshold over time.

When the Block Representation of the Digital Element is nearing the Burn Threshold timing, as set by Primary User preference, within the span of seconds or minutes, there can exist a graphical changing of the Receiver Digital Element to indicate that the Digital Element is nearing the Burn Threshold. This may be indicated through any methods previously described. This can also be accompanied by an audio signal that is sent to the Primary User indicating that segment of Blocks are nearing the Burn Threshold.

Once the Block Representation is within 0:00 and the Burn Threshold, the Digital Element on the Receiver Device is again, changed graphically to indicate to the Receiver User that this segment is now unchanging and will need to be performed in real time. This indication is made possible through the use of shading or opacity removing or editing, or sending of audio signals to indicate that the portion is going to be performed live. For the Primary Device, the graphical display may change in a similar format, changing the coloration of the Blocks or the background of the Blocks in order to convey to the Primary User that the Blocks are nearing the Burn Threshold. This may also be indicated through the use of audio signals.

Once Blocks or Bundles have been placed within the Live and/or Mid-Live Area, the performance may begin as determined by the Primary User. The Primary Device allows for a performance to begin through a series of methods including, but not limited to, a series of ‘play’ buttons or knobs within the Primary Device. This initiates a graphical and audio countdown that is transmitted and synchronized to the Primary Device/User and Receiver Device/User. When this occurs, the Blocks and Bundles that exist within the Live and Mid-Live Area all begin moving toward 0:00 and the Burn Threshold respectively. The Primary Device may be controlled with a series of switches or in a panel of preference selections to prevent the Mid-Live Area region from continually moving. Simultaneously, on the display of the Instrumentalist Receiver, a graphical display indicating the current point in time will be displayed—this may exist, but is not limited, to appearing as a vertical black or red or any other color line that gradually moves through the Digital Element in real time. At the same time, the synchronized ‘click’ is transmitted to the Primary User and all Receiver Users. This synchronization in time may also be displayed on both interfaces as a flashing clock or flashing symbol or color to indicate the tempo of the song and that the performance has begun. As Blocks and Bundles move past 0:00 and the Burn Threshold, the graphical view of the Blocks on the Primary Device and the corresponding Digital Elements on the Receiver Device change respectively as delineated in the previous section.

At any point the Primary User may toggle through the use of a variety of knobs and buttons or selections to listen to the audio that is being performed live by the Receiver Users, or may listen to the audio that is being generated from the Metadata of the Linked Element within the Live or Mid-Live area, or may listen to audio that is being generated from Metadata of Linked Element in any other area of the Primary Device. The Primary User or Receiver User may also use through a series of controls and preferences to control if a ‘click’ is audible to them or not. The Receiver User may also have control over the audio that is transmitted to them live, selecting through a series of buttons and controls to listen to the ‘click’, the Metadata audio of their Track, the Metadata audio of multiple Tracks including the entire current summed audio of the current live section, or a selection of Tracks or audios from Receiver Users.

Whenever a receiver device does not actively have a block of sheet music in the timeline that is playing, there is no digital sheet music that is displayed. However, when a block is added to the timeline, the sheet music is displayed, but there is a graphical change to the sheet music that is made to indicate that it is not yet active and the musician should not play it yet. For example, if the sheet music is added forty bars ahead of time, that sheet music may be displayed but it is grayed out. When the sheet music is about to approach the ‘live’ time or is within the Burn Threshold, the graphical display changes again. Finally, when the sheet music is about to approach the current measure in the timeline, there is a one or two bar countdown that is either audio and/or visually displayed to the musician to count them off, and then the sheet music changes interface again to demonstrate that this is a live component to be played.

The input of the described system requires digital sheet music notation files, in the setting of a music application. This system also has a capability whereby a musician can use an external MIDI controller or other music input device such as a microphone, to perform a segment of music, the system will convert the MIDI data or audio data into musical notation and allow for the Primary User to then utilize that newly created digital sheet music notation in the system. For example, a Primary User can perform an 8-bar keyboard performance, directly into the system. Then the Primary User can drag that newly created block to a different instrumentalist, and the notation will appear in a modified fashion to the new instrumentalists Receiver Device. This can be applied to multiple rows in the Live, Mid-Live and Prep Area so that a performer can play a specific segment of music, the sample is transcribed to notation, then the segment appears on the Receiver Device's display.

This same process can occur by a Primary User first selecting a specific instrumentalist row in the Timeline, then pressing a button on the Primary Device to record a segment of audio. As previously stated, the Primary User can then use an audio generating device such as a keyboard or microphone to perform an audio segment. This can be performed with the aid of a metronome click track. When the Primary User stops performing the segment and hits a stop button, the segment is immediately transcribed into digital sheet music. This in essence creates a new Linked Element in the library with an associated Latent Representation Block in that given Track's row in the timeline that corresponds to digital sheet music displayed on the Receiver Device. This enables a performance style that is ‘call and response’ in nature, whereby a Primary User performs a segment of sheet music, and a series of responders using the Receiver Device can perform the same piece back from the Primary User by reading the Digital Element that is displayed on the Receiver Device.

Every time a user adds a block to the prep/mid-prep/live area, a new score is generated and saved. In this way, any time the user is creating a new digital element sheet music, even if it is not being sent in real time to musicians, it is being saved as a new score. This means that it can be recalled back into the software as the block representations, or it can be saved and exported as digital sheet music. Any empty regions within the live timeline are treated as empty measures of sheet music and the score is saved accordingly.

The receiver device interface has multiple regions. One region is for the displaying of the Digital Element, in an example, to display the sheet music that is being sent from the Primary User. When the performance begins to go live, there is an indicator that follows along the Digital Element sheet music indicating which is the current synchronized bar. There is also an area for visual display that is included on the receiver device interface where messages from the primary user can be communicated. For example, this could include a message such as ‘get ready to stop playing’ or a custom text message written from the primary user or a message such as ‘sheet music about to update’. There is also a visual panel of a set of controls on the software that can allow messages and signals to be sent from the primary device.

The Receiver Device has the capability to play back audio to the musicians. This audio that is being played back to the Receiver may be of different forms. Based on the user's preference it could be playing the MIDI orchestral version of the current live timeline blocks. This can include or not include their own part. They can also listen to the studio version of the song that is currently live in the timeline related to their song. They can also choose to listen to the other musicians that are performing live that is coming from their microphones.

As blocks are added into the Timeline, the Digital Element representation is displayed on the Receiver Device. Depending on the location of the Block Representation in the Timeline, whether the block is placed in the Prep, Mid-Prep, or Live Area, the block on the Primary Device and the Digital Element on the Receiver Device is graphically altered with color or by another common method to indicate which region the Block/Digital Element is placed in. If a given Track or Receiver Device contains no Block within the Timeline, nothing is displayed on the Receiver Device's interface—or empty measures of digital sheet music are displayed. When a performance begins on the Primary Device, and the Timeline begins to move in real synchronized time with the Receiver Device, there is a system of notifications that is employed, as blocks approach the current time or the Burn Threshold time. As a block of digital sheet music or other Digital Element approaches the current time or Burn Threshold, a notification is displayed on the Receiver Device's interface and can be played auditorily to the Receiver User. This change can also occur via a graphical change in color for the Receiver Device's digital sheet music notation. For example, as defined by the Receiver User using the Receiver Device, if a digital sheet music notation measure is occurring 2 measures ahead in time, the Receiver Device can opt to receive a notification visually or auditorily indicating that a music notation is approaching. An example of the notification could be an auditory file transmitted through headphones of the Receiver Device saying ‘music approaching’, or ‘be prepared’, or ‘get prepared’, or a common count down on each of the synchronized beat, counting down from the total number of beats remaining until the sheet music is at the current time.

The receiver device is able to request alterations to the digital elements to the DJ. For example, the receiver device may press a button that says ‘request solo’ which will then send to the DJ an interface that indicates that a musician or groups of musician have requested a solo. The primary user can then approve or deny the request. Either way, the result is displayed on the receiver devices user interface. If the solo for example is approved, then the digital element sheet music changes to reflect that—i.e. the sheet music changes from notation to empty measures with chords listed and big text says ‘solo now’.

In addition to the Receiver and Primary Devices there is also a Monitoring Device that can be controlled by a stage manager or similar role. This monitoring device displays the connection activity between the receiver and primary devices. For example, if there are 150 receiver devices connected to the primary device and all part of a similar session, the monitoring device can check the bandwidth capabilities for all of these devices and ensure that any signals that are being sent between the devices are being received and sent appropriately.

When the receiver device or the primary device become disconnected for some reason, a message is displayed on the primary, receiver and monitoring device prompting the users that there is an error that needs to be fixed.

The following are descriptions of extensions of the systems and methods presented herein. There may be a web based system whereby users can purchase and download individual instrumentalist parts from a specific song. This then corresponds to a specific instrumentalist part within the .XML region. This can then be used as a direct input to the Conduction system. Any parsable group of measures in a song can be purchased and downloaded in this way. This allows for a person to download, mix and mash up segments of digital sheet music as opposed to being confined to using entire full songs of sheet music.

The system described here may also be accompanied by a live streaming video component. In this addition to the system, there is a series of linked video monitors that enables the Receiver Users to exist in different remote locations from one another. In this setting, the Receiver Devices and Primary Device may or may not be still synchronized via a common clock. In this setting, when digital sheet music notation is displayed on the Receiver Device's interface, there is also a microphone system that is able to record the music audio production that is made by the Receiver User. Multiple Receiver Users may all asynchronously perform the digital sheet music notation that is displayed on their respective Receiver Device. At a triggered event, all of the audio files that are recorded on each of the Receiver Devices are then aligned with one another to create a full composite track. The composite track can then be played back through the Primary Device. In a specific example, the Primary User with the Primary Device may place one given song that contains 5 Receiver User parts in the Timeline. When the Primary User hits ‘play’ on the performance, the digital sheet music notation has been already displayed according to the rules of the Timeline, and begins to record any audio that is produced by the Receiver User performing the digital sheet music that is displayed on the Receiver Device. At a certain point, the audio files that are created by these 5 Receiver Users are then all aligned by a common clock and sent back to the Primary User. This enables multiple instrumentalists to perform asynchronously with one another to create an audio recorded file.

While it is described here in the system that Digital Elements are represented as Blocks, then modifications are made to the latent block representation, then converted back to their Digital Element native representation, it is worth noting, that this process can also occur non-linearly. In this setting, as Blocks are modified by the Primary User on the Primary Device, the modifications can be made immediately to the Digital Element file, and the changes can be saved and reflected immediately, as opposed to the changes being reflected on the Block representation then being converted back to a Digital Element format.

The overall system described here may either be a hardware or software based system. In the software based system, the same software may be deployed on a web-based app on a server or a downloadable software that is deployed on a given hardware device. The same software may be used on both the Primary and Receiver Devices.

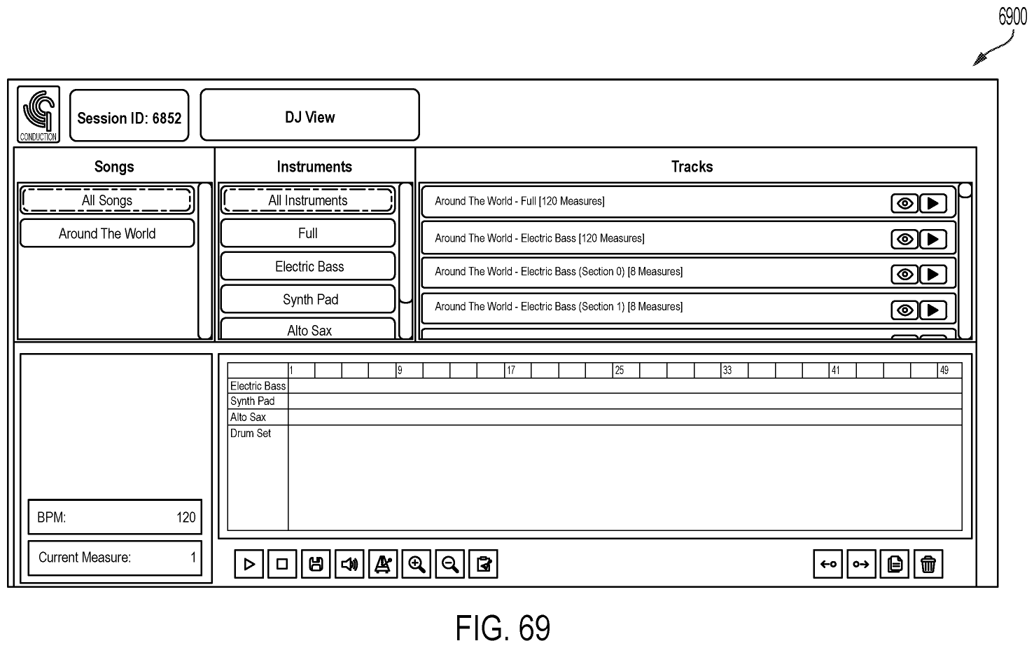

Turning to FIG. 68, an individual user may select whether they are the Primary User or the Receiver User by selecting through the graphical user interface “DJ” or “instrumentalist”. The Receiver User may further select which instrumentalist they represent, thereby selecting which digital sheet music they will be receiving and displaying on the Receiver Device when the Primary Device begins transmitting music.

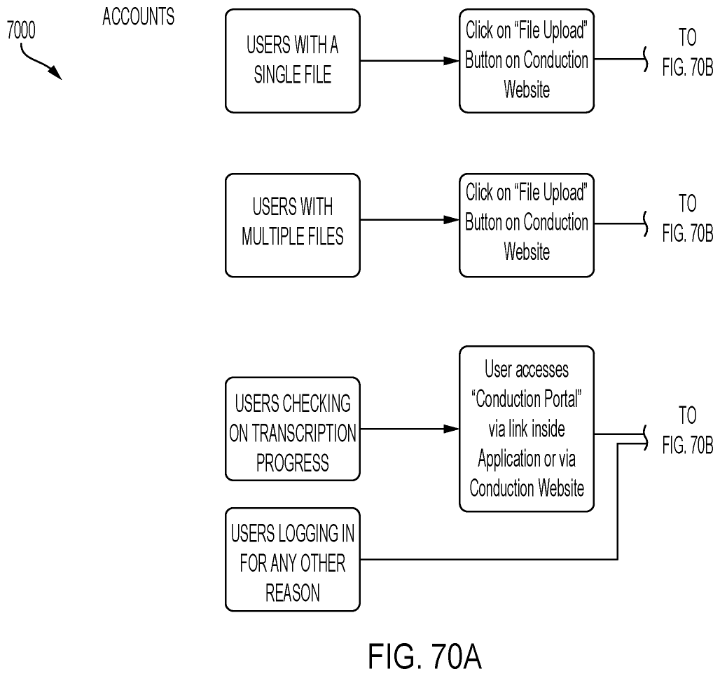

As depicted in FIG. 69, there exists a common session ID as displayed on the Primary Device, that when input by the Receiver Device, aligns the Primary and Receiver Devices to communicate on a common session. This allows for multiple Primary Devices and Multiple Receiver Devices to all operate at the same time, potentially on separate sessions.

It should be noted that various changes and modifications to the presently preferred embodiments described herein will be apparent to those skilled in the art. Such changes and modifications may be made without departing from the spirit and scope of the present invention and without diminishing its attendant advantages.

What is claimed is:

1. A system for dynamic, real-time composition and display of sheet music comprising:
a data library including a plurality of static music notation files, each static music notation file represented as divided into a plurality of blocks;
a primary device in communication with the data library, the primary device including a user interface, memory storing program instructions, and a communications module;
a receiver device in communication with the primary device;
wherein, in response to executing the instructions, the primary device:
communicates a dynamic notation file to the receiver device based on a configuration of the plurality of blocks arranged by the primary device; and
presents a GUI including controls for moving selections of one or more of the plurality of blocks in real-time while the communication to the receiver device is in progress.

2. The system of claim 1, wherein the dynamic notation file is a representation of the configuration of the plurality of blocks arranged by the primary device presented to the receiver device in a first format schema and the configuration of the plurality of blocks arranged by the primary device are presented through the primary device in a second format schema.

3. The system of claim 1, wherein the plurality of blocks are divided by instrument.

4. The system of claim 1, wherein the plurality of blocks are divided by instrument grouping.

5. The system of claim 1, wherein the plurality of blocks are divided by time.

6. The system of claim 1, wherein the plurality of blocks are divided by song segment.

7. The system of claim 1, wherein the plurality of blocks are divided by instrumentalist.

8. The system of claim 1, wherein the plurality of blocks are divided by instrumentalist grouping.

9. The system of claim 1, wherein, when the primary device presents a GUI including controls for moving selections of one or more of the plurality of blocks in real-time while the communication to the receiver device is in progress, the primary device:
presents a GUI including a prep region, a mid-live region, and a live region, wherein the live region is defined as spanning from a start time, or a present time when the present time is after the start time, through a burn threshold and the mid-live region is defined as spanning from the burn threshold to a later time;
presents, through the GUI, controls for moving selections of one or more of the plurality of blocks from the prep region into the mid-live region and live region; and
communicates the dynamic notation file based on the blocks in the mid-live region and live region to the receiver device.

10. The system of claim 9, wherein, further in response to executing the instructions, the primary device presents, through the GUI, controls for moving selections of blocks into the prep region.

11. The system of claim 1, wherein, further in response to executing the instructions, the primary device presents, through the GUI, a block modification control.

12. The system of claim 11, wherein the block modification control is an equalization control.

13. The system of claim 11, wherein the block modification control is a reverb control.

14. The system of claim 13, wherein, in response to an application of the reverb control to a selection of blocks, the selected blocks in the dynamic notion file are communicated to the receiver device at a first time and are communicated to a second receiver device as a second time offset from the first time.

15. The system of claim 1, wherein each static music notation file represented as divided into the plurality of blocks is automatically created by the system in response to accessing a related sheet music file or in response to receiving and processing a live music performance.

16. A system for dynamic, real-time composition of sheet music comprising:
a data library including a plurality of static music notation files, each static music notation file represented as divided into a plurality of blocks;
a primary device in communication with the data library, the primary device including a user interface, memory storing program instructions, and a communications module;
a receiver device in communication with the primary device;
wherein, in response to executing the instructions, the primary device:
presents a GUI including a prep region, a mid-live region, and a live region, wherein the live region is defined as spanning from a start time, or a present time when the present time is after the start time, through a burn threshold and the mid-live region is defined as spanning from the burn threshold to a later time;
presents, through the GUI, controls for moving selections of one or more of the plurality of blocks from the prep region into the mid-live region and live region; and
communicates a dynamic notation file based on the blocks in the mid-live region and live region to the receiver device.

17. The system of claim 16, wherein the plurality of blocks are divided by instrument, instrument grouping, time, by song segment, instrumentalist, or instrumentalist grouping.

18. The system of claim 16, wherein, further in response to executing the instructions, the primary device presents, through the GUI, controls for moving selections of blocks into the prep region.
